(19) United States
(12) Patent Application Publication
(10) Pub. No.: US 2026/0030999 A1
(43) Pub. Date: Jan. 29, 2026

(54) SYNTHETIC TISSUE MODELS, MATERIALS, AND METHODS FOR THERMAL TREATMENT TRAINING AND SIMULATION

(71) Applicant: Ward Shalash, Englewood, CO (US)

(72) Inventor: Ward Shalash, Englewood, CO (US)

(21) Appl. No.: 19/283,009

(22) Filed: Jul. 28, 2025

Related U.S. Application Data
(60) Provisional application No. 63/676,434, filed on Jul. 28, 2024.
(60) Provisional application No. 63/685,249, filed on Aug. 20, 2024.
(60) Provisional application No. 63/837,784, filed on Jul. 2, 2025.

(51) Int. Cl. G09B 23/30; C08L 29/04; C08L 89/06

(52) U.S. Cl. CPC G09B 23/30; C08L 29/04; C08L 89/06; C08L 2312/00

(57) ABSTRACT

There is a need in the art for synthetic tissue models that not only simulate the tactile properties of tissues and organs but further withstand and respond in an analogous fashion to the application of energy, particularly heat and electrical energy such as accompany electrosurgery. Described herein are materials and methods useful in the construction of synthetic tissue models, particularly conductive synthetic tissue materials made from a state-sensitive, cross-linked polymer composition, that have utility in connection with thermal treatment training and simulation exercises, and moreover provide a current controlled treatment field profile analogous to that of existing tissue to that of the present invention. To that end, the simulated tissues and anatomical models of the present invention are fabricated from a hydrogel composition that undergoes partial or complete transition from its native state prior to treatment (e.g., thermal or non-thermal treatment) to one or more other states when exposed to energy, including but not limited to the following state transitions: discoloration, denaturation, coagulation, carbonization, vaporization, melting or other energy-induced state transition. These transitions facilitate the generating and detecting of a lifelike treatment field profile.

### 1 PRIORITY CLAIM

This application claims the benefit of the earlier filing date of U.S. Provisional Application No. 63/676,434, filed Jul. 28, 2024, U.S. Provisional Application No. 63/685,249, filed Aug. 20, 2024, and U.S. Provisional Application No. 63/837,784, filed Jul. 2, 2025, all of which are incorporated by reference herein in their entirety.

### 2 TECHNICAL FIELD OF THE PRESENT INVENTION

This invention generally relates to materials and methods useful in the construction of synthetic tissue models that have utility in connection with thermal treatment training and simulation exercises, and, in particular, to conductive synthetic tissue materials made from a state-sensitive, cross-linked polymer composition and methods of manufacturing such synthetic tissue materials and anatomical models fabricated therefrom.

### 3 BACKGROUND OF THE PRESENT INVENTION

### 3.1 Description of the Prior Art

In order to provide background information so that the invention may be completely understood and appreciated in its proper context, reference is made to a number of prior art patents and publications as follows: U.S. Pat. Nos. 10,081,727; 10,755,600; 10,847,057; and 11,164,482, the contents of which are hereby incorporated by reference herein.

U.S. Pat. No. 10,081,727 to Felsinger et al discloses simulated tissue structures for electrosurgical training and simulation, which are designed to closely mimic the physical properties of human tissues. These structures can be manipulated with various surgical tools and energy devices, such as scissors, cauterizers, and sutures. The invention referenced uses variations in hydrogel composition, including different ratios of acrylamide and alginate to aid in adjusting the physical and mechanical properties of the simulated tissue, such as flexibility, elasticity, and tear resistance. Nevertheless, despite the useful applications of the current synthetic tissue, per se, U.S. Pat. No. 10,081,727 provides an improved hydrogel composition that responds similarly to real human tissue when subjected to electrosurgical tools, including cutting, coagulation, and cauterization. This is achieved by the use of ionic and conductive hydrogel composition. The material composition, mostly made of hydrogel, can be altered to control the rate of water evaporation. Water evaporation happens as the electrosurgical tool applies current to the conductive soft tissue analog or element. In turn, the temperature of the simulated tissue will increase to a temperature that begins to evaporate the water content of the hydrogel at the location of contact. Because a large portion of the material is water, it gives off steam that simulates smoke created during electrosurgery performed on real human tissue. Additionally, with prolonged contact with the electrosurgical unit, the water content in the simulated tissue will decrease in the location of the contact, mimicking real tissue dissection, sealing, and/or fusion by an electrosurgical unit. However, as discussed in greater detail hereinbelow, the hydrogel compositions described by Felsinger have certain deficiencies that are remedied by the present invention.

An article by Andrew Mikhael et al. (“Evaluation of a tissue-mimicking thermochromic phantom for radiofrequency ablation”) published in the American Association of Physicists in Medicine Journal for June 2016, the contents of which are hereby incorporated by reference, discloses a current tissue phantom that changes color when heated. The described tissue phantom comprises thermochromic ink that permanently changes the color of the tissue from white to magenta. In terms of form and function, the material is similar to that described in U.S. patent application No. 10,847,057 cited above. Another disclosure which furnishes background information is that above cited U.S. patent application Ser. No. 11, 164,482 in the name of T. N. Trotta et al, which discloses a method of using polymeric materials to create simulated tissue that mimics various tactile properties of human tissues and organs. However, as with Felisnger discussed above, these simulated tissues operate in a different manner and moreover have certain deficiencies that are remedied by the present invention.

### 3.2 On-Going Need in the Art

Notwithstanding the precise merits, features, and advantages of the above-described prior art materials, there is on-going need in the art for synthetic tissue models that not only simulate the tactile properties of human tissues and organs but further withstand and respond in an analogous fashion to the application of energy, particularly heat and electrical energy such as accompany electrosurgery. Critically, none of the existing prior art alternatives are capable of providing a current controlled treatment field profile equivalent to that of the present invention. Accordingly, it is a principal object of the present invention to achieve controlled treatment field profile in electrosurgical simulation and training on a current simulated tissue or anatomical model.

It is another principal object of the present invention to provide an environment with better characteristics that will enable the achievement of electrosurgical simulation and training.

### 4 SUMMARY OF THE PRESENT INVENTION

The present invention relates to a simulated tissue or anatomical model comprised of a hydrogel composition that undergoes partial or complete transition from its native state prior to treatment (e.g., thermal or non-thermal treatment) to one or more other states when exposed to energy, including but not limited to the following state transitions: discoloration, denaturation, coagulation, carbonization, vaporization, melting or other energy-induced state transition. These transitions facilitate the generating and detecting of a lifelike treatment field profile. In this manner, the simulated tissues anatomical models of the present invention are able to achieve the above-noted objectives, namely a controlled treatment field profile during electrosurgical intervention so as to thereby provide a more life-like environment for electrosurgical simulation and training exercises. Key to simulating the reaction of real tissue to an energy source is the incorporation of state-sensitive hydrogel composition that mimics the response of soft tissue to thermal treatment. This composition facilitates heat reactions which provide a true-to-life and hyper-realistic representation of tissue responses to an energy source including formation of treatment field profile.

While the novel composition can be configured using various methods to mimic a wide range of real tissues, the simulation of human soft tissue is of particular interest. Simulated human soft tissues provide a practical and ethical alternative in applications where real human tissue is unavailable or unsuitable, such as surgical training and the development of surgical devices. For example, in surgical training, the anatomical model containing the composition of the present invention offers a realistic platform for practicing techniques like cutting, coagulation, and thermal treatment, eliminating the need for cadaveric or animal tissue. Similarly, in device development, it serves as an ideal testing environment for evaluating the performance and safety of new surgical tools, enabling manufacturers to optimize designs before clinical trials. The anatomical model is used in controlled environments, such as modular simulators or laboratory setups, which replicate anatomical structures and thermal treatment conditions. These environments are equipped with monitoring systems to track simulated thermal treatment responses, such as treatment field profile parameter(s).

Accordingly, it is an objective of the present invention to provide a three-dimensional anatomical model configured to interact with treatment energy delivery device, examples of which include but are not limited to an electrocautery and a bipolar electrode. The anatomical model may be further constructed to interact with one or more auxiliary and/or monitoring components, examples of which include, but are not limited to, ultrasound and imaging sensors.

In a preferred embodiment, the anatomical model comprises a dry heat hydrogel composition and optionally a cooling element. In the context of the present invention, the dry heat hydrogel composition is preferably a state-sensitive, matrixed network formulated to undergo a state transition when exposed to treatment energy in a manner analogous to that of living tissue. Accordingly, the hydrogel composition preferably undergoes a reaction (such as a browning reaction) that causes the formation of a distinguished treatment field profile (e.g., one or more lesions characterized by vaporization, coagulation, carbonization, etc.) that are representative of the reaction in similarly situated soft tissue.

In a preferred embodiment, the hydrogel composition is fabricated from cross-linked polymeric matrix cured to solid form, wherein the matrix is comprised of a base polymer (such as optionally modified polyvinyl alcohols (PVA), polyethylene glycols, polyacrylamides, chitosan, cellulose, starch, alginate, agar, collagen, polyaniline) cross-linked with a binder polymer (such as natural polysaccharides including carboxymethyl cellulose (CMC), sodium alginate, xanthan gum, guar gum, dextran, starch derivatives, chitosan, and hyaluronic acid; proteins or protein derivatives including gelatin, gelatin methacryloyl (GelMA); synthetic water-soluble polymers including PVA, polyacrylic acid (PAA), polyacrylamide, PEG, poly(ethylene oxide) (PEO), polyvinylpyrrolidone (PVP), polyethyleneimine (PEI), and poly(N-isopropylacrylamide) (PNIPA); hybrid binders combining polymers and crosslinkers such as citric acid-glycerol; and polymer blends including PAA-PVA and alginate-polyacrylamide), and optionally a sugar compound (such as monosaccharides including glucose, fructose, galactose, mannose, ribose, xylose, arabinose, erythrose, sedoheptulose, ribulose, and tagatose; disaccharides including lactose, maltose, sucrose, and cellobiose; oligosaccharides including raffinose and trehalose; sugar alcohols including mannitol and sorbitol; deoxy sugars including fucose and rhamnose; amino sugars including glucosamine, galactosamine, and N-acetylglucosamine; sugar acids including gluconic acid, glucuronic acid, galacturonic acid, and iduronic acid; and sugar derivatives modified by phosphorylation, sulfation, acetylation, methylation, or other chemical modifications). It is yet another objective of the present invention to incorporate the anatomical model of the present invention into a modular simulator having utility both in the context of research and development and hands-on training. For example, in one preferred embodiment, the present invention provides an anatomical model, such as a prostate anatomical model, that is used in a modular simulator, referred to as prostate simulator, for electrosurgical training; this description serves as an example of using this novel anatomical model composition in an environment that allows for surgical training and practice. This application of the anatomical model is of particular interest and importance to personnel in the surgical and medical field, such as surgeons, training residents, and medical device manufacturers.

It is yet a further objective of the present invention to utilize an anatomical model or modulator simulator described above to design and/or simulate a treatment plan. To that end, the anatomical model may be designed to reflect the anatomy of a specific patient, for example, a specific tumor in a specific organ, to thereby allow the physician to practice and perfect a procedure before the onset of treatment. Alternatively, the model and/or simulator may be designed more generally to allow for the iterative design and development of novel treatment protocols.

As noted above, it is an objective of the present invention to utilize the anatomical model of the present invention to study, practice, and refine an established surgical intervention. It will also be readily apparent to the skilled artisan that the anatomical model of the present invention finds utility in the research development of novel clinical procedures and protocols. Furthermore, the data obtained through the use of the instant anatomical model finds utility in the optimization of the surgical tools themselves. Accordingly, it is yet another objective of the present invention to develop the anatomical models and simulators such as described herein as an iterative or predictive medical assay.

These and other objectives are accomplished in the invention herein described, directed to synthetic tissue models, materials, and methods for thermal treatment training and simulation. Further objects and features of the invention will become more fully apparent when the following detailed description is read in conjunction with the accompanying figures and examples. However, it is to be understood that both the foregoing summary of the invention and the following detailed description are of a preferred embodiment, and not restrictive of the invention or other alternate embodiments of the invention. In particular, while the invention is described herein with reference to a number of specific embodiments, it will be appreciated that the description is illustrative of the invention and is not constructed as limiting of the invention.

### 5 BRIEF DESCRIPTION OF THE DRAWINGS

The preceding background and summary, along with the subsequent detailed description of the preferred aspects, will be more comprehensible when read alongside the attached drawings. The drawings depict aspects currently preferred for illustrating the invention. It should be noted, however, that the invention is not confined to the exact arrangements and instrumentalities depicted. In the drawings:

FIG. 1 is a schematic of a frontal view of an illustrative prostate anatomical model in accordance with the present invention.

FIG. 2 is a schematic of an axial view of the prostate anatomical model of FIG. 1.

FIG. 3 presents an external front view of an exemplary prostate simulator constructed in accordance with the principles of the present invention.

FIG. 4 presents an external back view of the prostate simulator of FIG. 3.

FIG. 5 presents an external bottom view of the prostate simulator of FIG. 3.

FIG. 6 presents an exploded external front view of the prostate simulator of FIG. 3.

FIG. 7 presents an exploded view of panels of the prostate simulator of FIG. 3.

FIG. 8 presents an external exploded front view of the water backflow preventer assembly of the prostate simulator of FIG. 3.

FIG. 9 presents a cut-away view of the prostate simulator assembly of FIG. 3.

FIG. 10 presents a cut-away view showing the ultrasound-compatible rectal element of the prostate simulator of FIG. 3.

FIG. 11 presents a zoomed-in cut-away view of connector components of the prostate simulator of FIG. 3.

FIG. 12 presents a cut-away view of the internal structures of the prostate simulator of FIG. 3.

FIG. 13 is a graph showing composition state transition plotted against energy intensity and treatment time.

FIG. 14 is an image of a treatment field profile of an inventive polymer composition that is visually discernible from adjacent unaffected composition. Two treatment field profiles comprising a coagulation layer (400A) and carbonization layer (400B) are shown relative to unaffected composition (400C).

FIG. 15 is an image of a treatment field profile of the composition of FIG. 14 (dotted area) that is visually indiscernible from adjacent unaffected composition.

FIG. 16 is a schematic diagram of an illustrative aspect of the thermal treatment simulation process of the present invention.

FIG. 17 is an image showing sequential treatment field profiles of an inventive hydrogel composition at power levels of 20 W, 30 W, 40 W, 50 W, and 60 W, from left to right. The progression demonstrates increasing treatment intensity and the development of a carbonized layer with higher power levels.

FIG. 18 illustrates a simulation system in accordance with the parameters of the present invention.

FIG. 19 depicts the chemical reaction scheme underlying a discoloration reaction described herein.

FIG. 20 presents a block diagram illustrating one aspect of a simulation system in accordance with the present invention.

FIG. 21 presents a schematic diagram illustrating an aspect of an anatomical model production process in accordance with the present invention.

FIG. 22 presents an illustration of one aspect of a production process in accordance with the present invention.

### 6 DETAILED DESCRIPTION OF THE PREFERRED EMBODIMENTS

### 6.1 Overview of Terms

Before the present materials and methods are described, it is to be understood that this invention is not limited to the specific devices, systems, methodologies or protocols herein described, as these may vary in accordance with routine experimentation and optimization. It is also to be understood that the terminology used in the description is for the purpose of describing the particular versions or embodiments only, and is not intended to limit the scope of the present invention which will be limited only by the appended claims. Accordingly, unless explained otherwise, all technical and scientific terms used herein have the same meaning as commonly understood to one of ordinary skill in the art to which this disclosure belongs. However, in case of conflict, the present specification, including definitions below, will control.

Although methods and compounds similar or equivalent to those described herein can be used in the practice or testing of the present disclosure, suitable methods and compounds are described below. The compounds, methods, and examples are illustrative only and not intended to be limiting, unless otherwise indicated. Other features of the disclosure are apparent from the following detailed description and the claims.

Unless otherwise indicated, all numbers expressing quantities of compounds, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing aspects from discussed prior art, the aspect numbers are not approximate unless the word “about” is recited. Furthermore, not all alternatives recited herein are equivalents.

Any theories of operation are to facilitate explanation, but the disclosed devices, systems, materials, and methods are not limited to such theories of operation. Although the operations of some of the disclosed methods are described in a particular, sequential order for convenient presentation, it will be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed compounds and materials can be used in conjunction with other compounds and materials. Additionally, the description sometimes uses terms such as “produce” and “provide” to describe the disclosed methods. These terms are high-level abstractions of the actual operations that are performed. The actual operations that correspond to these terms will vary depending on the particular implementation and are readily discernible by one of ordinary skill in the art. Examples are described with reference to directions indicated as “above,” “below,” “upper,” “lower,” and the like. These terms are used for convenient description, but do not imply any particular spatial orientation.

The following explanations of terms are provided to better describe the present disclosure and to guide those of ordinary skill in the art in the practice of the present disclosure:

As used herein, “comprising” means “including” and the term “or” refers to a single element or component of stated alternative elements or a combination of two or more elements, unless the context clearly indicates otherwise.

The words “a”, “an” and “the” as used herein mean “at least one” unless otherwise specifically indicated. Thus, for example, reference to an “opening” is a reference to one or more openings and equivalents thereof known to those skilled in the art, and so forth.

As used herein, the noted directional terms relate to a human body in a standing position. For instance, “up” refers to the direction of the head, “down” refers to the direction of the feet. Likewise, herein, the “vertical” direction is parallel to the axis of the body and the “horizontal” direction is parallel to the floor. In a similar fashion, the term “lateral” refers to the direction extending away from the center of the body whereas “media” refers to a direction extending toward the center of the body.

In the context of the present invention, the term “proximal” refers to that end or portion of a device or instrument which is situated closest to the body of the subject when the device is in use. Accordingly, the proximal end of an electrosurgical device of the present invention includes the handle portions. Conversely, the term “distal” refers to that end or portion of a device or instrument that is situated farthest away from the body of the subject when the device is in use. Accordingly, the distal end of an electrocautery device such as contemplated by the present invention includes the active heating components.

To facilitate review of the various aspects of the disclosure, the following explanations of specific terms and abbreviations are provided:

Treatment: As used herein, “thermal treatment” or “treatment” refers to causing energy to be delivered to a composition to cause partial or complete state transition of the composition from its native state prior to treatment. Treatment may be delivered through treatment device (e.g., ablation device) to cause a state transition to the composition of the anatomical model.

Treatment field profile: As used herein, “treatment field profile” refers to the spatial distribution, geometry, and extent of composition alteration or removal resulting from the application of energy (e.g., thermal energy) to a target composition or tissue analog or element. The treatment field profile may be characterized by one or more parameters, including but not limited to depth of penetration, width, shape, energy gradient, boundary definition, diffusivity, color, and degree of thermal or physical transformation. In the context of the present disclosure, the treatment field profile represents the simulated or actual effect of a treatment device on a state-sensitive composition (e.g., discoloration, denaturation, coagulation, vaporization, carbonization, or melting), and may be used to evaluate device performance, procedural accuracy, or tissue response under simulated clinical conditions.

Anatomical model: As used herein, “anatomical model” or “model” refers to a physical or virtual representation of all or part of a human or animal anatomy, designed to replicate anatomical structures for purposes such as simulation, training, device design, device testing, or treatment planning. An anatomical model may include internal or external anatomical features and may be fabricated to mimic the geometric, mechanical, biological (e.g., presence of living cells), or physiological properties of biological tissues. The anatomical model may comprise one or more anatomical elements (e.g., bladder, urine, ureter, fat, bone) and/or non-anatomical elements (e.g., enclosure, base, holder, hooks, fluid) and may be configured to receive a medical instrument, device, injectate or facilitate a surgical procedure such as thermal treatment, incision, or catheterization.

Anatomical model element: As used herein, “anatomical model element” or “element” refers to any physical structure, component, or sub-component that is integrated with or coupled to an anatomical model for the purpose of facilitating simulation, training, testing, or surgical procedures. Anatomical model element(s) may include anatomical structures that replicate, represent, or simulate the geometry, form, mechanical properties, or functional characteristics of biological tissues, organs, or anatomical regions, such as skin element, muscle element, vasculature element, urethra element, bladder element, prostate, rectum, blood or other soft or hard tissue replicas or analogs (or elements). The term further encompasses non-anatomical structures coupled with the model to support or enhance simulation or procedural functionality. These may include, but are not limited to, hook(s), base(s), substrate(s), heat sink(s), wire(s), cooling element(s), tube(s), guide(s), marker(s), mesh(es), frame(s), rod(s), cage(s), or implant(s). Anatomical model element(s) may be fabricated using any suitable material and manufacturing method, including but not limited to molding, casting, and additive manufacturing (e.g., three-dimensional [3D] printing), and may be configured to interface with surgical instruments, respond to applied forces, or mimic procedural outcomes.

Composition: As used herein, “composition” refers to any combination of two or more substances, materials, or compounds that are physically mixed, chemically combined, or otherwise integrated to achieve specific functional, structural, or performance characteristics. A composition may include, but is not limited to, polymers, solvents, fillers, additives, colorants, stabilizers, crosslinking agents, or biologically derived materials (e.g., cells). In the context of the present disclosure, the composition comprises one or more compounds and optional additives formulated to exhibit properties such as state sensitivity, thermal responsiveness, or compatibility with thermal treatment procedures. Upon exposure to heat or energy (such as thermal energy), the composition is configured to undergo a controlled partial or complete state transition. This transition may include, but is not limited to, discoloration, softening, melting, vaporization, carbonization, or structural deformation, and is intended to mimic thermal treatment effects of tissue. Such composition may be used to fabricate anatomical models and/or elements and facilitate thermal tissue response under various treatment or training conditions.

Crosslinking: As used herein, “crosslinking” refers to the formation of chemical or physical bonds between polymer chains, resulting in a 3D network structure. Crosslinking may be achieved through various mechanisms, including but not limited to chemical reactions (e.g., covalent bonding via curing agents, initiators, or radiation) or physical interactions (e.g., hydrogen bonding, ionic interactions, or entanglement). Crosslinking may alter the mechanical, thermal, chemical, or biological properties of a material, such as increasing rigidity, elasticity, durability, or resistance to degradation. In the context of the present disclosure, crosslinking may be used to modify the state-sensitive composition to simulate tissue response or to achieve desired performance characteristics of the anatomical model.

Freeze-thaw cycle: As used herein, “freeze-thaw cycle” refers to a process in which a material or composition is subjected to one or more sequential phases of freezing (exposure to temperatures at or below its freezing point) followed by thawing (return to a temperature above its freezing point). This cycle may be applied intentionally to alter the physical, chemical, or mechanical properties of the material, such as crosslinking, phase separation, porosity modification, or structural stabilization. In the context of the present disclosure, freeze-thaw cycles may be used to condition or modify the behavior of a state-sensitive composition or anatomical model or element to more accurately simulate tissue characteristics or to achieve desired performance attributes.

### 6.2 Introduction

Lifelike anatomical models constitute a critical tool for the development, optimization, and simulation of surgical techniques. Such models enable replication of surgical procedures and may be employed in conjunction with imaging and acoustic modalities to monitor, guide, and assess procedural steps. Anatomical models provide cost-effective medium for direct feedback on optimal treatment strategies in a low-risk environment before continuing to pre-clinical in-vivo models and clinical trials. Anatomical models have been characterized and utilized in approximating both soft (e.g., kidney and liver) and hard (e.g., whole bone and dental) tissue for therapeutic techniques. Of interest, are less-invasive treatment modalities using thermal treatment, such as laser, focused microwave, and radiofrequency treatments. These techniques have been developed to perform localized tumor treatment, preserving healthy tissue in the inflected organ. To expand potential applications and avoid in-vivo experiments for human experimentations, the design and processing of tissue-mimicking anatomical models capable of demonstrating the evolution and extent of treatment field profile formation in real time are extremely helpful for all thermal treatment devices during preclinical development. Additionally, the compatibility of these anatomical models with imaging and acoustic applications allows to track the outcomes of the thermal treatment for feedback.

Anatomical models are widely used in simulation of surgical techniques and devices. Soft-tissue anatomical models contain unfavorable compositions of agarose, gelatin, polyacrylamide, polyurethane and oil-based gels with hard tissue anatomical models containing epoxy or acrylic plastic, among others. However, those intended for thermal treatment often lack realistic soft-tissue treatment effects, such as vaporization, and are inherently recalcitrant or not very amenable to benefiting somehow from using these anatomical models. Without favorable composition and/or composition suboptimal functionality under thermal exposure to facilitate reliable simulation, anatomical models have limited utility and, therefore, rely on alternative methods for simulation of thermal treatment.

Several suboptimal temperature-sensitive tissue-mimicking compositions have been reported as model materials for thermal treatment. For example, polyvinyl alcohol (PVA) or agar-based anatomical models were used to visualize the effect of bubble-enhanced heating by focused, MHz-frequency ultrasound. However, thermal treatment field profiles (e.g., lesions) could not be well visualized in such anatomical models. Transparent polyacrylamide (PAA) gels containing bovine serum albumin (BSA) were then proposed since BSA would turn white and optically opaque. Challenges persist in providing a realistic representation of tissue behavior responding to thermal applications in surgical simulation. Particularly, simulated tissues that can undergo state transition (e.g., discoloration, coagulation, vaporization, and carbonization) similar to realistic tissues. As a result, these anatomical models require specialized approaches, such as those discussed herein, to effectively introduce realistic treatment or thermal treatment and ensure successful simulation, preserving their viability and functionality for future use in medical applications and research.

Turning now specifically to illustrate development of a simulated human prostate tissue as a non-limiting example of anatomical model, it is well established that prostate cancer (PCa), often associated with prostatic tumor growth, is a prevalent condition that affects the quality of life of numerous individuals. This condition is most commonly diagnosed in men and has been associated with pain, sexual dysfunction, loss of independence, depression, and loss of social support. It is estimated that every year over 90,000 Americans undergo invasive surgery, such as radical prostatectomy, removing the entire prostate gland along with adjacent tissues to alleviate symptoms caused by PCa. Although radical prostatectomy techniques have been rising, this procedure is tied to increased risk of comorbidities, long treatment duration, and therapy delivery. The failing radical prostatectomy outcomes can be attributed to the invasive nature of the procedure. Partial prostatectomy techniques have emerged as an attractive alternative to treat localized PCa. Methods like thermal treatment and focal ablation therapy aim to preserve the prostate's healthy tissue and function while addressing the cancerous area. However, limitations in tailoring and controlling the thermal treatment field profile to the patient anatomy can lead to needless complications, including sexual dysfunction and urinary incontinence. Localized removal of prostate tissue is a significantly more complex procedure than the initial operation.

Partial prostatectomy procedures can thus provide an alternative to surgical strategies like radical prostatectomy, providing localized management of cancerous growth while restoring prostate function. However, access to prostate anatomical model for research and surgical simulation is limited due to challenges in adequately replicating fibrous tissues with inherent and thermally-induced controlled state transition (e.g., discoloration, coagulation, carbonization, and vaporization) a quality that may be especially important in thermal treatment simulation. Such inherent qualities of tissues are a product of thermally-induced reactions such as Maillard's Reaction, specifically the interaction between carbonyl containing compounds and amine containing compounds in the composition, mainly in the form of reducing sugars and the amino groups of proteins, respectively. This reaction is triggered at temperatures above 40° C. and is controlled by physical and chemical conditions, including temperature, water content, pH, and concentrations, among other factors. One of the challenges inherent in anatomical models is unfavorable composition and composition suboptimal functionality under thermal exposure, leading to uncontrolled mechanical deformation such as composition melting, or failure of anatomical models at temperatures below treatment thresholds, limiting their effectiveness in realistic simulation. One suggestion to overcome this challenge is to incorporate organic and/or nonorganic additive to improve the overall performance of anatomical models. Anatomical models with these physical attributes would also improve the logistics of thermal treatment simulation by decreasing costs and accommodating simulation schedules.

It is well recognized in the art that there are many problems facing the prospect of manufacturing anatomical models for thermal treatment simulation, including the non-limiting example of the prostate anatomical model. Among these problems is the need for anatomical models with favorable composition and excellent functionality under treatment working temperatures between 40-100° C. Furthermore, most methods used to manufacture anatomical models with thermal feedback utilize toxic compounds, posing a risk to the end user when handling the models. Poor functionality of phantoms can affect its application in surgical simulation and leads to inaccurate control of treatment field profile, unreliable feedback, and failed simulation, or a combination thereof. Accordingly, additional systems, devices, and methods for improving the thermal stability of anatomical models are desirable.

The above-mentioned problems limit the effectiveness of anatomical models manufactured using conventional methods, especially those used for the simulation of thermal treatment techniques.

Disclosed herein are aspects of systems, devices, and methods for simulating lifelike thermal treatment in anatomical models. In particular aspects of the disclosure, a method for manufacturing a prostate anatomical model for the practice of thermal treatment techniques is provided. In a preferred embodiment, the method includes the steps of providing polyvinyl alcohol (PVA) polymer, providing collagen polymer, providing a peptide polymer such as albumin, providing water, mixing the water with the PVA, collagen and albumin to form a solution, adding sodium chloride to the solution, adding D-glucose, adding calcium sulfate to the solution, adding dimethyl sulfoxide (DMSO) to the solution after the steps of adding D-glucose and calcium sulfate to the solution, casting the solution into a shape representative of an anatomical structure, and curing the solution to form a prostate anatomical model made of favorable composition for practicing and simulating thermal treatment techniques the like of electrosurgery. In this case, adding DMSO can enhance the rate at which browning reactions occur.

Additionally, the description comprises a method for using the prostate anatomical model for simulation, wherein a simulation device or environment (e.g., simulator) can be used to provide the user (e.g., medical device manufacturer) with a risk-free environment to replicate specific surgical procedures as part of the simulation. Additional components of the simulation device are described herein. System aspects comprising the simulation device or environment also are described. The method aspects disclosed herein utilize the simulation device and/or system aspects disclosed herein to facilitate tissue thermal treatment simulation more efficiently than conventional methods. The method disclosed herein is able to achieve a desirable and controlled thermal treatment field profile within the anatomical model with favorable composition and excellent functionality under thermal treatment working temperatures between 40-150° C. As such, the method is able to achieve a successful simulation of tissue thermal treatment, ensuring realistic and reliable simulation for applications in medicine and research and development.

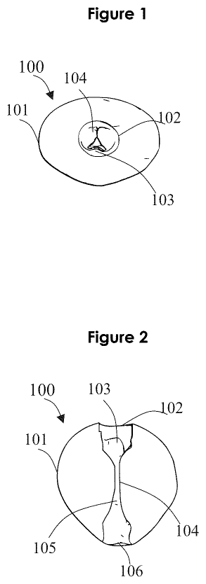

As shown in FIGS. 1-22 and described in further detail herein, the present disclosure relates to a novel system and method for design and use of a lifelike, device for use in simulations of a diverse number of surgical procedures, particularly those procedures containing thermal treatment. The device preferably uses a patient's unique morphology, which may be derived from capturing data such as MRI data, CT data, or any other medical imaging device to derive one or more anatomical elements, which comprise complementary surfaces to those encountered during the simulated procedure(s) as derived from a set of data points.

According to various aspects described herein, the anatomical model device may comprise one or more anatomical models containing a composition of the current invention, one or more sides, at least one valve to control fluid flow, and one or more holder surfaces for seating the anatomical model in particular orientation. The device may further comprise desired axes and/or insertional trajectories. According to aspects, the anatomical model may be further matched with one or more other anatomical models used during the simulation or surgical procedure. Other features of the disclosure will become apparent after a review of the following disclosures and varying aspects of the disclosure.

### 6.3 Control of Thermal Treatment Field Profile

In particular disclosed aspects, the method comprises exposing one or more anatomical model elements containing composition of the present invention to high intensity energy (e.g., thermal energy, or non-thermal energy), for example through IRE, high-intensity focused ultrasound (HIFU), plasma, minimally invasive therapy (MIT), tightly targeted minimally invasive therapy (TTMIT), microwave (MW), radiofrequency (RF), laser (L), Cryotherapy (CryoT), Magnetic Resonance (MR), Ultrasound, (US), Radioactive Therapy (Brachytherapy: BrT), chemical treatment techniques, adjuvant therapy, chemo therapy or radiation or any combination of these methods can be used in conjunction with but not restricted to imaging modalities or incisions or laparoscopy or needle placement in or near or adjacent to the anatomical model elements to be treated (referred to as target area hereafter) such as but not restricted to target area containing a composition containing PVA mentioned herein.

Throughout this disclosure the term “treatment” can include activation, deactivation, modulation, and delivering of energy (such as to produce a thermal treatment field profile) in organic or inorganic composition. Energy can include any suitable form of energy and may include thermal and/or non-thermal, including RF and MW and L, CryoT, HIFU, BrT, IRE, Electrical Current Therapies, Electrocautery, MR, US, or plasma. Treatment can be delivered to a target area (e.g., area to be treated) of anatomical elements and the target area comprises a state-sensitive composition, according to this disclosure, that partially or fully transitions from its native state prior to treatment to one or more other states, including but not limited to the following state transitions: discoloration, denaturation, coagulation, carbonization, vaporization, melting or other energy-induced state transition in response to an applied stimulus, such as, but not limited to, electromagnetic, kinetic, mechanical, or thermal energy. In one aspect, a state-sensitive composition (e.g., composition of the current disclosure) facilitates formation of distinguishable thermal treatment field profile when treated. A deactivating substance is one that diminishes or stops treatment effects; an activating substance initiates, augments, or continues treatment effects; and a neutralizing substance is one that neutralizes treatment effects or eliminates conditions under which treatment effects may occur. Specific examples are given throughout without loss of generality. One example of this is a disclosure that composition can contain sugar and amino acid compounds that when exposed to thermal treatment energy the compounds undergo a chemical reaction resulting in distinguishable discoloration or coagulation state transition. The discolored or coagulated target area forms a lifelike thermal treatment field profile. Additionally, deactivating substance such as water can be delivered via a thermal probe to modulate or control the thermal treatment field profile; however, this disclosure is not limited to the use of a sugar and/or amino acid compounds. Other suitable means of creating lifelike thermal treatment field profile are also disclosed.

In surgical practice, soft tissue thermal treatment is a complex process that is driven mostly by heat energy delivery to the soft tissue. When heat energy is delivered to a composition comprising the anatomical model or a component thereof, kinetic energy in the composition increases leading to breakage of chemical bonds. Weak bonds, for example hydrogen bonds, are easily broken by heat. When heat is delivered to a composition (e.g., in a soft tissue element), the composition including for example protein is heated and the heat makes the compound vibrate and the hydrogen bonds break, allowing protein to travel and form randomly looped structures. In one aspect, this state transition represents denaturation. When one or more unfolded protein compounds make contact, they may form new bonds via sulfide chains, or other bonds, with each other till a large net of interconnected protein ultimately forms. In one aspect, this state transition represents coagulation and can be favorable in maintaining composition structure. Coagulation can start to appear darker than adjacent non-treated composition. Further, increasing heat in composition increases the kinetic energy and, in some aspects, facilitates water evaporation and composition dehydration. This process can further facilitate composition caramelization, which is the melting, partial reduction, and solidification process of the composition. This process can be advantageous in maintaining the structural integrity of composition in thermal treatment. Further heating of composition leads to desiccation and carbonization or discoloration. Changes (e.g., state transition) of composition induced by thermal energy, including changes to the electromechanical and optical properties of the composition, is referred to as composition state transition throughout.

Composition state transitions mimic soft tissue interaction with thermal treatment. In soft tissue, thermal treatment or further heating can include decomposition, oxidization, vaporization or melting state transition of the tissue creating visually distinguishable layers each with distinct characteristics. In soft tissue thermal treatment, heat or energy delivered to tissue facilitates state-sensitive transitions and form visually distinct layers, known in the prior art, comprising a no tissue survival layer, heating with short-term tissue survival layer, and heating with prolonged tissue survival (for example, hours to months) and together form a thermal treatment field profile or a treatment field profile.

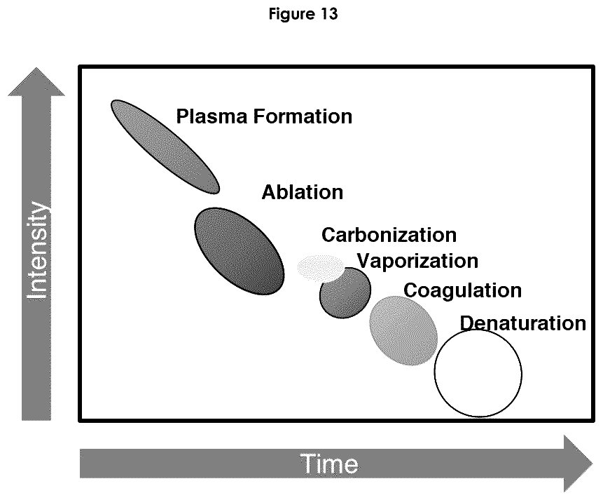

Thermal effects generally tend to be nonspecific. Nevertheless, depending on the duration and peak value of the target area temperature achieved, different composition state transitions that are distinguishable like discoloration, denaturation, coagulation, vaporization, carbonization, and melting may be visually distinguished and may produce a thermal treatment field profile. FIG. 13 is a graph showing composition state transition plotted against energy intensity and treatment time; wherein a relative relationship between duration and energy intensity affects the formation of a thermal field profile established by various composition state transitions.

Now turning to simulation of soft tissue thermal treatment, causing distinct composition state transitions or thermal field profile in anatomical models, using currently understood methods, can be challenging due to the composition relatively high content of water, unfavorable composition (e.g., such as additive), and/or composition suboptimal functionality under thermal exposure. To solve this issue composition may be improved by incorporating base compound and additive and may facilitate more favorable composition state transitions (e.g., formation of thermal field profile), as described in the current invention and improve the functionality and realism of simulated thermal treatment.

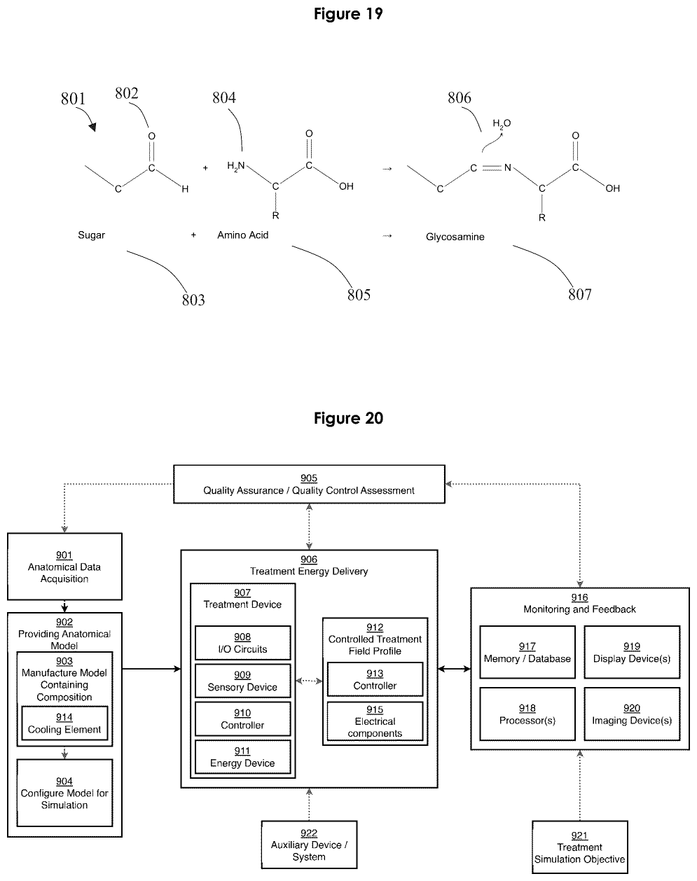

Use of favorable composition and/or additive of the current disclosure can facilitate the delivery of sufficient heat to induce more controlled composition state transition and prevent undesirable composition deformation (e.g., uncontrolled melting or excessive treatment) at thermal treatment temperatures. In one aspect, composition state transitions responsible for distinct coloration of the composition may be induced at temperature threshold of soft tissue thermal treatment. In some aspects, favorable composition and/or additive may include reactants of browning reaction. For example, with reference to FIG. 19, which depicts an illustrative Maillard's Reaction 801, a compound comprising a reducing sugar 803 containing a carbonyl functional group 802 and a compound, such as an amino acid 805, comprising an amine functional group 804, which under heat induce browning reaction, e.g., through the Maillard's Reaction 801, and composition dehydration and condensation 806 takes place at the target area. As the composition dehydrates and is exposed to energy, compounds may undergo Amadori rearrangement, subsequent dehydration, condensation, fragmentation of reactants, or Strecker degradation. This process can release low molecular and reactive intermediates, such as glycosamine 807, carbonyl intermediates, dicarbonyl compounds including glyoxal, which may facilitate at least one composition state transition, such as discoloration, and produce thermal field profile. Thus, characteristics of the composition described herein allow for the simulation of soft tissue thermal treatment including one or more soft tissue energy interactions like denaturation, discoloration, coagulation, vaporization, carbonization, and melting at temperature threshold values.

In one example, when heat is applied to a target area of the composition using an energy device, a thermal field profile is formed and simulates soft tissue response to energy. In one aspect, a thermal field profile forms and comprises one or more layers with a first layer that is a carbonization layer and at least partially enclosed within a second coagulation layer; and a second coagulation layer at least partially enclosed within a third transition layer; and a third transition layer directly adjacent to a coagulation layer on one side and unaffected composition on a second side. When a treatment field profile forms, all considered interactions (e.g., composition state transition) can be presented as both the intensity and temperature rise attenuate from innermost part of the thermal field across its profile. The temperature in some examples may reach over 100° C., such as over 150° C. to treat the composition. Cracks may be seen originating from thermal treatment, such as thermal stress induced by local temperature gradient across the thermal field profile. The duration of thermal treatment process may be sufficient to cause an increase in temperature. Denaturation, coagulation, vaporization, and carbonization interactions are shown in FIG. 13 have intensity (e.g., in units W cm-2) that are different and distinctive and some may overlap.

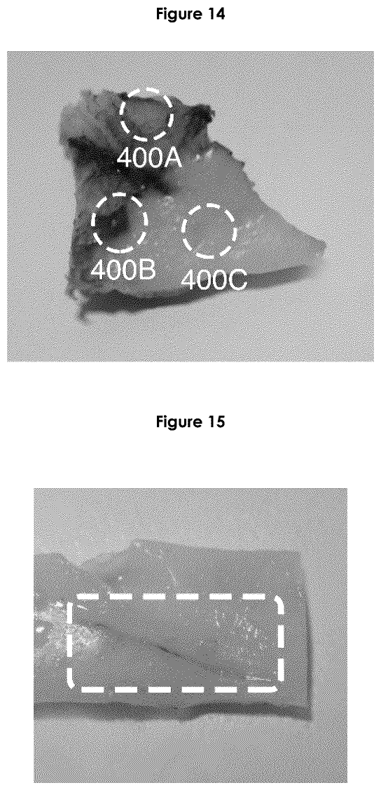

As such, and with reference to FIG. 14, the thermal field profile formed using the current invention can be characterized by well-demarcated layer of marked color change 400A and 400B from the surrounding unaffected composition 400C. According to one aspect, this invention comprises an anatomical model with a composition that facilitates simulation of thermal treatment processes of soft tissue. This composition is superior to conventional compositions in thermal response at the completion thermal conditions and functionality for simulation. It has a thermal field profile condition that is consistent with the conditions and retort thermal treatment conditions in the medical field. In other words, this invention discloses anatomical models comprising a state-sensitive composition that transitions in response to an applied stimulus and capable of mimicking soft tissue response to thermal energy.

As shown in FIG. 17, composition response to thermal treatment can be further controlled to produce desired results for thermal treatment simulation as described hereafter. For example, the composition of the current disclosure allows for gradual increase in discoloration, 600A, 600B, 600C, 600D, 600E, as thermal energy is progressively increased from 20 W to 60 W (20 W, 30 W, 40 W, 50 W, 60 W).

Turning now to another aspect of the present invention, wherein a composition responds to thermal treatment conditions: In one variation, the composition is a state-sensitive composition and mimics soft tissue thermal response to treatment external or internal to the anatomical model, inside a cavity in the anatomical model, on the surface of a cavity, between a first side and a second side of one or more anatomical models. In some aspects, one or more anatomical models contain a composition of the present invention and configured to replicate fat, muscle, tissue, organ, bone, vessel, nerve, and/or bodily fluid.

In another aspect wherein composition response to treatment energy (e.g., thermal treatment, non-thermal treatment) is at a target area other than on an anatomical model surface. In this aspect, treatment energy is applied to a target area some distance from a surface of an anatomical model. This process facilitates an increase in heat and kinetic energy leading to water vaporization, composition dehydration, and composition caramelization. Thermal effects generally tend to be nonspecific. Nevertheless, depending on the duration and peak value of the target area temperature achieved, different composition responses like discoloration, denaturation, coagulation, vaporization, carbonization, or melting may be visually distinguished. The first mechanism by which composition of the target area is thermally treated can be attributed to conformational changes of large composition compounds leading to, for example, protein denaturation. Denaturation ranges approximately between 40° C. to 50° C. Denatured composition can start to have a different color, for example more opaque, compared to adjacent unaffected composition. During the process of coagulation, temperatures reach at least 60° C. Coagulated layer can start to appear darker than adjacent unaffected composition. Carbonization can include decomposition, oxidization, or melting of the composition leading to formation of a dark carbon treatment field profile, typically at higher temperatures. In some aspects, a steam pop, or boiling, may occur with formation of a thermal field profile. This happens when the energy applied increases target area temperature higher than the temperature of steam formation and the resulted steam is released from the central layer of the thermal field profile into the surrounding area. This release of steam is often accompanied by an audible “pop”. Thermal field profile formed which resulted in a steam pop usually presents a central cavity. This response mimics soft tissue response to treatment energy.

In another aspect, composition response to thermal treatment conditions comprises generating a treatment field profile that is a multilayer. In one aspect, the treatment field is on the surface of a first anatomical model element, such as simulated skin containing the composition of the present invention. A generated treatment field that is a multilayer comprises at least a first coagulation layer adjacent to the composition at a native state (e.g., composition prior to treatment) on a first side and adjacent to a second carbonization layer on a second side. The carbonization layer is adjacent to a second anatomical model element not having the composition of the current invention (such as simulated blood). Further, treatment field profile (e.g., containing coagulation and/or carbonization layer) contrasting the bordering unaffected composition and the appearance of the treatment field profile is similar in color to thermally treated soft tissue, such as treated skin. In other aspects, a composition response, which comprises a treatment field profile and in certain anatomical models, for example in fat models, may be indiscernible from bordering unaffected composition. FIG. 15 is an image of a treatment field profile of the composition of FIG. 14 (dotted area) that is visually indiscernible from adjacent unaffected composition. This aspect mimics thermal treatment in fatty soft tissue. However, treatment field formed on a smooth anatomical model surface containing composition of the present invention, such as the surface of skin model, can be easily discernable due to the color change on the surface.

Delivery of sufficient heat facilitates composition state response to thermal treatment conditions and comprises a treatment field profile with one or more layers of denaturation, coagulation, dehydration, vaporization, or carbonization and mimics soft tissue response to thermal energy. FIG. 14 is an image of a treatment field profile of an inventive polymer composition that is visually discernible from adjacent unaffected composition. Two treatment field profiles comprising a coagulation layer (400A) and carbonization layer (400B) are shown relative to unaffected composition (400C).

Now we turn to describing the treatment field profile and distinct structural and optical properties thereof in response to thermal conditions. Treatment field profile formation according to one aspect of this invention comprises a process of removing composition mass, for example adenoma in prostate anatomical model containing the composition of the present invention, to create a new treatment field profile and/or move treatment field profile deeper within anatomical model. To better understand the current invention, a non-limiting example of three types of laser treatment (e.g., used in tissue ablation) are considered: (1) continuous or long pulsed treatment when water is vaporized and composition is first desiccated, and ultimately carbonized or melted. This type of treatment is typically governed by thermal interactions; (2) pulse (micro- and nanosecond) treatment as a composition undergoes both thermal and mechanical stress; (3) an ultra-short (pico- and femtosecond) pulse treatment, for example in laser ablation this type of treatment causes nonlinear absorption and/or plasma formation creating a treatment field (for example by composition optical breakdown) when the optomechanical mechanism of composition damage becomes dominating. In laser treatment, energy absorption by water leads to vaporization. During vaporization, the water volume tries to expand, the pressure increases, and finally localized micro-explosions may occur. Vaporization is sometimes referred as a thermomechanical effect due to the pressure build-up involved.

Vaporization of the composition can be described using heating equations such as the following equation used to describe heat in laser treatment: Qₜₕ=(p_{w}[c_{w} ΔT+Lᵥ]A)/(μₐ); where p_{w} is the density of water (1 g cm⁻³); μₐ, the absorption coefficient of water (cm⁻¹); c_{w}, the specific heat of water (4.2 J g⁻¹ C⁻¹); ΔT is the difference between the boiling temperature of water and initial water temperature; Lᵥ, the latent heat of vaporization (2.26 J g⁻¹ at 1 atm), and A is the area targeted for treatment. Further, water vaporization, vapor diffusion, and composition desiccation appear as the composition temperature reaches 100° C. at constant normal pressure. When generation of water vapor is faster than the rate of its diffusion out of the composition, the vapor can be trapped inside the composition, forming steam vacuoles. If the treatment energy applied continues to be converted to heat, pressure rapidly increases within the composition and steam expands within the vacuoles, stretching the surface until it raptures, either creating larger vacuoles within the treatment field profile or exploding by throwing fragments of the treatment field profile from the surface and thus creating new surface and/or moving the treatment field profile deeper within the composition. In other aspects, the treatment field profile comprises thermally decomposed composition.

In yet another aspect, when excessive energy is applied to the composition, the local temperature at the target area drastically increases and decomposition occurs as at temperatures above approximately 100° C. Decomposition is the heat mediated reduction of composition compounds (for example, amino acids and reducing sugars) that may form a thin (5-25±μm) decomposed layer (e.g., carbon in carbonization layer) on the surface being treated. When carbon is released, it leads to a blackening color. In other aspects, this newly formed layer may comprise a treatment field profile containing one or more layers of distinct composition states in response to thermal treatment conditions. For example, a treatment field profile comprising three layers and a first layer is a carbonization layer and at least partially adjacent to a second coagulation layer, and a second coagulation layer at least partially adjacent to a third transition layer, and a third transition layer directly adjacent to a coagulation layer on a first side and unaffected composition (e.g., composition at the native state prior to treatment) on a second side. In other aspects, carbon formation may reduce visibility during simulation.

### 6.4 Characterization of Treatment Field Profile and Parameters

Further preferred methods may be used to characterize treatment field profile. For example, heat production in continuous thermal treatment includes both sensible and latent components instead of just sensible ones. Sensible components, for example, present in thermal damage by slow heating to 100° C. The term “slow” refers to a condition of thermal confinement, where the duration of energy delivery to the target area (tp) is less than or equal to the time it takes for the target area to dissipate heat (td). This means that the ratio tp/td, representing how long energy is applied to the target area compared to how long it takes for the heat to dissipate, is less than or equal to 1 (tp/td≤1). In one aspect, when thermal confinement is not present (tp/td>1), the treatment field profile in the composition exhibits broader thermal spread, diffuse layer boundaries, and response to treatment primarily characterized by coagulation without significant vaporization or stratification.

Further, the treatment field profile can be characterized by the velocity by which composition removal (cut or drilling) vₐ (cm s⁻¹) occurs, commonly referred to in the prior art as the vaporization velocity. A gram of water requires a given amount of energy in order to be vaporized into gas. By calculating the amount of energy absorbed by the composition, for example, amount of energy absorbed per unit area of the treatment field profile, it is possible to estimate the grams of water vaporized per unit time per unit area. As a non-limiting example, the reader may consider the following case of laser treatment using a CO₂ laser, representing a scenario of continuous thermal treatment. Vaporization velocity can be approximated by the equation: vₐ=(fₑI)/(p_{w}[c_{w} ΔT+Lᵥ]); where I is the irradiance (W cm⁻¹); p_{w}[c_{w} ΔT+Lᵥ]=Qₜᵣₑₐₜₘₑₙₜ, the heat of vaporization of water (J cm⁻³); fₑ, the apparent efficiency of converting absorbed energy into vaporization. Further, the vaporization threshold can be found as the ratio of Qₜᵣₑₐₜₘₑₙₜ over μₐ (Hₜₕ=Qₜᵣₑₐₜₘₑₙₜ/μₐ). According to the equations above, if only a small fraction of water is vaporized then the p_{w}Lᵥ term can be neglected and the exposure treatment threshold becomes an order of less magnitude. Furthermore, the vaporization depth of the treatment field profile in the composition can be predicted as: d_{z}=(H₀−Hₜₕ)/(Qₜᵣₑₐₜₘₑₙₜ); where H₀ is the initial exposure. And, the composition mass loss m (g) can be predicted using the equation: m=p_{w}(A[H₀−Hₜₕ]/(Qₜᵣₑₐₜₘₑₙₜ). Turning to an example where a carbonization treatment field profile is formed before rapid vaporization and treatment occurs. At first, treatment device heats and dries the composition until the combination of dry and hot causes composition oxidation that yields a carbon treatment field profile. Once the carbon treatment field profile forms, in the example of laser treatment, it strongly absorbs laser radiation to drive rapid vaporization and ablation, extending the carbon treatment field profile. This process is rather dynamic and chaotic with continuous cycling of heating-dessication-carbonization-superheating-vaporization-ablation cycle. On average, there is a net average treatment field profile thickness and a net average velocity of treatment. The average velocity of treatment requiring carbonization v_{c} can be approximated by a simple formula: x_{c}=(fₑμₐd_{E}I)/(Qₜᵣₑₐₜₘₑₙₜ); where μₐ is the absorption coefficient of carbonized composition (cm⁻¹), d is the thickness of carbon treatment field profile (cm), _{E} is an augmentation factor due to multiple passes of treatment energy through the treatment field profile, for example in laser ablation caused by light scattering and total internal reflection, and the rest equation parameters have been defined previously. A yet more generalized equation can be used to measure the velocity of treatment field profile formation using equation: v_{c}=(qₙₑₜ)/(pQₜᵣₑₐₜₘₑₙₜ); where qₙₑₜ is the net heat flux into the composition; and p is composition density. Similar equations can be developed to describe the formation of treatment field profile using other forms of energy delivery methods, such as RF, MW, or US where heating is represented with composition properties and energy requirements.

In yet another example, treatment is delivered to a composition wherein irreversible damage of the composition is caused by laser light occurring within a timescale of seconds and less, based on light absorption and nonradiative energy conversion giving a temperature rise and can be provided either through thermal decomposition or composition state transition leading to thermal, mechanical, electrochemical destruction, or a combination thereof. In one aspect, the high-power laser causes the composition to be coagulated, reshaped, melted, welded, drilled, or cut depending on the light intensity and time of exposure as illustrated in FIG. 13. Removal and destruction of composition is not associated with any haptic feedback during operation. Therefore, to deliver controlled treatment, for example, by laser, guidance is demanded and one such example for guidance is the use of physical cues such as treatment field profile comprising a carbonization layer. Three points are critical under conditions of high-power treatment including maintenance of treatment threshold (monitoring of absorption changes due to heating and ablation), determination of the target area (avoiding destruction of critically important model elements such as simulated nerves or blood vessels), and delineation of target area.

In a preferred aspect, delivery of laser energy to the anatomical model containing composition of the present invention is controlled through different treatment conditions. In the case of energy delivered by laser, the main conditions may be power output (P, W) of the laser, exposure time (t, s), and average area treated (A, cm²). The latter condition is limited by Rayleigh length and depends both on outlet laser geometry and focusing, and delivering optics. Normalizing power (P) over area (A) can produce irradiance (I, W cm⁻²) which characterizes the specific power delivered to the target area. The radiant exposure (H, J cm⁻²) characterizes the specific energy delivered as H=I×t.

In pulse mode the important conditions are pulse energy (Eₚ, J), pulse duration (tₚ, s), and pulse repetition frequency (f, Hz), and also total exposure (t, s). For pulse lasers, an average power (pₘ, W) and energy (Eₘ, J) as Pₘ=Eₚf and Eₘ=Pₘt can be computed. Similar conditions may be used to characterize energy delivery through means other than laser.

Additionally, heat generation may be induced by either continuous wave or pulsed laser radiation. This is typically achieved through the absorption of a photon of energy by the composition, hv, promoting molecules within a composition to a vibrational excited state, and then an inelastic scattering causing molecules to collide, increasing the kinetic energy in the target area. Thermal interactions of the composition leading to state transition follow. Deposited heat at the target area may be transferred to adjacent model elements. These mathematical models and similar ones have been developed to describe transfer of heat through biologic tissues and can be used to model transfer of heat in the composition of the current disclosure using, for example, equation: Q_{gain}=Q_{storage}+Qₗₒₛₛ+W, where Q_{gain} is the rate of heat gained as a result of composition responses and environment-composition interactions, Q_{storage} denotes heat storage in the composition (e.g., dry heat composition of the current invention), Qₗₒₛₛ denotes heat lost to an adjacent model element and/or the environment (for example through evaporation, radiation, convection, and conduction), and W denotes the work produced by the composition (for example, exothermic reaction). These equations can further be used to study concepts in thermal treatment, such as but not limited to laser surgery irradiance and radiant exposure. Other concepts important to the design of devices used to deliver treatment energy can be studied using the composition and methods described herein.

Further, direct energy deposition in the target area may lead to excessively high central temperature in the composition. For example, in treatment methods that use a catheter or an antenna, this excessively high temperature is found around the treatment device that is the composition. As a result of the high temperatures, a composition response comprising a carbonization layer may easily occur, where highly desiccated charring composition usually appear, and form a treatment field profile. The composition after a treatment process, according to the present invention, comprises non-treated composition and a treatment field profile (e.g., composition with state transition due to treatment). In one aspect, the treatment field profile can be divided into three layers: a carbonization layer, coagulation layer, and transition layer. In clinical practice, the carbonization layer can lead to complications, for example, in treatment procedures of the spleen, a carbonized layer could lead to inflammation cellular response among other complications. Appropriate temperature control for treating soft tissue effectively while avoiding tissue carbonization is important for optimal clinical outcomes. Anti-carbonization strategies may utilize steps to decrease the carbonization probability in the treatment field profile. For example, by circulating a saline solution the probability for carbonization in the spleen is reduced. Alternatively, temperature control using pulsed and continuous delivery of power can be utilized to control carbonization. The present invention is advantageous for soft tissue treatment simulation, wherein an anatomical model containing a composition of the present invention allows for the simulation of controlled treatment conditions as shown in FIG. 17. In some aspects, the composition mimics parameters of soft tissue spleen, such as dielectric property, heat conduction, thermal conductivity, density, diffusivity, relative dielectric constant, conductivity, and specific heat capacity. In other aspects, the composition is characteristic of healthy and/or unhealthy soft tissue, such as healthy or unhealthy spleen.

Next, approaches to treatment of large tissue volumes and perfused tissues can be simulated using the composition mentioned herein. Equations and analytical models may be developed, such as analytical models known in the prior art, and may be applied to represent treatment field profile parameters. For example, a heat transfer equation describes heat diffusion in tissue with an added term for perfusion losses, for example by blood.

$$ρ C \frac{\partial {T}^{′}}{\partial T} = Q + κ {∇}^{2} {T}^{′} - {wC}_{b} {T}^{′}$$

where T′ is the tissue temperature rise over its equilibrium temperature T_{∞}, Q is the power deposited per unit volume, p is the tissue mass density, C is the tissue-volume specific heat, w is the blood mass flow rate per unit tissue volume, C_{b} is the blood-volume specific heat, and κ is the tissue thermal conductivity. This equation in this specific example can be further simplified if heat loss by perfusion is not present.

In general, treatment field profile delivered by thermal treatment devices is governed by two key conditions: thermal intensity and exposure time. A treatment is delivered, using for example, an RF device, at temperatures above 40° C. for 60 minutes and in other aspects, not restricted to heating and duration, include successfully induced treatment field profile at 70° C. for 60 seconds as a single exposure or two 70° C. exposures each for 30 seconds. Generated power can include many different power generated settings and one aspect can include, but is not restricted to 150 Watts producing 100° C. for 10 minutes. In another aspect, a high-frequency, alternating current with a wavelength of 460-500 KHz can be emitted through an electrode placed within the target area containing a composition of the present invention. A return electrode and/or a connection (i.e., for the returning current) applied to the composition complete the electrical circuit. When energy is applied to the circuit, it causes frictional heating in the composition due to the movement of electrons in the composition near the emission site. This heating can raise the temperature above 49° C. and induce a treatment field profile with at least one coagulation layer 400A (FIG. 14), mimicking soft tissue response, where heating above 49° C. leads to composition discoloration. Temperatures in excess of 60° C. can induce a treatment field profile comprising at least one layer with excessive coagulation or carbonization 400B. Alternatively, when temperatures exceed 105° C. the water begins to boil and releases vapor. In other aspects, an RF device induces composition state transition and produces a treatment field profile comprising one or more layers: a first coagulation layer adjacent to unaffected composition on one side and a second carbonization layer on the opposite side; the second carbonization layer encapsulates vapor vacuoles and inhibits the dispersion of energy, thereby reducing the effectiveness of heating and limiting the penetration of energy concentrations. RF treatment devices ideally induce a treatment field profile with temperatures sustained between 50° C. and 105° C.

According to an alternative aspect, treatment field profile can be sensitive to the surrounding thermal environment, for example the presence of structures, model elements, or mechanisms that act as heat sinks. A heat sink may be a treatment condition and comprises any medium, structure, or model element that absorbs and redistributes thermal energy away from the target area. The presence of a heat sink can alter the treatment field profile including treatment field profile formation rate, layer depth, shape, size, color, temperature gradient, and treatment completeness. In soft tissues, this effect is most often observed near boney elements or blood vessels where adjacent model elements with different thermal properties than a target area act as a dynamic heat sink, drawing thermal energy away from said target area and reducing local temperatures. For example, treatment in close proximity to perfused vessels often do not reach the thermal thresholds required for composition state transition, leading to formation of treatment field profile that is smaller, asymmetric, or incomplete. Anatomical model according to this invention may be configured as to comprise cooling elements capable of dissipating heat, such as channelized vessel elements filled with a circulating fluid that simulates blood. When treatment energy is applied in close proximity, typically within approximately 10 mm, and preferably less than 5 mm, simulated blood acts as a local heat sink, extracting heat from adjacent target area and altering the expected thermal distribution. This results in localized cooling and a measurable reduction in the volume and symmetry of the treatment field profile. Placement of cooling element or heat sink, the like of simulated blood flow, adjacent or within a target area changes the composition response to thermal treatment.

### 6.5 Simulation of Treatment Methods and Effects

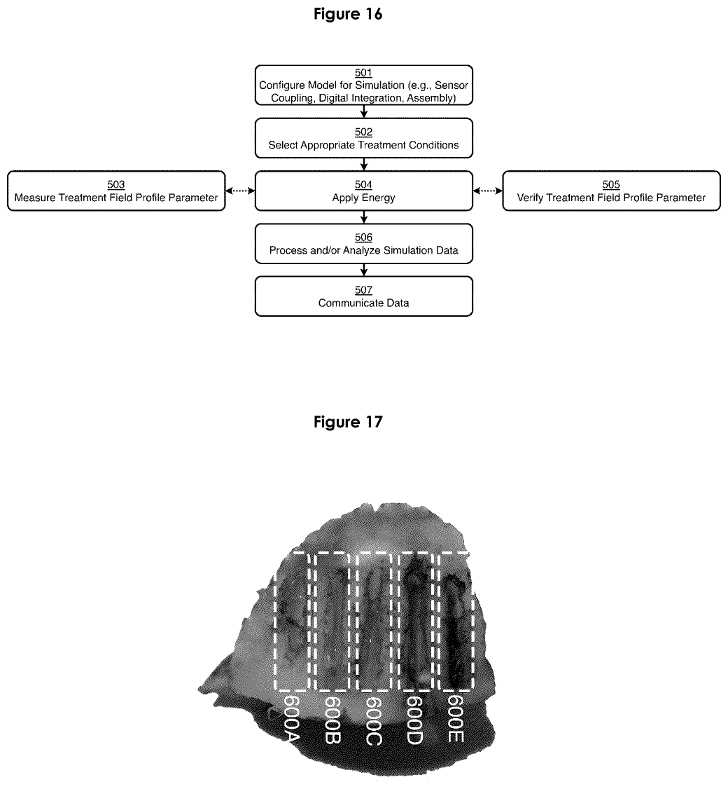

Accordingly, the present invention provides methods for simulating soft tissue response to treatment. Methods in FIG. 16 include the steps of: providing a treatment device; configuring the anatomical model containing composition and treatment device; applying energy for a period of time to induce composition state transition 504; and repeating the steps of applying energy. The anatomical model of the current disclosure comprises composition that when exposed to treatment energy undergoes state transitions like discoloration, denaturation, coagulation, vaporization, carbonization, or melting. Unlike conventional anatomical models such as the prostate anatomical model of U.S. Patent Application Publication No. 10,081,727, wherein the anatomical part (e.g., representing prostate) contains a dual-network alginate/acrylamide hydrogel material and covalently cross linked with N,N′-methylenebisacrylamide to permit the model to simulate thermomechanical treatment including cauterization, cutting, or fusing. If any of the simulated prostate, simulated seminal vesicles, simulated bladder, simulated urethra, and simulated vas deferens is made of material, a composition of the present invention may be provided to the model and model being configured to undergo a thermally induced reaction that produces controlled visible discoloration upon exposure to treatment energy, thereby simulating soft tissue response to treatment. When thermal energy is delivered to the composition heat increases and drives water vaporization, composition dehydration, and composition caramelization. Treatment effects generally tend to be nonspecific. Nevertheless, depending on the duration and peak value of the composition temperature achieved, different composition state transition may be distinguished and form a treatment field profile with at least one layer representing soft tissue response like denaturation, coagulation, vaporization, carbonization, melting or the combination thereof, at temperature threshold values. The treatment field profile having the above characteristics is obtained by reacting the composition of the present invention and additive by heating to produce discoloration. When heat is delivered temperature at the target area of the composition increases to over 60° C. and increases kinetic energy and induces heat reactions. Maillard's Reaction is one such reaction wherein reducing sugars and amino acids (e.g., from protein) react under heat. Dehydration and condensation is a crucial process in Maillard's Reaction. As the composition dehydrates it leads to the formation of Amadori rearrangement, subsequent dehydration, condensation, fragmentation of reactants, and Strecker degradation of amino acids. This process may release low molecular and reactive intermediates, such as dicarbonyl compounds including glyoxal, further heating decomposes the compounds which form a treatment field profile containing coagulation and carbonization layers at the target area. In general, when sufficient heat is applied, pyrolysis of organic compounds, like polymers, begins by breaking down the C—C bonds of the polymer backbone. The pyrolysis process for a polymer chain may proceed in three ways. First, the chain may degrade into small fragments and vaporize as H2, CO and CO2 gases, together with hydrocarbons such as CH4, C2H4 and C2H6. Second, the chain may collapse to form aromatic molecules, which may stack to form a lamellar plastic state. Third, the chain may transform into a conjugated carbon state without forming a plastic state, creating a carbonization layer also known as “char”. The present invention provides methods to modulate heat reactions in the composition which may prove useful in treatment simulation.

Direct and primary mechanisms utilized to modulate treatment field profile in organs and/or tissues containing composition of the present invention can include but are not restricted to heat, cold, chemical, osmotic, pressure, suction, and mechanical, electromagnetic including but not restricted to causing a current through the composition, and nuclear energetic destruction. Delivery mechanisms of treatment energy can include but are not restricted to IRE, HIFU, MW, RF, L, CryoT, chemical and adhesive and osmotic and packet delivery systems can include but are not restricted to liposomes and microbubbles and activated and deactivated materials that can be deactivated or activated by a second substance or treatment to include but not restricted to de-carboxylation and de-methylation and activation and inactivation with electromagnetic energy to include but not-restricted to visible light and UV to produce treatment field profile in the composition and in the local environment. Also exposing the composition and the local environment and non-target area (e.g., area not to be treated) to cooling elements such as but not restricted to chilled solution, such as chilled or frozen distilled water ionic solutions and non-ionic solutions; ionic solutions such as but not restricted to saline, non-ionic solution such as but not restricted to 5% dextrose water or distilled water. Combinations of treatment techniques can include but are not restricted to the following. Treatment techniques can be used in isolation or in combination. Multiple treatment techniques can be combined such as but not restricted to hyperthermia with adjuvant ablation and MR heating with ferromagnetic or HIFU with adjuvant ablation and local protective treatment.

An anatomical model containing a composition which undergoes controlled state transition as described herein is well-suited for simulating soft tissue thermal treatment. For example, a prostate anatomical model that is manufactured accordingly and contains composition configured to represent a wide range of tissue characteristics, for example, very thin elements (such as prostatic urethra, the prostatic capsule, and the prostatic fascia), elements of intermediate thickness (such as prostatic peripheral zone, the seminal vesicles, and the levator ani fascia), as well as thicker elements (such as the prostatic central zone and bladder neck). FIG. 17 is an image showing sequential treatment field profiles of an inventive hydrogel composition at power levels of 20 W, 30 W, 40 W, 50 W, and 60 W, from left to right. The progression demonstrates increasing treatment intensity and the development of a carbonized layer with higher power levels. Further, a prostate anatomical model can be combined in a simulator comprising one or more anatomical models to achieve realistic simulation of soft tissue thermal treatment and to determine a relationship between one or more treatment field profile parameters and one or more treatment conditions.

The method may comprise one or more steps of delivering thermal treatment to anatomical model containing the composition of the present invention and a treatment field profile is generated some known distance from the model surface. In one aspect, a treatment field profile may form radially, wherein the center of the treatment field profile, which receives the highest energy, starts to heat up and coagulate and carbonize. In this case, heat diffuses away from the center point (e.g., center of target area) and creates a treatment field profile with one or more layers containing composition with transitioned state in response to heat stimuli. In other words, characteristics of the treated composition are different than bordering untreated composition. In another aspect, a first treatment field profile, such as treatment profile in the adenoma element of prostate anatomical model, is radiopaque to facilitate visualization under ultrasound. A second treatment field profile, such as treatment in adipose tissue element surrounding the prostate element of prostate anatomical model, comprises composition that transitions to liquid or gel (e.g., melts) when heated and does not coagulate or carbonize and thus mimics treatment response of fatty tissue. In any of these examples, treatment field profile may be modulated or controlled by controlling the composition and additive.

The method may further comprise configuration of composition of the current invention to replicate treatment requirements wherein such requirements, for example, are based on the tissue type being simulated. Treatment requirements for simulated benign soft tissue, such as but not limited to the prostatic gland, differ from requirements for simulated carcinomas and simulated malignant tumors since complete treatment is typically less critical in benign tissue treatment, whereas tumor models may require higher fidelity in simulating complete thermal treatment coverage of the target area. For example, in a simulation of benign prostatic hyperplasia (BPH), it may be sufficient for the treatment field profile to cover up to 90% of the target area. In contrast, a tumor simulation may require the treatment field profile to extend across at least 90%, and ideally 100%, of the tumor target area and simulate complete treatment. In addition, composition may be configured to allow at least a second or more treatment events to achieve a desired treatment level. In one aspect, multiple treatment events may be performed to produce one or more treatment field profiles in the vicinity of the target area. In thermal treatment simulation scenarios involving multiple treatment field profiles or overlapping treatment field profiles, it may be appropriate to apply a staged energy delivery strategy, first delivering energy to a primary target area and then observing the thermal effects (e.g., composition state transition) in adjacent non-target area. This approach represents a “watch and wait” technique, where additional energy is withheld until a desired composition response (e.g., state transition) is created. In simulations of benign pathology, such as BPH, the strategy should include conservative energy application, favoring protection of adjacent non-target area and minimizing unnecessary treatment. Conversely, in simulations of malignant or aggressive tumors, the simulation objective may shift toward achieving full coverage of the target area, requiring more aggressive energy application to ensure complete coverage of the treatment profile field by complete state transition of composition throughout the target area, such as a simulated carcinoma target area.

Now turning to an example where energy is delivered to target area, such as carcinoma element in prostate model, through a treatment device including a catheter having a treatment electrode and at least one backplate placed proximal to the prostate anatomical model. In one aspect, the backplate(s) are coupled to a switching device for selecting which backplate to utilize as a return electrode to complete the circuit with the treatment electrode in order to obtain desired treatment field profile (or composition transition) for a given amount of energy. Additionally, a power delivery system for applying thermal treatment energy (e.g., 0.1 to 500 watts at least 100 times) to electrodes of the treatment device exists. With the treatment device having independent control of the anatomical model. A treatment delivery unit supplies a first controlled signal having a first power level, frequency (one per second to 1 GHZ), phase, and time duration (10 milliseconds to 1500 milliseconds) to the first electrode set in the composition of the carcinoma element and a second controlled signal having a second power level frequency (one per second to 25 per second), phase, and time duration (10 milliseconds to 1500 milliseconds) to the second electrode set in the composition of the carcinoma element or other plurality of composition electrically connected to a first composition. The total number of cycles is at least 100. Consequently, desired treatment field profile is not generated entirely at a first bipolar electrode set, and then at a second bipolar electrode set; rather there is a process wherein there is a gradual, incremental, and concurrent development of treatment field profile at all bipolar electrode sets. The difference between the first and second power levels and the temperature of the composition between the first and the second signals are monitored, for example by a monitoring and feedback unit, to control the treatment field profile generation. The supply of the first signal is terminated when the monitored temperature of the first signal exceeds a first predetermined value and the supply of the second signal is terminated when the monitored temperature of the second signal exceeds a second predetermined value. By adjusting the frequency and/or phase of the first and second signals, the relative amounts of bipolar and monopolar treatment can be adjusted for accurate control of the treatment field profile, such as the volume thereof. Treatment field profile generation may also be controlled by varying the deployment length of the electrodes. Unipolar energy may also be delivered to the carcinoma element through one or more electrodes in one or more probes. Energy delivered by each electrode can be controlled simultaneously and independently, the temperature of composition at each electrode can also be monitored simultaneously and independently so that the treatment field profile, such as the volume, produced by each electrode can be accurately controlled. Energy delivered to each electrode can be interrupted if a predetermined temperature or energy level is exceeded. Additionally, using treatment device, power signals having controllable peak-to-peak amplitudes are provided to electrode sets so that during a first period of time, a first amplitude signal is provided to a first electrode set and a second amplitude signal is provided to a second electrode set. The first amplitude is greater than the second amplitude and bipolar current flows from the first electrode set to the second electrode set. During a second period of time, a third amplitude signal is provided to the first electrode set and a fourth amplitude signal is provided to the second electrode set. The third amplitude and the current flows from the second electrode set to the first electrode set. Alternating first and second periods of time establish repetitive bipolar current flow between electrode sets. The addition of a backplate establishes unipolar current flow. Additionally, a multi-phase treatment device employing a two-dimensional or three-dimensional electrode array producing a multitude of currents paths in the target area. This results in more uniform treatment field profile, for example with a volume defined by the span of the electrode array. An orthogonal electrode catheter array can be used in conjunction with a two-phase power source to produce more uniform square-shaped treatment field profile of specified volume. A temperature sensor at the electrode tip allows monitoring of treatment field profile temperature and regulation thereof to minimize the electrode tips from being fouled by composition coagulation. The device may have an external auxiliary electrode to be used in combination with the catheter electrodes. The treatment field profile may be produced with a sequence of elementary electrode-electrical configurations. In other examples, one or more sets of electrodes are used to deliver energy to the carcinoma element wherein the use of one or more sets of electrodes in various combinations to create a 3D, long, linear treatment field and/or 3D non-linear treatment field profile in order to conform in volume and shape to the simulated carcinoma element.

Simulation may also include wherein a second electrode group set creates a reference electrode which, although not necessarily more symmetric relative to the first electrode group creates a virtual return path electrode whose position relative to the first electrode group can be predicted so that current can be directed from reaching non-target areas such as areas of critical elements like simulated blood vessels. The target area, such as the carcinoma element in prostate model can have an irregular shape or extend non-uniformly wherein production of treatment field profile of irregular shapes can be performed. For example, the prostate anatomical model allows the disposition of a first and second electrode groups of unequal lengths and/or in various directions at a distal end portion of at least one probe of the first electrode set, an irregular treatment field shape can be thus created that generally matches the size and shape of simulated carcinoma element. Wherein by the disposition of first and second electrode groups of unequal lengths and/or in various directions at a distal end portion of at least one probe of the first electrode set, a treatment field profile can be created that is offset from the probe central longitudinal axis in order to be directed towards the target area, such as carcinoma element, and away from adjacent non-target area. This aspect facilitates simulation of realistic movement of the treatment device to different target areas with repeated treatments at each new position to expand the overall treatment field profile including volume or shape. In real surgery these movements can result in unpredictable treatment field profile which can be either too small or larger than required, leading to unnecessary soft tissue destruction or harming adjacent critical element. In some aspects, generating larger treatment field profile, aside from increasing device size and number, includes the use of tip cooling with internal circulating fluids to alter and extend the delivered heat pattern surrounding the tip, or designs where devices deliver treatment energy (e.g., thermal energy) to the composition. The target area, such as simulated carcinoma element, can still exceed the generated treatment field profile including volume or shape, requiring device repositioning and repeated treatments. In addition, target area can be less than anticipated due to imperfections in the treatment field profile formation or other limitations.

Next, the method may involve applying combination of electrodes to control the treatment field profile including temperature gradient. Forming a treatment field profile includes providing a first electrode set having first and second electrode groups, the first electrode group including one or more electrodes and the second electrode group including one or more electrodes; applying energy for a period of time to the first electrode set capable of forming a first portion of the treatment field profile; and repeating the step of applying energy to the first electrode set. In the case of applying RF treatment to prostate anatomical model containing composition of the present invention, the preferred period of time for applying energy to the first electrode set may be in the range of 50 milliseconds to 500 milliseconds, and the application of energy to the first electrode set is preferably repeated at a frequency of once per second to 10 times per second, and the total number of repetitions is at least 100. To facilitate the delivery of energy to the target area, such as carcinoma element, voltage is delivered through an electrode, and a return path for the resultant current is provided through the prostate anatomical model. The applied energy need not be RF but instead, for example: conducted heat provided by a small resistive structure at the probe's active area excited with either AC or DC current stent along two conductive wires within the probe, or infrared energy in the infrared optical region radiated from the probe's active area, or coherent or non-coherent infrared radiation coupled down the probe and exiting the probe tip at a controlled angle to be absorbed by and heat the composition, or high frequency focused ultrasound.

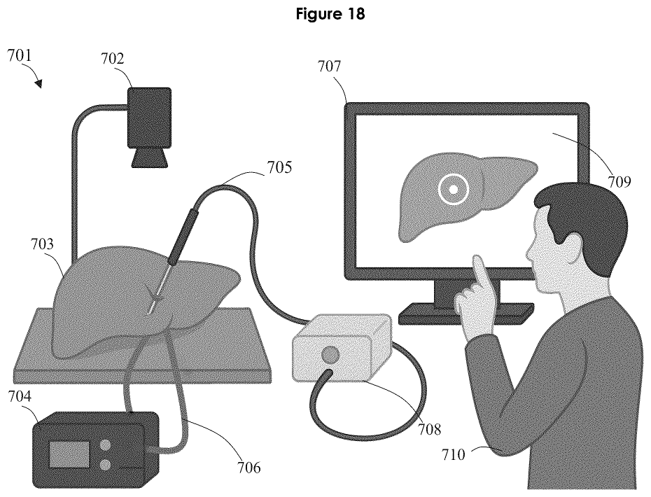

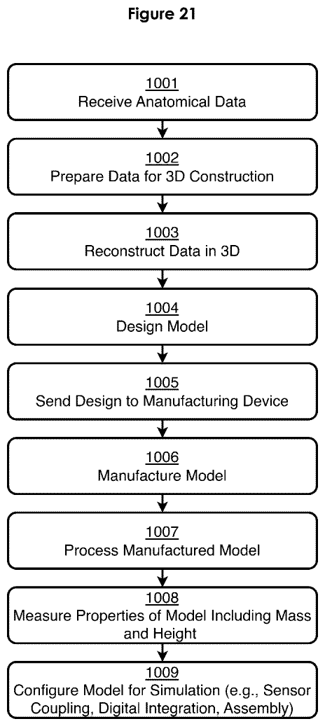

In aspects, a user may implement the methods described herein to simulate effects of electrocoagulation using electrodes wherein a composition of the present invention is coupled with an energy device following a prior art process, referenced by step 1009 in FIG. 21, wherein the energy device having two active terminals (outputs), one that delivers a voltage into the target area, such as carcinoma element of prostate model, and the other that serves as a return path for the resultant current. In one aspect, generator voltage output and return path input directed to an anatomical model coupled with first electrode (e.g., 705 of FIG. 18) results in the formation of an elliptical treatment field profile including a coagulation layer, as referenced by step 503 of FIG. 16. In the next step the generator activation is directed to a second electrode (e.g., placed some distance from a first electrode for example 2 mm) for a second treatment field profile, it is generally assumed, the elliptical treatment field profile. In theory, the overall outcome, is essentially identical treatment field profiles with some overlap, thus simulating elongated lesion in soft tissue.

Another step may entail using distal end portion of treatment probe with electrodes and probe insulation in accordance with a prior art process. The treatment output directed to electrodes, in this case is generally assumed, to result in the formation of a treatment field profile that is elliptical. But the initial condition of electrode is changed: a part of electrocoagulation covers and partially insulates electrode. Because of the higher resistance surrounding electrode, in practice the second treatment field profile will be smaller than the first treatment field profile and as well will be irregularly shaped.

Additionally, the composition at the target area exhibits heat decay which allows for advanced applications of treatment techniques such as application of one or more sequential duty cycles for a brief period of time for example, 100 milliseconds and when completed the cycle is repeated for example more than 100 times. The process of sequentially distributed then repeated very short applications of current can be simulated using composition of the present invention. For example, relatively one or more small treatment field profiles are created at the electrode sets with the treatment field profiles reaching volumes that are about predetermined target area volumes. One or more treatment field profile volumes can be lightly stippled to indicate further development of the treatment in each of the target areas. A later point in the process can be simulated, with the treatment field profile reaching volumes slightly larger and now darkly stippled. During this process, the electrode-composition interface resistance increases, as it normally does during soft tissue treatment development. In other aspects of this disclosure, the anatomical model, such as the prostate anatomical model, can accommodate one or more electrodes positioned within one or more target areas to form an electrode array. Some or all of the electrodes can be variably deployed within the anatomical model, for example, from a catheter lumen.

In another aspect, the user may configure the anatomical model for insertion of an insulated device with one or more electrodes in its distal portion that is guided by imaging modality, such as x-ray or ultrasound imaging, from one side of the model to a target area, such as carcinoma element, for the purpose of making either a treatment field profile with one or more coagulation layers or otherwise inducing composition state transition. In other aspects, the model allows for the insertion of devices of various configurations. The electrode of the device can be straight or sprung steel or a memory metal such as nitinol so that when extruded assume a curved shape. Various configurations such as parallel electrodes, loops, and baskets can be used.

In order to characterize thermal treatment the following steps can be taken. The order of these steps can be changed: anatomical model containing composition of the current invention is configured to receive a treatment device 501 (FIG. 16), treatment conditions are identified 502, a controlled amount of energy is applied 504, composition state transition is measured 503, temperature is measured by temperature meter, and one or more treatment field profile parameters are analyzed 506. In one aspect, other modules and systems contribute to the calculation as well. Temperature monitoring modules and/or systems acquire the data, perform averaging operations, and provide warning and ramp control as required. In another aspect, thermal treatment exposure time allocation module and pulse exposure allocation module calculate the required energy exposure time while impedance analysis module evaluates the impedance as measured when electrode connections are combined and separated and provides information to the control algorithm in the electrode phase calculator about the progress of the treatment and how voltage, power, and device selection are to be done. In other aspects, monitoring modules and systems can include advanced logic-based algorithms, plurality reference data such as database, logic control, and wireless communication.

Further, the anatomical model of the current invention allows the user to better evaluate the safety of treatment devices, treatment protocols, and treatment conditions (e.g., operation parameters). And, it is possible to characterize the potential adverse events associated with the intended use of a treatment system. For example, information about perforation of elements, production of treatment field profile in inappropriate locations, and production of treatment field profile on adjacent elements is possible to be collected during simulation. Treatment devices may also rely on ancillary devices which have their own safety risks which can confound the assessment of the safety of the treatment device. In a real clinical setting, wires and sheaths can induce thermal trauma to the patient. Therefore, performing preclinical safety study using an anatomical model containing a composition, such as the composition described herein, is dependent on the realism of the simulated treatment and the ability to configure the anatomical model in a way that represents the surgical approach and surgical environment. A user can further use simulation to glean information about preferred modes of operation, preferred device configuration, or preferred specimen orientation. Local safety assessment protocols may be developed which evaluate the treatment performed. The following treatment conditions can be evaluated as part of this protocol and include but are not limited to: damage to nearby and adjacent elements and perforations. A scoring system may be developed to facilitate evaluation of treatment field profile. Damage to adjacent elements may be simulated by transfer of energy from the target area to nearby elements. In other aspects, anatomical model of the current invention may be used to develop methods, devices, and/or systems that predict generation of treatment field profile or an aspect thereof.

There are at least three factors that can affect controlling treatment in simulation including: quality control, damage control, and treatment energy guidance. Quality control refers to maintenance of thermolysis quality to sustain the treatment field profile. For example, in laser treatment, the absorption properties may change with the formation of a treatment field profile. In order to generate the expected treatment field profile at the target area a certain energy has to be effectively converted into heat, facilitating the required temperature rise within the treated composition, as has been described thereabove. Temperature control dominates as the main tool for the quality control exploiting imaging techniques or temperature sensors, such as thermocouples or fluoroptic probes. Absorption spectral measurements may also be used to affect controlling the treatment field profile and thermolysis quality. Further, acoustic monitoring may be utilized. Second, damage control describes the process of controlling and/or monitoring the cutting or destruction depth as treatment field profile boundary is moved and/or created. Obviously, as soon as the boundary (e.g., surface) of treatment field profile is moved deeper into the composition, such as due to vaporization, the treatment process naturally stops until the treatment device moves further to the new boundary or surface of the treatment field profile. However, selecting the next cutting step has to prevent damage of adjacent non-target areas, such as simulated blood vessels element or simulated nerve element and prevent damage to the composition beyond the target area. This type of control has to determine the spatial expansion of the treatment field profile, discriminate critical elements avoiding their damage, and identify the elements being treated. A variety of devices and methods, referenced by 916 in FIG. 20, should be employed for this type of monitoring including probes to measure heat diffusion, reflection, absorption, scattering, acoustic signals, optoacous monitoring, optical coherence tomography. Lastly, guidance is critically important to adequately delineate the treatment field profile margins. In this case, an image modality is more preferable versus one point measurement for the sake of effective guidance. Ramen, infrared modalities, image modalities (e.g., fluorescence imaging, narrow band imaging, endoscopy, and auto-fluorescence endoscopy, acoustic) are non-limiting examples of guidance.

In other aspects, a treatment field profile parameter, whether performed by laser, plasma, or other energy delivery methods, can be detected, measured, and/or monitored. Treatment field profile parameter, also referred to as parameter hereafter, may include chemical, structural, thermal, mechanical, optical, electrical, magnetic, biological, cellular, and morphological characteristics, among others. In some aspects, the parameter is detected, measured, and/or monitored before, during, and/or after a treatment energy being applied. Methods, devices, and/or systems may be applied. In other aspects, the parameter enables optimization of one or more treatment conditions for applications such as medical device manufacturing, materials science research, tissue engineering, surgical care, surface engineering, quality control, predictive modeling, development of novel thermal treatment-based technologies, medical device marketing, among others. In other aspects, optimization of treatment conditions may depend on conditions informed by a range of disciplines.

In one aspect, the method of optimization may comprise performing dosing studies using anatomical model containing composition of the current invention. For example, one or more treatment field profiles are produced on the surface of an isolated skin anatomical model containing composition and placed within a recirculating solution kept at a constant temperature. The treatment device, such as an RF catheter, is fixated externally during the delivery of energy, which allows for precise control of catheter orientation and force. During RF treatment, rapid heating of composition can cause vapor bubble formation at the electrode-skin model interface. These bubbles create electrically insulating gaps that interrupt direct current flow, leading to the generation of plasma arcs. The plasma arcs deliver intense, localized energy, resulting in a treatment field profile through mechanisms beyond simple resistive heating, including molecular dissociation and photochemical effects. Plasma arcs can increase the extent of treatment field profile, and cause mechanical damage, such as micro-explosions and cavitation. Data generated can be used for different research and preclinical work, for example during a regulatory submission of a medical device.

In the assessment of treatment field profile parameter, monitoring methods can be used such as imaging methods that have been described in this invention. Additional methods may include the use of stains to demarcate treatment field profile. For example, a trichrome stain may be used to better visualize treatment field profile containing one or more layers. Other methods of studying parameter may be of relevance and importance. For example, correlating the treatment conditions with treatment field profile parameter (e.g., parameter) rely on the morphometry of the gross and/or cross sections of resulting treatment field profile. For these purposes, morphometry should be performed on the midlongitudinal cross section of each treatment field profile in an appropriate anatomical model. In another example, directly measured dimensions can be used for comparison which include maximum depth, maximum width, volume, and cross-sectional area. One or more such measurements or parameters can also be performed on one or more layers of the treatment field profile. Methods for estimating parameter may utilize formulae such as to approximate the volume of an ellipsoid. The following formulae or other formulae can be utilized to calculate parameter: V=¾ π (½B²) (A−C)−¼ π (½ D)² (A−2C) and π/6 (AB²+CD₂)/2) as a more accurate formula to estimate volume; wherein V is the volume, A is the total height, B is the main ellipsoid diameter, C is the height of the top cut, and D is the diameter of the removed ellipsoid. Some limitations exist with these formulae since treatment field volume may not present a true ellipsoidal shape and therefore improved formulae may be developed. In some aspects, dosing may be performed to characterize treatment field profile parameter. It is of preference to simulate treatment, for example using a model with enough composition depth, in order to perform a meaningful assessment regardless of the formula employed.

Another aspect describes configuration of one electrode unit, a treatment device or unit, and a sensor. Sensor is configured to detect parameter, such as indicative of temperature, pressure, cell viability, and/or flow. The treatment device is configured to deliver energy to composition by applying high intensity energy thereto. Treatment device is configured to apply a non-thermal treatment to the composition, typically so as to simulate portion of a clinical procedure. The parameter that sensor is configured to detect is typically a parameter that changes in response to transition in composition state. For example, impedance, temperature, osmolality, or other parameters can be detected when the composition is exposed to treatment conditions. A catheter, a longitudinal member, electrode unit, and/or treatment device are advanceable together, such as within and/or through a sheath. For some applications, sensor is also coupled to catheter and is advanceable therewith. In other aspects, temperature sensors such as thermocouples configured in the multielectrode probes within or close to some or all of the target area in order to provide information about composition state adjacent to each electrode. Although constantan and copper are used in prior art for the thermocouple junction, other metal pairs well known to the industry such as nickel-chromium and nickel can also be used. Temperature sensors allow feedback control in order to adjust current or application time to each electrode set if required. Similarly, impedance, current, voltage can also be monitored to assess the development of the treatment field profile at each target area, and adjustments made if indicated.

Additionally, following configuration of treatment device with the anatomical model as referenced in step 501, steps in FIG. 16 may follow for example step 503 wherein sensor detects a parameter important for simulation (e.g., temperature). For some applications, detecting temperature represents “natural” temperature. Treatment devices apply energy insufficient of inducing a composition state transition, such as to prevent formation of a treatment field profile, to the composition. After the start of the application of the energy (e.g., while the energy is being applied, or after it has stopped being applied) sensor detects a parameter relevant to composition (e.g., electrical current) 503. The energy may be calibrated in real time (e.g., by adjusting the amplitude, frequency and/or duty cycle) 502, so as to establish a current that results in a desired parameter change. Then, treatment devices apply thermal energy sufficient of inducing a composition state transition 504. After the start of application of the thermal energy (e.g., while the thermal energy is being applied, or after it has stopped being applied) 504, sensor detects a parameter (e.g., temperature) 503. For example, composition temperature may be detected after a duration in which the composition is allowed to respond to the increase in temperature. Treatment devices may be calibrated in real time (e.g., by adjusting amplitude, frequency and/or duty cycle) 502, so as to establish the energy that results in a desired change to the native state of the composition prior to thermal treatment. In some aspects two opposite-facing unidirectional treatment devices may be deployed, it is noted that for some applications, only one treatment device is used, and for some applications, the treatment device(s) are not unidirectional. For applications in which two treatment devices are deployed, the operation of the treatment devices may be temporally offset with respect to each other, so as to reduce interference therebetween. For example, although a relatively large timescale, the first treatment device may initiate induced parameter change at generally the same time as a second treatment device initiates induced parameter change, nevertheless, on a relatively small timescale, the parameter change is typically alternated (e.g., as in the application of alternating currents). Delivering thermal energy comprises a first application of thermal energy (e.g., RF energy) to target area, such as carcinoma element in prostate model. It is desirable to treat target area to a degree that is sufficient to achieve a desired parameter value or composition state which can be distinguished using a device and/or by visual inspection. The first application of energy is typically configured to be insufficient to cause composition state transition in target area, such as carcinoma element in prostate anatomical model, to the desired degree (e.g., insufficient to completely treat the simulated carcinoma). For example, first application may be configured to be sufficient to treat less than 80% volume (e.g., less than 50%, such as less than 20%) of target area. That is, the first application generates, in target area to be treated, a treatment field profile (e.g., a circumferential lesion) that is sufficient to the treatment simulation objective.

In another method of delivering energy to anatomical model, the anatomical model comprises an element that is multi-part comprising a target area containing the composition of the present invention, wherein the anatomical model represents skin for percutaneous treatment. For example, a treatment device is advanced percutaneously (e.g., transluminally, such as transfemorally) such that one or more electrodes and treatment devices are disposed within a target area, such as one or more parts of a benign lesion element. Thereby, electrode units and treatment devices are adjacent to respective portions of at least one part of the benign lesion element. Typically, sensor is configured to detect a parameter indicative of changes to the native state of the composition of the benign lesion element (e.g., sensor may comprise a temperature sensor). Typically, sensor is coupled to catheter such that when the electrode units and treatment devices are disposed in the target area, the sensor is disposed proximally and/or distally. For example, sensor may be disposed greater than 0.1 mm and/or less than 700 mm proximally from the treatment device and/or one or more components thereof. Alternatively, a simulation system may be configured with one or more sensors configured to detect one or more parameters useful in simulation. Following the delivery of energy to benign lesion element within the skin anatomical model, electrode units are typically expanded from a compressed delivery state, to an expanded state in which electrodes are placed in contact with a target area (e.g., simulated benign or malignant skin lesion element).

Parameters can be measured before, during, and/or after application of energy. After the start of the application of the treatment energy (e.g., while the treatment energy is being applied, or after it has stopped being applied) one or more sensors detect a change in the native state of the composition. For example, a sensor could detect a temperature change in the composition. For example, the temperature change may be detected after a duration in which composition temperature is allowed to respond to treatment energy applied. In aspects where the energy is at least in part blocked from propagating past the target area, the parameter measured is typically lower than detected previously. Configuration of the electrodes in the composition may improve detection of parameters measured. Subsequently, treatment energy delivery unit typically applies a second application of energy to the composition, thereby increasing the degree of treatment. Second application may have the same characteristics (e.g., intensity) as first application, or may be different (e.g., may have a greater or lower intensity). For example, if sensor determines that the reduction in measured parameter due to the first application of energy is significantly less than is desired, then second application of energy may be set to have a higher intensity than first application of energy. Similarly, if sensor determines that the reduction in measured parameter due to first application of energy is close to a desired parameter level (e.g., a desired value), then second application of energy may be set to have an equal or lower intensity than first application of energy. (In general, the intensity of applied energy may be varied using techniques known in the art, such as by varying amplitude, pulse width, frequency, duration of energy application, duty cycle of energy application, or other treatment condition[s]). Subsequent to second application of energy, a treatment energy delivery unit again initiates a response in the treated composition. Due to the increased treatment of the composition (e.g., increased carbonization of composition), energy is blocked from propagating past the target area, to a greater degree than it was from propagating past target area. After the start of the application of the energy (e.g., while the energy is being applied, or after it has sopped being applied) sensor detects a change in the native state of the composition. For example, temperature change may be detected after a duration in which the composition is allowed to respond to the energy applied. The duty cycle of treating the composition, initiating composition state transition, and changes to parameters may be repeated as necessary. For some applications, impedance between electrode units is measured at each duty cycle, so as to further facilitate the determination of the achieved degree of treatment. In one aspect, a technique of using a simulation system may be applied to repeatedly initiate energy, and treat, simulated prostatic tissue, and to repeatedly detect volume of the carbonization treatment field profile in presence and absence of the energy, and before and after the treatments. This treat-change-detect cycle (e.g., duty cycle) may be repeated as necessary to achieve a desired treatment field profile. As such, a suitable number of repetitions may be determined. Typically, this determination is performed after each detection of desired parameter subsequent to detection of desired parameter.

In the current invention it is possible to simulate heat-sinking effect. In soft tissue, heat-sinking can be used to reduce local treatment effectiveness and uniformity in tissue. Typically, heat sinks from blood vessels reduce treatment field profile size and reduce tissue temperature. In some aspects, heat-sinking can be considered a drawback and reduces effectiveness of treatment. In the current invention, a heat sink can be simulated, for example, by bathing the anatomical model in cooler solutions. In other aspects, vessels, elements, and/or pockets are created within the model to hold material, for example fluid filled simulated vasculature element, wherein such element allows for heat-sinking effect at the target area. Also the target area can be isolated or insulated from non-target area (e.g., area not to be treated). Or the target area can be surrounded by a material that reflects or locks-in the heat on the target area but spares surrounding non-target area such as but not restricted to a heat-conducting material on the inside facing the target area and an insulating material on the outside facing the non-target area to be protected. Reference is made to FIG. 18, which illustrates a simulation system in accordance with the parameters of the present invention. The illustration shows gallbladder anatomical model 703 and may include one or more of liver element, gallbladder element, peritoneum element, fascia element, duct(s), a base element, and one or more artery elements. In an alternative variation of the gallbladder model, the liver element is being made of composition of this invention in order to localize the surge areas to the area where a simulated procedure would be performed. In another variation of the gallbladder model, an artery is positioned near a target area and is coupled to fluid pump 704 with tube 706 to facilitate a heat sink effect, mimicking the cooling effect of blood flow in soft tissue. When treatment field profile is generated in close proximity to an element capable of conducting or dissipating heat, such as a simulated vessel greater than approximately 3 mm in diameter, the heat is carried away from the target area. This results in localized cooling and a corresponding reduction in the volume of treatment field profile.

In another aspect, carbonization treatment field profile can act as partial thermal insulator, limiting radial heat transfer from the target area to adjacent composition. And in the presence of actively cooling elements, such as, perfused vessel with simulated blood flow, the cooling effect from cooling element may exceed the insulating effect of carbonization layer. The presence of a heat sink transforms the thermal environment around the target area. It shifts the temperature profile, limits the extent of composition thermal interactions, and introduces asymmetry into the treatment field profile. Therefore, modulating heat-sinking may be advantageous in simulation. In one aspect, the anatomical model comprises heat-sensitive or thermochromic indicators to provide feedback on temperature distribution and treatment field profile parameter(s).

The anatomical model or model of this invention may comprise cooling elements. Cooling element(s) can take many forms. For example, a passive heat sink that conductively cools one or more portions of the anatomical model, such as a space of static, gas (e.g., argon), liquid (e.g., water, saline) or a solid (e.g., ice, ceramic plate), a phase change liquid selected which turns into a gas, or some combination thereof (e.g., a cylinder filled with water). In some aspects a cooling element can represent an anatomical element, such as bone, ribs, blood vessel, vascular bed, aorta, inferior vena cava, superior vena cava, pulmonary arteries, pulmonary veins, portal vein, hepatic veins, hepatic artery, renal arteries, renal veins, femoral arteries, femoral veins, iliac arteries, iliac veins, mesenteric arteries, mesenteric veins, splenic artery, splenic vein, carotid arteries, vertebral arteries, jugular veins, subclavian arteries, subclavian veins, brachiocephalic artery, brachiocephalic vein, coronary arteries, coronary sinus, left atrium, right atrium, left ventricle, right ventricle, mitral isthmus, atrial appendages, papillary muscles, pulmonary trunk, bronchial arteries, segmental and lobar pulmonary vessels, trachea, mainstem bronchi, cerebrospinal fluid spaces, lateral ventricles, third ventricle, fourth ventricle, cerebral aqueduct, central canal of the spinal cord, basilar artery, anterior cerebral artery, middle cerebral artery, posterior cerebral artery, internal carotid arteries, arteries and veins of the Circle of Willis, spinal venous plexus, vertebral venous plexus, cancellous bone, periosteal vasculature, bone marrow, liver parenchyma near the portal triad, kidney cortex and medulla near the hilum, adrenal glands, pancreas, spleen, bladder, uterus, rectum, ureter, prostate, seminal vesicles, ovaries, testicles, and pelvic venous plexuses. In other aspects, the cooling element can provide active cooling in the form of a spray or stream of gas or liquid, or gel, or aerosol particles for convective cooling of the anatomical model or the target area. Further, a cooling element positioned at some distance inside, outside, or both of a target area and has thermal properties different or similar to the target area. In other aspects, an active cooling element can comprise a thermally conductive element with an adjacent circulating fluid to carry away heat.

In yet another aspect, a heat sink effect can be facilitated using one method of incorporating thermally conductive materials, circulating cooling fluids, or inflatable elements that absorb and dissipate heat. In one example, stabilizing members are inflatable elements, such as balloons that can be inflated with air or liquid (saline) and are used in combination with a treatment device to absorb heat from the treatment device and reduce or eliminate treatment field profile formation in the non-target area in proximity to the treatment device. Thus, in one example, stabilizing members are inflatable elements, such as balloons that can be constructed of thermally conductive and/or thermally absorbing material, inflated with thermally conductive and/or thermally absorbing fluid, or comprise one or more thermally conductive and/or thermally absorbing materials covering at least a portion of the inflatable element, e.g., proximal to target area. Examples of thermally conductive or thermally absorbing materials or fluids include thermally conductive paints, thermally conductive epoxy or silicone coatings, or thermal phase change materials (PCMs). In one example, the inflatable elements function as a heat sink during operation of treatment device, such as RF cutting device. In yet other aspects, the cooling element may be insulating and poor conducting.

In other aspects, a cooling element is a component of a cooling unit. A cooling unit may include a water bolus, a fluid circulation unit, a spacing element filled with a suitable substance, one or more thermoelectric coolers, one or more Peltier elements, heat conductors, a heat sink, a nozzle spraying a cooling fluid to cool the applicator and/or to cool the target area, and others. The cooling unit may be configured to remove heat from the target area and create a reverse thermal gradient. When a specific temperature gradient is reached, the amount of energy delivered to the target area may be adjusted. Cooling alters heat distribution at the target area. The device may also comprise a heating unit to heat at least one portion of the target area. At least one portion of the target area may be cooled and/or heated during treatment or may be selectively switched on/off during treatment. The heating/cooling may be administered pre-simulation, during simulation, or post-simulation.

FIG. 18 shows a fluid circulation unit 704, such as pump, arranged to control the delivery (e.g., flow rate, velocity, and/or volume) of a cooling fluid, for example to a cooling element (e.g., simulated blood vessel) and/or target area using different pump rates and/or pump settings (e.g., pump volume). In some aspects, the pump may produce the cooling fluid before and/or in conjunction with delivery of the cooling fluid. For example, the pump may include a temperature control unit, which may be configured to adjust (e.g., reduce) a temperature of the fluid or another fluid introduced to the pump to produce a fluid (e.g., a cooling fluid) with a sufficiently cool temperature, such as a temperature below a threshold value. The temperature control unit may include a heat sink, a refrigerator, coolant (e.g., coolant circulating in one or more conduits), and/or the like, for example. In that regard, the temperature control unit may be configured to reduce a temperature (e.g., draw thermal energy from) of a fluid. The temperature control unit may additionally or alternatively include one or more components, such as a heat pump, configured to increase the temperature (e.g., supply thermal energy to) a fluid. For instance, the temperature control unit may be equipped to increase a temperature of a fluid such that the fluid is a suitable temperature to sustain treatment field profile, such as a temperature that maintains consistent rate of treatment field profile formation or composition state transition. In that regard, the temperature control unit may further include one or more sensors (e.g., thermometers) configured to determine a temperature of the fluid in the pump and/or a difference between the actual temperature of the fluid and a desired temperature of the fluid corresponding to a desired treatment. Moreover, in some aspects, a cooling fluid with a sufficient temperature for a particular level (e.g., degree) may be introduced into or included within the pump. Accordingly, the pump may refrain from adjusting the temperature of such a fluid. To that end, the temperature control unit may adjust the temperature of the fluid by operating based on a feedback loop associated with a difference between an actual and a desired fluid temperature. Further, the pump may output a fluid with temperature controlled by the temperature control unit (e.g., a cooling fluid) to the treatment energy delivery unit (e.g., via the tubing) at a certain rate, resulting in a corresponding volume of treatment field profile associated with the temperature of the cooling fluid and the delivery of the cooling fluid. To that end, the treatment field profile may be adjusted via control of the temperature and/or delivery of a cooling fluid provided via (e.g., output by) the pump.

The method may also involve the step of creating a virtual simulation or virtual treatment plan. Initially, the method may entail receiving user-defined input data (or user input data) on a specific surgical operation, such as the simulation(s) and treatment simulation objective(s) 921 (FIG. 20). User input data may be based on virtual anatomical model or may be provided prior to creation of an anatomical model. User input data may include treatment field profile parameter(s), treatment condition(s), planned simulation(s), simulation objective(s), final treatment condition(s), surgical workflow(s), or other treatment plan(s).

Another step may entail modifying the virtual anatomical model based on input of a planned simulation. Then, the method may entail creating a treatment plan of virtual model representative of the anatomical model configuration following the simulation. Another step in the plan may include adjustment of the anatomical model, which in turn may include anatomical model element, e.g., organ or tissue (one or more), translation in any plane or in 3D. Adjustment of the anatomical model may further include anatomical model element, e.g., organ or tissue (one or more), rotation about any plane or point, execution of incisions or treatments on the virtual anatomical model, or a device or element being inserted. Devices and/or implants may be stock or patient-specific. Adjustment of virtual anatomical model may include anatomical model element, e.g., organ or tissue, manipulation, implant insertion, and treatment device configuration. Preferably, measurement and treatment conditions will automatically update while modification of the virtual anatomical model is occurring.

It is expressly understood that the foregoing steps may be either automatic, manual or automatic with manual adjustments. Additionally, the method may include the step of evaluating the treatment plan and/or virtual anatomical model for acceptability.

In aspects, model elements (e.g., ligament, muscle, neuro, vascular, or hard tissue material) analysis may be included in virtual simulation or virtual treatment plan. Additionally or alternatively, hard tissue may be included in the virtual anatomical model described above. In other aspects, anatomical model characteristic(s) analysis, such as density analysis, may be included with the virtual anatomical model and/or treatment plan. The characteristic(s) analyzed may be global or regional, or specific to one or more anatomical model elements.

In some aspects, a machine learning (ML) program or algorithm may be provided. The ML is configured to suggest a treatment plan based on the similarity between a current simulation data set and one or more stored simulation data sets. A simulation data set may include, but is not limited to, simulation objectives and an anatomical model. In some cases, a simulation data set may comprise part or all of a previously executed simulation. The ML may access data from one or more databases 917, including records of simulation data sets or clinical treatment cases, to identify those with similar pathologies or simulation objectives. Based on outcomes associated with the identified similar simulation data sets, the ML is further configured to predict one or more achievable objectives for the current simulation data set. In certain aspects, similarity between simulation data sets may be determined by calculating a similarity score based on one or more attributes such as anatomical features, simulation parameters, simulation objectives, or favorable outcomes.

In other aspects, simulation of heat sink effect enables more accurate simulation and energy delivery optimization, especially of anatomically complex regions with significant vascular elements. Such simulation capabilities are particularly useful in guiding energy dosing, probe placement, and predicting treatment outcomes.

In aspects, a user may implement the methods described herein to plan treatment based on an achievable outcome, such as the outcome determined by ML. Alternatively, the method may incorporate data such as datasets from post-simulation data to filter out identified simulations to only positive outcomes.

In certain aspects, the method may utilize data such as a database of histopathology images to identify treatment conditions to help mimic surgical procedure, treatment, and treatment field profile. The ML algorithm may be configured to automatically predict parameters of the treatment field profile based off of user input of treatment condition(s).

In other aspects, ML provides proposed model element placement or position, treatment energy delivery unit configuration, cooling element configuration, patient-specific implants, or off the shelf implants. The ML algorithm may predict treatment field profile outside of the target area, based on data such as a database of post-op datasets. A ML algorithm may also be configured to predict anatomical model element or characteristic(s) thereof, such as composition, configuration, diameter, shape, size, conductivity, cell density, and/or mechanical properties based at least in part off of at least one of the following data; water content, density, imaging data, anatomical model data, user input, demographics, pathology, planned treatment, treatment condition(s), or tissue analysis.

The method as outlined in FIG. 16 may comprise the step of export and storing output 507 including (in the one or more databases) treatment condition(s), treatment field profile parameter(s), anatomical model, target area(s), user input(s), anatomical landmarks, etc. In other aspects, output 507 is exported and stored in computer memory. In yet other aspects, output is exported to devices and systems useful for simulation or treatment planning, such as treatment device, treatment guidance system, or a database.

A software program 709 (FIG. 18) may be provided to enable end user (e.g. training surgeon) 710 to view the virtual anatomical model, target area, treatment condition(s), treatment field profile parameters, and planned simulation and accept/reject one or more aspects of treatment plan via a user interface. The treatment plan may be automatically updated based on input data (e.g., from a user), and in turn a new treatment plan may be generated for further evaluation or approval. Although aspects described above relate to soft tissue treatment simulation, planning may be expanded into patient-specific soft tissue treatment and energy applications. Regardless, the method may further comprise manufacturing one or more implants, auxiliary devices, or treatment devices based on the treatment plan.

### 6.6 Simulation Anatomical Models and Configurations

Attention is now directed to certain configurations of the anatomical model associated with the present invention, which are provided as exemplary aspects and should not be construed as limiting in any way. In some aspects, the anatomical model configurations themselves constitute part or all of the anatomical model data used by the system.

The anatomical model of the current invention is suitable for use in treatment simulation and can include, but not limited to, one or more geometries, tissue elements, and compositions (including composition of the current invention). In one aspect, the anatomical model may be designed to replicate human or non-human elements and can be constructed using hydrogel-based or non-hydrogel-based composition. An anatomical model can represent a liver, prostate, stomach, brain, muscle, skin, fat, or bone. In another aspect, the anatomical model can comprise cellularized and/or decellularized composition; and cellularized composition may contain cell seeding density of 0.5×10⁴ to 2×10⁷ cells/mL. Non-hydrogel-based anatomical models may incorporate polymer composition, elastomers, plastics, plant based composition, silicone-based composition, or other synthetic or biomimetic composition configured to resemble the structural and functional characteristics of tissues or organs. In various aspects, the anatomical model may be configured to replicate one or more properties of soft tissue across physical, thermal, electrical, magnetic, optical, acoustic, chemical, and biological domains. The anatomical model may mimic these properties individually or in combination, enabling realistic interaction with devices, instruments, surgical systems, imaging systems, and energy-delivery devices. The anatomical model may exhibit mechanical properties, including but not limited to elasticity, viscoelasticity, compliance, tensile and compressive strength, shear resistance, plastic deformation, fracture mechanics, and fatigue behavior. Thermal properties may include thermal conductivity, specific heat capacity, thermal diffusivity, heat retention, melting point, freezing point, and cooling or warming rates. Electrical and electromagnetic properties may include dielectric constant, impedance, permittivity, conductivity, resistivity, electromagnetic absorption, RF or microwave responsiveness, and capacitive or inductive characteristics. Acoustic properties may include acoustic impedance, attenuation, speed of sound, reflectivity, echogenicity, and compatibility with ultrasound imaging. Optical properties may include light absorption, transmission, scattering, refractive index, fluorescence, and interaction with laser energy. The anatomical model may also replicate chemical properties such as pH buffering capacity, chemical stability, hydrophilicity or hydrophobicity, degradation kinetics, solubility, diffusion of drugs or markers, and compatibility with reagents or contrast agents. In certain aspects, the model may simulate biological or cellular behaviors, including cytotoxicity, protein adhesion, enzymatic activity, immune response, enzymatic degradation, and support for cellular adhesion, migration, proliferation, or necrosis studies. In some aspects, the anatomical model, partially or fully, may be configured to mimic soft tissue properties, such as perfusion, density, or vascularization. It should be understood that the foregoing list of properties is non-limiting, and the anatomical model may additionally replicate other physical, chemical, electrical, biological, or functional properties of soft tissue, including properties that may become known or deemed relevant after the date of this disclosure, to the extent such properties facilitate the intended use or performance of the model.

These aspects or properties constitute part or all of the anatomical model data and may further be utilized to depicting treatment, surgical techniques, device-tissue interactions, treatment field profile, thermal spread, mechanical disruption, or chemical diffusion in a clinically relevant context.

In another aspect, the anatomical model may be configured to facilitate detecting one or more treatment field profile parameters, including volume, number of treatment field profile layers and measures thereof, the amount of composition removed, and thermal effects (such as composition state transition). Treatment may be performed using an treatment energy delivery unit 906 under operator control and one or more treatment conditions can be adjusted including, but not limited to: treatment device, power level, mode of energy delivery (e.g., continuous or pulsed), pulse duration, scanning frequency, repetition rate, exposure time, treatment depth, and the thermal impact within the anatomical model. In other aspects, the anatomical model facilitates simulation of unintended treatment. In yet another aspect, the anatomical model is configured to simulate surgical workflows including but not limited to percutaneous or open access, localization of target area, device placement, delivery of treatment (e.g., thermal, radiofrequency, cryogenic, MW, or L), and subsequent visualization and assessment of composition response (e.g., composition state transition). In one aspect, the anatomical model is configured to receive real time imaging modalities, including but not limited to ultrasound, MRI, and CT, and may incorporate embedded markers or reference elements for alignment and targeting. The anatomical model can further facilitate the evaluation and optimization of treatment, surgical techniques, training protocols, and treatment devices. In other aspects, the anatomical model can be configured to partially or fully replicate anatomies or anatomical systems, including but not limited to prostate, liver, breast, hypogastric nerve, and cardiovascular system. The anatomical model may further incorporate embedded sensors, fiducial markers, or other integrated components configured to detect, monitor, calculate, and communicate parameters such as temperature, electrical conductivity, impedance, and mechanical deformation.

Anatomical model of the current invention comprises dry heat composition that when exposed to treatment energy produces a lifelike treatment field profile. Unlike conventional anatomical models, such as the prostate anatomical model of U.S. Pat. No. 10,081,727 described above, wherein the model contains a dual-network alginate/acrylamide hydrogel material and covalently cross linked with N,N′-methylenebisacrylamide to permit the model to simulate cauterization, cutting, or fusing. If any of the simulated prostate, simulated seminal vesicles, simulated bladder, simulated urethra, and simulated vas deferens is made of composition containing the additive of the present invention, the treatment field profile differs under treatment conditions and material conditions. According to the current invention, when energy is delivered to a target area containing the composition of the present invention, heat increases and drives water vaporization, composition dehydration, and in some aspects caramelization. Composition state transition generally tend to be nonspecific. Nevertheless, depending on the duration and peak value of the temperature achieved at the target area and due to energy delivery, a degree of composition state transition may be distinguished. In this case, composition state transition may define a treatment field profile containing one or more layers and representing controlled soft tissue thermal interaction such as denaturation, coagulation, vaporization, carbonization, melting, or other energy-induced tissue transition or change at temperature threshold values.

Treatment of soft tissue generates distinguished layers known in the art and comprise (1) a no tissue survival layer, within the thermal or target area. This layer is created with temperatures over 55° C.; (2) heating with short-term tissue survival, where the tissues are alive, have an intact blood pressure, and survive at least for a period from several seconds to a few hours after the heating event. This layer has temperatures between 45° C. to 55° C. Usually this layer is located at the margins of the ‘no-survival’ layer (in surgical and clinical practice, this layer is of particular importance as heat-injured cells located at the cooler surface of the ‘no-survival’ layer may remain functioning where in the case of tumor treatment, such cells can repair themselves and survive, leading to tumor recurrence. This is the reason why it is a standard surgical practice to apply treatment energy to an extra of 3-15 mm around the visible surface of the tumor); (3) heating with prolonged tissue survival (for example, hours to months) happening at 40° C. to 45° C. These layers are important in clinical practice and simulation. By containing the additive of the present invention, the degree of treatment field profile is controlled under energy conditions and material conditions, and in some cases, treatment occurs only when specific energy thresholds are met. That is, it is easy to produce specific composition state transition under energy conditions and difficult to produce composition state transition under material conditions. In addition, since the degree of treatment field profile can be adjusted by adjusting the type and content of the additive of the present invention, the progress and completion of the composition state transition (e.g., due to thermal energy) can be confirmed according to the degree of treatment profile.

In one aspect, the anatomical model, according to the current invention, comprises dry heat composition that when exposed to thermal energy undergoes a state transition and produces lifelike treatment field profile (including denaturation, coagulation, carbonization, or vaporization at temperature threshold values). In the event, the composition in the entirety of an anatomical model is configured such that the composition does not contain the additive of the present invention, treatment proceeds rapidly, and the composition melts and there is not much difference in color different between the treated area and the unaffected area. In the case of the current disclosure, the additive of the current invention can adjust the degree of the treatment field profile by improving the reaction kinetics (e.g., between reducing sugar compound and amine containing compound) and the progress and completion of the treatment can be adjusted to the degree of the treatment field profile. Can be confirmed accordingly. The relationship between the treatment time and the degree of treatment field profile is appropriately set according to the treatment conditions (e.g., temperature) and the types and/or contents of the additive of the current invention.

In one aspect, treatment field profile is associated with temperature threshold values applied by treatment device. For some treatment mode (e.g., continuous treatment) the greatest temperatures exist nearest to the treatment device, with successively lower temperatures at more distant radial locations and forms a treatment field profile comprised of one or more layers. In one aspect, a treatment field profile is comprised of one or more layers wherein at least one layer formed at temperature threshold (e.g., carbonization layer) is closest to the treatment device, or at least one layer formed with lower temperature threshold than the carbonization layer (e.g., coagulation layer) and is adjacent to the carbonization layer and farther from the treatment device, or at least one layer formed at even lower temperature threshold than the coagulation layer (e.g., transition layer) is adjacent to the coagulation layer and further farther from the treatment device and is adjacent to non-treated composition. In other aspects, treatment field profile comprises one or more layers that represent one or more soft tissue treatment interactions like denaturation, coagulation, vaporization, carbonization, or melting at temperature threshold values. In yet another aspect, the treatment field profile comprises one or more layers that undergo state transition according to treatment duration and energy. In one aspect, modulating treatment conditions changes (e.g., modulate, increase, decrease, activate, deactivate) treatment field profile layer number, type, depth, or color, among other characteristics. In one aspect, compared with the continuous treatment mode, periodic intermittent pulsed treatment output (e.g., using MW) can reduce treatment field profile layer thickness. For example, the maximum length and width of carbonization layer may decrease by 5% to 80% by modulating the pulsing mode and intermittent time of MW protocols with fixed heating time of 300 s.

In another aspect, dry heat composition is incorporated within a large anatomical model with one or more compositions representing a variety of soft tissues and/or organs, and, such anatomical model is configured to receive clinical intervention, for example, to simulate dissection, specifically, the term ‘dissection’ is action of dissection, division, incision, or resection of composition (for example, composition of adenoma element of prostate model). Particularly, since the composition has the aforementioned properties, an anatomical model with at least one composition is suitable to simulate incision and/or dissection with a surgical energy device (such as a cautery knife, ultrasonic knife, or a high frequency radio wave knife). An example of a more specific use of an anatomical model according to the present invention includes performing surgical method such as cholecystectomy, aquablation, endoscopic submucosal dissection (ESD), cool-ablation, coblation, prostate nerve-sparing surgery, per oral endoscopic myomectomy (POEM), endoscopic full-thickness resection (EFTR), or dissection (for example, lymph node dissection). In addition, the anatomical model, according to the present invention, is also configured to receive transurethral enucleation with bipolar energy (TUEB), which is done using a bipolar electrosurgical loop to simulate separation of prostatic tissue from prostatic capsule.

Additionally, determination of the likely location of attempted treatment is performed. When a composition is incised or dissected with a scalpel, a surgical knife, or a treatment device (such as cautery knife), the composition gives moderate changes of feeling and generates a specific sense of dissection in the composition. In addition, when the composition is dissected, the composition being dissected exhibits noticeable features similar of fibrous connective tissue. As the scalpel or dissection devices moves through the composition, the composition may stretch and pull before finally giving away with a subtle tear. In a non-limiting example where an existing composition (for example, a hydrogel based composition contained in prostate anatomical model) is incised with a treatment device (such as a cautery knife) and the solid content of the composition may form a treatment field profile. Furthermore, in an existing prostate anatomical model (particularly, a prostate anatomical model including a hydrogel based composition), when the anatomical model is incised with a treatment device (such as a surgical laser), char layer may be generated as the composition is treated.

An anatomical model is substantially made of any one of the dry heat compositions disclosed in this invention. In one aspect, the anatomical model may be configured to contain one or more elements that represent an artificial human organ including simulated ovary portion, a uterine horn portion, uterus, ovary, fallopian tube, vagina, cervix, bladder, omentum, and peritoneum. The peritoneum and omentum may further include embedded elements, such as tumors, vasculature, hollow or solid, also made of the composition of the present invention. Other organs that are made of the composition of this invention and form at least part of an anatomical model include stomach, kidney, rectum, aorta, tumor, cyst, and polyp. Any of the anatomical models containing a composition described herein may include a mesh element. Further, the anatomical model disclosed herein is applicable to all treatment simulation scenarios and can be used as an anatomical model of lung, liver, heart, abdominal wall, skin, diaphragm, gallbladder, stomach (inner wall), kidney, bladder (inner wall), uterus, or intestines and the like. It is also possible to use the anatomical model as a model that resembles a specific tissue in a certain viscus (for example, submucosa of the stomach). By appropriately changing the shape and composition properties of the anatomical model, the anatomical model can be used as a tubular anatomical model resembling, for example, blood vessel, esophagus, stomach (hollow), small intestine, ureter, urethra, vagina, anus, or portal vein and the like. In other aspects, the anatomical model may contain non-anatomical elements.

In an alternative aspect, an anatomical model may contain one or more elements containing at least one or more compositions. For example, as described herein, at least one part of an anatomical model may contain a first composition having an 8:3 formula and a second part containing a second composition having an 8:1 formula. Also, a third part of an anatomical model may contain a third hydrogel based composition according to the present invention and a fourth part containing a silicone or other fourth composition and attached, connected, adjacent or in juxtaposition to the part made of hydrogel based composition. For example, in a TUEB simulator, an artificial bladder and urethra are made of silicone and an artificial prostate, prostatic adenoma, and vessels are made of hydrogel having a composition described herein. In another example, in a TUEB simulator the bladder element is made of silicone and all other parts of the TUEB simulator are made of hydrogel having a composition described herein. In another example, an artificial urethra is made of silicone and artificial prostatic adenoma of hydrogel composition described herein are adhered to the silicone urethra using cyanoacrylate glue.

In use, the anatomical model according to the present invention is configured to receive treatment devices, including but not limited to monopolar, bipolar, harmonic or other devices commonly used in treatment. The anatomical model provides a realistic environment configured into an anatomical model or portion thereof to facilitate the practice of operating treatment devices, learning treatment techniques, and performing surgical procedures that involve treatment alone or in combination with other instruments. The handling of treatment devices requires hands-on training and practice as does applying surgical techniques and learning specific procedures performed with the treatment devices. When a treatment device is applied, heat is generated as kinetic energy increases in the target area and alters chemical and physical properties of the composition. Typically, in treatment simulation, the progress and completion of management of treatment devices, as well as the use of surgical techniques and the learning of specific procedures performed with treatment devices can be confirmed according to the degree of treatment field profile.

In one aspect, the anatomical model comprises an element that is multi-part, wherein the first part is composed of a first composition and one or more subsequent parts may be added to a first side of the first part and have composition different from the first part. In this case, when each composition is exposed to the same or different treatment conditions, composition state transition or treatment field profile specific of each part is detected and represents one or more thermal soft tissue interactions including discoloration, denaturation, coagulation, vaporization, carbonization, melting, or other thermal soft tissue interactions known in the art. Further, when one or more composition exposed to treatment energy a distinguished treatment field profile is formed. For example, treatment field profile formed may represent soft tissue carbonization and characterized by a char (black in color) and may further facilitate rapid vaporization. In another aspect, one or more composition exposed to treatment energy forms a distinguished treatment field and may represent soft tissue coagulation and when exposed to treatment energy it undergoes irreversible chemical and structural changes, including but not limited to, photo/polymer cross-linking, protein-like denaturation, structural collapse, fusion, dense network formation, cellular damage or death, or color change for example light yellow or brown in color judged with the naked eye. In yet another aspect, one or more composition exposed to treatment energy forms a distinguished treatment field such as a transition layer and exhibits one or more of the following: partially cross-linked chains, intermediate stiffness, intermediate opacity, or gradual color gradient judged with the naked eye.

Any one of the compositions disclosed herein can be contained by an anatomical model to facilitate simulation of surgical techniques. In one aspect, endoscopic electro-surgical procedure is simulated. And an anatomical model containing a composition is disposed inside an enclosure. An example of an enclosure includes a simulator or surgical trainer 200 in which an endoscope may be utilized to visualize the surgical field. An anatomical model containing composition of the present invention is not limited to artificial vessels, arteries, veins, one or more organs and tissues, hollow or solid, associated with a human organ, such as a prostate, as described above and suitable for practicing TUEB. Also, an anatomical model for TUEB may be manufactured with one or more elements of at least one composition described herein and element represents a lateral lobe, anterior lobe, urethra, posterior lobe, median lobe, ejaculatory duct, capsule, and vascular pedicle. In an alternative variation, a simulated vascular pedicle element contains a fluid. In this case, the vascular pedicle facilitates heat sink effect during treatment. Of course, the model need not have a curved shape. Any of the anatomical model may include tissue growth element to be practiced for removal using energy.

An exemplary anatomical model containing a composition described in this specification is shown in FIGS. 1-2. The anatomical model is a prostate anatomical model 100. The prostate anatomical model 100 includes at least a lumen 105, capsule 101, gland 104, and landmarks made of any one of the composition described herein and dyed to resemble soft tissue. In one variation, the composition is made from a dual interpenetrated cross-linked hydrogel network. The composition is a mixture of at least one base polymer compound that is ionically and/or covalently cross-linked. In the context of this illustrative embodiment, the composition is prepared by mixing a ratio of approximately 10:1 one or more additive of this invention, to PVA and water. In order to make the anatomical model that is more realistic, at least a coloring agent can be incorporated into the process. A coloring agent is added at any point in time during a manufacturing process, for example, a coloring agent is added prior to the deionized water being mixed with the PVA. The amount of a coloring agent used depends on the anatomical model being manufactured. The water content of the composition is approximately 60% (v/v). At least one base polymer compound is added to a solvent (e.g., water) to form a composition mixture at approximately 2% (w/v) to 50% (w/v), and preferably 6% (w/v) to 20% (w/v). For example, water is mixed with solid PVA (as a base polymer compound) at a concentration of 12% (w/v), creating a PVA-water composition.

A composition mixture is cured to form a solid composition, such as a hydrogel. The additive of the current invention is added at different concentrations. In some aspects, the additive may be added at any time during a manufacturing process to control properties of composition. For example, additive of the current invention, such as sodium sorbate, is added to a PVA-water composition to reach final additive concentration of 0.01% (w/v) to 5% (w/v), and preferably 0.1% (w/v) to 1% (w/v). Additive of the current invention, such as Polyethylene glycol (PEG), can be added during a manufacturing process to adjust the steps thereof. For example, PEG having a molecular weight in the range of about 200 to about 5,000 g/mol, preferably from about 300 to about 1,000 g/mol, and more preferably around 400 g/mol may be added as a co-solvent to improve a manufacturing step, such as mixing of a composition mixture. In other aspects, additive of the current invention added to a manufacturing process can alter one or more composition properties. For example, glycerol is one additive that can control cross-linking rate of composition. In yet other aspects, additive of the current invention can be removed from a manufacturing process. For example, in order to control electrical impedance of composition, removal of salt additive can be achieved, wherein precipitation is one such removal method. Thus, during a manufacturing process, additive of the current invention can be added, removed, or a combination thereof to achieve desired composition properties.

In some aspects, the composition can be cured to form a solid composition that is a hydrogel. The hydrogel contains water and is viscoelastic. And the hydrogel is used in replicas of soft tissues or elements. The application of hydrogel in an anatomical model allows to create realistic and dynamic anatomical models that are lifelike and energy device compatible. For example, anatomical model containing composition of the present invention closely resembles and reacts to manipulation with treatment devices similar to soft tissues. In other words, the composition of the current invention is used in replicas of soft tissues compatible with one or more steps of treatment process including, providing treatment device, determining a target area, positioning of treatment device, delivery of energy, formation of treatment field profile, feedback and monitoring, data collection, cooling or recovery, and post-treatment assessment.

Further, the prostate anatomical model 100 is a replica of a human prostate and further includes a first cavity defining a first lumen 105 and extending between a proximal end 102 and a distal end 106. The lumen may be shaped like a healthy lumen and in other aspects the lumen comprises lobes 104, such as lobes indicating unhealthy enlargement of the prostate such as in BPH. And the lumen is dimensioned to receive a surgical instrument of some type.

In one aspect, a prostate model 100 comprises one or more elements that are landmarks. Said landmarks facilitate simulation of surgical procedure, for example, a landmark, such as verumontanum element 103, facilitates orientation of a surgical instrument of some type in a lumen of prostate anatomical model. In some aspects, a landmark may be positioned on a surface, beneath a surface, along a surface, or the combination thereof.

Another aspect of the present disclosure is to provide a method for preparing a prostate anatomical model which in a preferred aspect may include any one or more of the following soft tissue replicas or elements: prostate, glandular tissue, capsule, seminal vesicles, bladder, urethra, penis, vagina, vasculature, nerve bundle, and vas deferens. In one aspect one or more replicas are made of one or a combination of the materials silicone, urethane, polymer, plastic, hydrogel, foam. In one aspect, the composition is hydrogel and is selected to have a ratio of approximately 4:1 additive to PVA and approximately 50% water.

In another aspect the prostate anatomical model may include a multi-part element. More specifically, the prostate model has a laminate element including a second part; a third part provided on one surface of the second part; and a first part provided on the other surface of the second part. The multi-part element may be changed appropriately depending on the intended use. Furthermore, each part in a multi-part element may comprise a distinct composition, wherein variations in composition across parts result in corresponding variations in the formed treatment field profile as long as a part used in a surgery has a degree of treatment field profile. For example, a treatment device delivers heat to one element and reaches a temperature of 45° C. to 120° C. (preferably 80° C. to 100° C.) and produces a treatment field profile containing a carbonization layer of depth 0.1 μm to 10000 μm (preferably 5 μm to 25 μm). A treatment field profile may facilitate any composition state transition mentioned previously.

Further, one or more subsequent parts may be applied over a first part, and are formulated to facilitate adhesion to surrounding elements, such as other hydrogel, silicone, plastic, or combinations thereof. One or more subsequent part may incorporate specific chemical or physical properties, such as adhesive polymers, crosslinking agents, micro-textured surfaces, interlocking elements, or a combination thereof to promote sufficient contact with adjacent elements. A part is made of any one of the compositions described herein and dyed to have a tissue like color to represent a soft tissue replica, for example a capsule. The part is made of one or a combination of the materials silicone, polymer, urethane, plastic, plastic, hydrogel, foam. In one variation, a hydrogel based composition is selected to have a ratio of approximately 3:1 collagen to PVA and approximately 40% water. Furthermore, any plurality of parts may be made of a composition similar to that of another part or may be made of a different composition. Other parts may be made of a hydrogel based composition, or a soft composition other than a hydrogel based composition. Alternatively, other parts may include a hard composition (or may be made of a hard composition).

In another aspect, the prostate anatomical model comprises a rectal element located and embedded on one side of the prostate element. In one aspect, the rectal element is in direct contact with the prostate element. In another aspect, the rectal element is located at the posterior side of the prostate element. In yet another aspect, the rectal element further includes any one or more of the following anatomical elements: anus, rectal cavity, valves of Houston, polyps, transverse folds, and mucosal tissue. One or more of said elements are made of one or a combination of the materials silicone, polymer, urethane, plastic, hydrogel, foam. In other aspects the anatomical model may be compatible with imaging modalities such as ultrasound.

### 6.7 Materials and Production Methods

Dry treatment energy discoloration composition. The composition of the present invention is a dry heat discoloration composition containing a polymer, a curing agent, a binder, filler, and a solvent, and further contains at least one of sugar and amine. It is characterized by doing. The dry energy color-changing composition of the present invention having the above characteristics is obtained by reacting sugar compound and amine compound by heating to produce dark carbon compound. However, sugar and amine are used as additives. By containing at least one of these, the degree of discoloration differs under dry heat conditions and wet heat conditions, or discoloration occurs only under dry conditions. That is, it is easy to discolor under dry heat conditions and hardly discolor under wet heat conditions. In some aspects, the composition is referred to as polymer gel composition or polymer composition.

In addition, since the degree of discoloration can be adjusted by adjusting the type and content of the additive, the progress and completion of the treatment field profile can be confirmed according to the degree of discoloration. Therefore, according to the dry heat discoloration profile using the dry heat discoloration composition of the present invention, whether or not the dry heat conditions suitable for the treatment are obtained when thermal treatment is performed, and whether the treatment is surely completed. It is possible to judge accurately.

The polymer gel composition of the present invention is not limited as long as it is a polymer gel capable of forming a three-dimensional, optionally viscoelastic matrix. It is preferable to use as base polymer gel a constituent that is white or light in color and facilitates browning reaction (e.g., Maillard's Reaction), polymer gel such as polyvinyl alcohols (PVA), polyethylene glycols, and polyacrylamides, or a natural gel material such as cellulose, starch, alginate, agar, and collagen (dry heat composition may contain many different types of polymer gel). Polymer gel may be modified at least partially (for example, PVA may be modified-PVA, including anionic-modified PVA, cationic modified-PVA, and nonionic-modified-PVA). To solve the problem of the present invention it is particularly preferable that the composition is a PVA (PVA gel) or that the composition contains a PVA as a base polymer constituent. Two other examples of replacement polymer gel compounds are an acrylic based gel and a clay based gel. Other examples of polymer gel include polyethylene glycol, polyacrylamide, cellulose and its derivatives, chitosan, polyaniline, and their chemically modified forms such as carboxylated, acetylated, or oxidized variants. Among these polymers, at least one selected from the group consisting of PVA, chitosan, and carboxylated cellulose derivatives is preferable. These polymers may possess functional groups including hydroxyl, carboxyl, or sulfhydryl moieties that facilitate nucleophilic attack or bonding with amine groups, facilitating formation of covalent bonds through amination, Schiff base formation, or other related reaction pathways. The choice of polymer depends on the desired mechanical, chemical, and functional properties of the resulting composition mimicking soft tissue. The particle size of the polymer compound is not limited, but is preferably 3000 μm or less, and more preferably 500 μm or less.

When the anatomical model includes a PVA as base polymer constituent, a mean degree polymerization of the PVA is not limited but is preferably 500 to 3000, more preferably 1000 to 2000, and still more preferably 1500 to 2000. A degree of saponification of PVA is not limited but is preferably 90 mol % or more, and more preferably 95 mol % or more. In a case of compounding plural kinds of PVA having different degrees of polymerization represents the mean degree of polymerization of these plural kinds of PVA (mean degree of polymerization and degree of saponification may be numerical values measured in accordance with known standards, using one or plural kinds of PVA as a sample(s)). The content of the polymer in the dry heat discoloration composition is not limited, but is preferably 0.5 to 50% by weight, more preferably 2 to 25% by weight. By setting the content of the polymer within the above range, the durability of the cured composition can be favorably maintained while maintaining the effects of the invention.

With regard to composition cross-linking form, the composition may not be cross-linked, but it is preferable that the composition is cross-linked (physical-curing) or chemically cross-linked (chemical-curing). A specific method of curing (e.g., cross-linking) is not limited, and a known method may be employable, including selection of a curing agent (for example, a cross-linker and a curing agent which is usable when a PVA is included as base polymer constituent is not particularly limited, and an example of the curing agent includes an agent capable of reacting with a hydroxyl group in the PVA, for example, a chemical compound such as boric acid and the like). Other examples include ionic curing agents such as calcium sulfate, calcium chloride, barium chloride, aluminum chloride, and magnesium chloride; natural curing agents including tannic acid, genipin, and citric acid; covalent curing agents such as glutaraldehyde, carbodiimides (EDC and NHS), epichlorohydrin, divinyl sulfone, formaldehyde, bisacrylamide, methylenebisacrylamide, ethylene glycol diglycidyl ether, sodium trimetaphosphate, and polyfunctional acrylates including polyethylene glycol diacrylate (PEGDA) and poly(ethylene glycol) dimethacrylate; photoinitiated curing agents and initiators such as Irgacure, riboflavin, camphorquinone, benzophenone, and eosin Y; enzymatic curing agents like transglutaminase, tyrosinase, and horseradish peroxidase; as well as physical curing methods including UV, heat, freeze-thaw cycling, ionic gelation agents, and hydrogen bonding enhancers. These curing agents or methods may be used individually or in combination to tailor gelation kinetics, mechanical strength, and other composition properties.

The content of the curing agent in the dry heat color-changing composition is not limited, but is preferably 0.1 to 40% by weight, more preferably 2 to 15% by weight. From the content of such curing agent, the content may be adjusted according to polymer used and the mechanical strength required for the dry heat discoloration composition.

The binder is not particularly limited as long as it is a polymer or resin capable of forming a cohesive network within a gel matrix. Examples of such binders include natural polysaccharides such as carboxymethyl cellulose (CMC), sodium alginate, xanthan gum, guar gum, dextran, starch derivatives, chitosan, and hyaluronic acid; protein source like eggwhite or protein derivatives like gelatin, gelatin methacryloyl (GelMA); synthetic water-soluble polymers including PVA, polyacrylic acid (PAA), polyacrylamide, PEG, poly(ethylene oxide) (PEO), polyvinylpyrrolidone (PVP), polyethyleneimine (PEI), and poly(N-isopropylacrylamide) (PNIPA); and hybrid binders combining polymers and crosslinkers such as tannic acid, citric acid-glycerol, or polymer blends like PAA-PVA or alginate-polyacrylamide. These binders function through hydrogen bonding, ionic coordination (e.g., Ca²⁺ with alginate), covalent crosslinking (e.g., GelMA under UV), or supramolecular interactions to provide for example mechanical stability, swelling control, or structural cohesion.

The content of the binder in the dry heat discoloration composition is not limited, but is preferably 0.1 to 20% by weight, more preferably 1 to 10% by weight. By setting the content of the binder within the above range, the durability of the composition can be favorably maintained while maintaining the effects of the invention.

Furthermore, the composition may contain a solid filler such as a filler or fibers. Examples include natural fibers such as cotton, linen, wool, silk, hemp, jute, ramie, and kapok; regenerated fibers such as rayon and viscose; animal-derived fibers such as keratin and fibroin; plant-based nanofibers such as cellulose nanofibers, nanocellulose, chitin nanofibers, and bamboo fibers; synthetic fibers such as nylon, polyester, polypropylene, polyethylene, aramid fiber, acrylic fiber, glass fiber, carbon fiber, ceramic fiber, and basalt fiber, and particulate fillers such as cellulose powder, microcrystalline cellulose, starch granules, silica, talc, titanium dioxide, calcium carbonate, kaolin, bentonite, montmorillonite, sepiolite, mica, alumina, hydroxyapatite, graphene, and carbon nanotubes. These fillers may be used alone or in combination of two or more.

The content of the filler in the polymer or composition is not limited, but is preferably 0.1 to 50% by weight, more preferably 1 to 30% by weight. By setting the content of the filler within the above range, the mechanical strength, dimensional stability, or functional properties of the gel can be effectively enhanced without compromising the integrity or processability of the composition.

The solvent is not particularly limited as long as it can effectively dissolve the polymer or form a stable polymer system. Examples of suitable solvents include alcohols, polyhydric alcohols (such as glycerol), glycol ethers, esters, ketones, polar aprotic solvents like dimethyl sulfoxide (DMSO) and dimethylformamide (DMF), aliphatic hydrocarbons, alicyclic hydrocarbons, aromatic hydrocarbons, and aqueous solvents or mixtures thereof. Additionally, solvents that promote polymer swelling or gelation, such as water or buffered aqueous solutions, can be employed depending on the polymer system. Of these, glycol ether solvents and polar solvents are often preferred due to their excellent solvating ability and compatibility with a wide range of polymers.

The content of the solvent in the dry heat color-changing composition is not limited, but is preferably 0.1 to 80% by weight, more preferably 2 to 40% by weight. From the content of such solvent, the content may be adjusted according to the type of polymer and the viscosity required for the dry heat discoloration composition.

The viscosity of the dry heat color-changing composition can be adjusted by adjusting the content of additive including polymer, curing agent, binder, filler and/or organic solvent in the dry heat color change composition. By adjusting the viscosity, it is possible to provide a dry heat discoloration composition having a viscosity suitable for various manufacturing techniques. In the present invention, the dry heat discoloration composition preferably has a viscosity of less than 5×10⁷ mPa·s. Particularly, the viscosity suitable for molding is about 10 to 5×10⁵ mPa·s, and the viscosity suitable for additive manufacturing is about 300 to 5×10⁴ mPa·s.

The dry heat discoloration composition of the present invention contains at least one of sugar compound and amine compound as an additive in addition to the above components. By containing the additive of the present invention, the degree of treatment field profile differs under dry heat conditions and wet heat conditions, and in some cases, treatment occurs only when dry heat conditions are met. That is, it is easy to produce composition state transition (e.g., carbonization) under dry heat conditions and difficult to produce composition state transition (e.g., carbonization) under wet heat conditions. In addition, since the degree of treatment field profile can be adjusted by adjusting the type and content of the additive of the present invention, the progress and completion of the composition state transition (e.g., carbonization) can be confirmed according to the degree of treatment field profile.

As the sugar compound, one that is white or light in color and reacts with the amine compound of the present invention to produce darker browning product. Examples of the sugar compound include at least one selected from the group consisting of monosaccharides such as glucose, fructose, galactose, mannose, ribose, xylose, arabinose, erythrose, sedoheptulose, ribulose, and tagatose; disaccharides including lactose, maltose, sucrose, and cellobiose; oligosaccharides such as raffinose and trehalose; sugar alcohols like mannitol and sorbitol; deoxy sugars including fucose and rhamnose; amino sugars such as glucosamine, galactosamine, and N-acetylglucosamine; sugar acids including gluconic acid, glucuronic acid, galacturonic acid, and iduronic acid; and sugar derivatives modified by phosphorylation, sulfation, acetylation, methylation, or other chemical modifications. Additionally, adding a sugar in the composition improves the texture of the cured composition.

The content of the sugar compound in the dry heat discoloration composition is not limited, but is preferably 1 to 25% by weight, more preferably 2 to 5% by weight. When there is too much content of a sugar compound, there exists a possibility that the color change at the time of discoloration (e.g., due to treatment) may advance too much. Moreover, when there is too little content of a sugar compound, there is a possibility that there will be little color change at the time of discoloration (e.g., due to treatment) and an accurate judgment may be impossible.

Examples of the amine compound include at least one selected from the group consisting of primary amines such as methylamine, ethylamine, propylamine, butylamine, benzylamine, and aniline; secondary amines including dimethylamine, diethylamine, dipropylamine, piperidine, and morpholine; tertiary amines such as trimethylamine, triethylamine, and N,N-dimethylaniline; aromatic amines including aniline derivatives like nitroanilines and toluidines; heterocyclic amines such as pyridine, pyrrole, imidazole, and quinoline; polyamines including ethylenediamine, diethylenetriamine, and spermine; amino acids like lysine, ornithine, and histidine; amine-containing macromolecules suitable for use in the composition include natural polymers such as chitosan and proteins (e.g., albumin), as well as synthetic polymers such as polyethyleneimine and polyvinylamine. These amine containing compounds may be aliphatic, aromatic, cyclic, or polymeric and may provide reactive amine groups for browning reaction.

The content of the amine compound in the dry heat discoloration composition is not limited, but is preferably 1 to 25% by weight, more preferably 2 to 5% by weight. When there is too much content of an amine compound, there exists a possibility that the color change at the time of discoloration may advance too much. Moreover, when there is too little content of an amine compound, there is a possibility that there will be little color change at the time of discoloration and an accurate judgment may be impossible.

FIG. 19 depicts the chemical reaction scheme underlying a discoloration reaction described herein, such as Maillard's Reaction; wherein a carbonyl group 802 of the sugar 803 reacts with the amine group 804 of the amino acid 805 under heat. The molar ratio of the sugar compound to the amine compound is selected within a range sufficient to promote the browning reaction under heating conditions. The molar ratio of sugar to amine is preferably in the range of 0.3:1 to 5:1, more preferably in the range of 0.5:1 to 3:1, and most preferably approximately 1:1, depending on the desired extent of browning, crosslinking, or formation of browning products. In alternative aspects, an excess of either the sugar or amine compound may be employed to shift the reaction kinetics or favor specific product distributions. The optimal ratio may be determined empirically for a given application and may fall within any sub-range encompassed by the overall ratio disclosed herein. The reaction produces N-substituted glycosylamine 807 and water 806. The unstable glycosylamine undergoes Amadori rearrangement, forming ketosamines. Several ways are known for the ketosamines to react further: produce two water molecules and reductones; diacetyl, pyruvaldehyde, and other short-chain hydrolytic fission products can be formed; produce brown (e.g., light or dark colored) nitrogenous polymers and melanoidins. Removal or reduction of water content in the composition or reaction can be utilized to modulate the rate of reaction and extent of discoloration.

Excess moisture (e.g., water) in the composition may suppress reaction kinetics and discoloration. In some cases a composition having a controlled or reduced water content (e.g., dry composition) is preferred. That is, in the case of the heat-and-excessive water content color-changing composition (e.g., wet composition) that contains the additive of the present invention, discoloration proceeds slowly after the start of treatment, and there is not much difference in color difference between nontreated and treated composition. In the case of the dry heat discoloration composition of the invention, the additive of the present invention can adjust the degree of discoloration by inducing the reaction between the sugar compound and the amine compound, and the progress and completion of the treatment field profile can be adjusted to the degree of discoloration. Can be confirmed accordingly. The relationship between the treatment time and the degree of discoloration is appropriately set according to the treatment conditions (e.g., energy amplitude) and the types of additive (e.g., sugar compound and amine containing compound).

Examples of browning, glycation, or amination products include at least one selected from the group consisting of initial Schiff bases (imines) formed by the condensation of amines with sugar carbonyl groups; Amadori rearrangement products (ketoamines) arising from the stabilization of Schiff bases; advanced glycation end-products (AGEs) such as carboxymethyllysine (CML), pentosidine, crossline, and pyrraline; various dicarbonyl compounds like glyoxal, methylglyoxal, and 3-deoxyglucosone that act as reactive intermediates; melanoidins, which are complex, high-molecular-weight brown polymers responsible for browning; protein-sugar crosslinks; and heterocyclic nitrogen-containing compounds formed during the Maillard's Reaction cascade. These products encompass early, intermediate, and advanced stages of sugar-amine chemistry and contribute to changes in color, fluorescence, and mechanical properties in the reacting system.

In addition, an extender, a heat non-discoloring additive resistant to browning-induced color-changing, a composition additive compatible with amine-functional compounds, and the like may be blended as necessary.

Examples of bulking agents that can influence browning reaction include bentonite, activated clay, alumina, talc, calcium carbonate, silica, and the like.

Composition preparation is a generic name for a mixture of a polymer as a main active ingredient or compound or compound and an additive added for convenience in use. Examples of the additive may further include other additives such as a manufacturing agent, an anti-foaming agent, an enzyme, a pH adjuster, a cross-linker, an odor control agent, a fragrance, a preservative, a sterilizer, an antioxidant, an antifungal agent, a shelf life improver, a colorant, a color improver, a decolorant, a brightener, a flavor, a sweetener, an acidulant, a bittering agent, an emulsifier, a thickener, a stabilizer, a gelatinizer, an adhesive paste, a leavening agent, a gum base, a metabolic substrate, a growth factor, a softener, and an enrichment; materials such as a lipid such as a phospholipid (e.g., lecithin), a carbohydrate, a processed starch, a protein, and a peptide; and water. The secondary additive may be used alone or in combination of two or more kinds thereof. The form of the polymer composition preparation is not particularly limited, and may be any form such as a powder, a paste, a gel, a liquid, and a lump.

Now turning to describing preferred manufacturing methods of the present invention. An anatomical model made of the composition of the present invention (e.g., prostate anatomical model) closely resembles and reacts to treatment with treatment device(s) similar to the way human organ(s) or tissue(s) do. According to process outlined in FIG. 21, which presents a schematic diagram illustrating an aspect of an anatomical model production process in accordance with the present invention; wherein the anatomical model can be manufactured through a multi-step process and may comprise obtaining data such as medical imaging 1001, generating computer-aided design (CAD) from data 1003, designing anatomical model comprising anatomical elements or elements to facilitate simulation 1004, and causing design and/or data to be sent to advanced manufacturing methods to create representations of soft tissues and/or organs 1005. This process ensures that the final model closely replicates the shape, mechanical properties, and interaction of soft tissues and/or organs (e.g., human prostate) with treatment devices.

Reference is made again to FIG. 21 which is a schematic diagram of an illustrative aspect of a production process. In one aspect, anatomical imaging or structural information of a prostate may be acquired from data source 1001, such as imaging modalities, anatomical references, clinical experience, observational study, prior procedural experience, or inferred models, a clinical database or a patient-specific dataset, or the combination thereof. The data of imaging modalities may be further used as a reference for the generation or design of a digital anatomical model of the prostate. Data of imaging modalities may include, but is not limited to, magnetic resonance imaging (MRI), diffusion weighted imaging (DWI), computed tomography (CT), positron emission tomography (PET), or any other imaging modality suitable for depicting features of the anatomy (e.g., prostate). The data obtained may be further processed 1002. For example, data obtained from a source or database may be pre-processed prior to segmentation such as to improve anatomical accuracy and standardization. Pre-processing may include artifact correction such as noise reduction, bias-field correction, intensity normalization, and resampling to standardize voxel dimensions across datasets. In certain aspects, advanced computing methods including artificial intelligence (AI)-based methods may be applied such as to enhance image quality, suppress noise, localize regions of interest, or normalize intensity distributions based on learned patterns across imaging modalities. In other aspects, the image data may be compared for example against one or more reference data such as datasets the like of publicly available data or other databases. Reference data may include statistical parameters, prostate volume ranges, measures such as distance, tissue density, intensity histograms, or annotated anatomy. In other aspects, multiple imaging modalities (e.g., MRI, CT, PET, or DWI) may be co-registered and processed, for example, to delineate prostate boundaries and infer soft tissue properties such as tissue makeup, mechanical properties, or material diffusion. Following pre-processing, the anatomy is viewed and segmented 1003, for example, using the open-source application 3D Slicer. Important anatomical elements, e.g., the peripheral zone, the central zone, and the urethra, are designed and converted to 3D meshes using a CAD software (for example, FreeCAD). The prostate anatomical model is designed and contains primary anatomical elements that facilitate realistic surgical simulation 1004. In some aspects, primary elements include the prostate's outer walls, internal glandular zones, and a central cavity that simulates the prostatic urethra, complete with anatomical landmarks such as verumontanum. In this case, the prostate anatomical model is designed to have a wall thickness of 1-2 mm, 8-50 mm, or 2-8 mm as the preferred thickness. Additionally, the prostate anatomical model has a total volume of 30-50 mL, 120-500 mL, or 50-80 mL as the preferred volume. To improve realism, the anatomical model may be configured to simulate diverse tissue characteristics representative of soft tissue (e.g., healthy and/or unhealthy). In certain aspects, characteristics may be derived from data such as from a wide range of data sources, including but not limited to clinical imaging modalities (such as MRI, CT, ultrasound, histopathological analyses, biochemical assays, references datasets, surgeon input data, and other data). The anatomical model may incorporate various elements that are anatomical and pathological, including but not limited to neoplastic lesions (e.g., tumors of different grades and stages), cystic or calcified formations, inflammatory regions, fibrotic tissue, or other morphological anomalies indicative of disease or abnormality. The anatomical model design is subsequently caused to be manufactured by sending the design to a manufacturing device 1005.

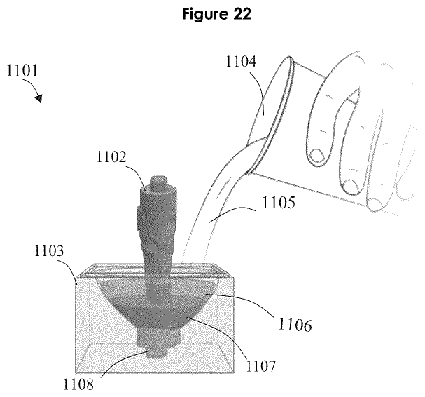

In one aspect, the creation of a prostate anatomical model requires a mold 1006. The 3D mesh anatomical model may be designed according to step 1004 and is then used to generate a corresponding mold system, which typically comprises a top mold portion and a bottom mold portion. FIG. 22 presents an illustration of one aspect of a production process in accordance with the present invention. Mold components, when assembled, define a cavity corresponding to the outer dimensions of the prostate anatomical model. The mold is designed with alignment features 1108, such as interlocking pins, guide slots, and registration marks to ensure precise positioning and reproducibility during fabrication.

Further, for anatomical models containing internal elements such as the urethral cavity of a prostate anatomical model, additional mold components such as a lumen spacer is utilized 1102. These spacers are designed to fit securely into designated slots within the mold, ensuring that internal elements are accurately replicated. In aspects requiring subsequent removal of the spacer, a dissolvable material such as PVA is used, allowing for selective dissolution in an aqueous solution post-curing. The mold itself is manufactured using advanced manufacturing techniques, such as 3D printing. Materials such as polylactic acid (PLA) or silicone-based mold compounds may be used, depending on the required durability and reusability. In some aspects, a multi-part mold system may be employed for complex anatomical models, for example to create an anatomical model with one or more compositions. In other aspects, the mold parts used to manufacture the anatomical model, such as the prostate anatomical model, is printed using an advanced manufacturing system the like of 3D printer. In one aspect, PLA plastic may be used for the main part of the mold. To allow the use of biomimetic composition, direct 3D printing should be complemented with molding. Finally, the mold is filled with appropriate composition of the present invention. Of course a state-sensitive composition the like of the composition of the present invention may be used in the manufacturing process of the anatomical model, such as the prostate anatomical model, using 3D printing (e.g., stereolithography, fused deposition modeling, selective laser sintering, direct ink writing), polymer molding processes such as injection molding or compression molding, extrusion-based fabrication, casting of thermoset or elastomeric materials, CNC machining of polymers or composites, freeze drying, electrospinning, thermoforming, sol-gel processing, blow molding, gelation casting, extrusion-based texturization, and hybrid manufacturing approaches combining multiple methods.

An example prostate anatomical model contains a dry heat composition that is a mixture of one or more cured polymers: ionically cured PVA and Collagen networks. Collagen has a weakness that is low mechanical properties that require the addition of a polymer that has higher mechanical properties. Advantageously, one polymer is PVA with good hydrophility, biocompatibility, and is non-toxic. Additionally, PVA has good stability. A dry heat composition ratio of the polymer is not particularly limited and may be changed appropriately depending on the intended use, but preferably composition is prepared by mixing a 1 to 3.2 times ratio of Collagen to PVA and water, and more preferably 1 to 2.5 times. The composition ratio thereof is a numerical value represented by the density of the composition (before mixing)/the bulk density of the composition (after mixing). Another approach utilizes adjusting the ratios of ingredients already present in the composition mixture. The two polymers of the composition are what allow the gel to be elastic and still hold its shape. In one aspect, a polymer ratio of Collagen to PVA in the gel may be adjusted to enhance different properties of the composition (e.g., polymer gel). Accordingly, the amount of Collagen can be increased to increase brittleness and reduce tear resistance of the prostate anatomical model; if the amount of PVA is increased, flexibility and elasticity is amplified. The curing agent is responsible for certain characteristics. The curing agent (e.g., crosslinker) or plurality thereof essentially entangle the polymer strands together forming a polymer network. Increasing the amount of crosslinkers causes the composition to cure faster and in other aspects lack elasticity and in yet other aspects insufficient amount of crosslinkers cause the formation of a jelly rather a gel. The amount of water can also be varied, with the amount of water being inversely proportional to hardness. Gel with higher water content will be softer and will have the formation of a jelly.

In order to make the prostate anatomical model that is more realistic, color additive can be incorporated into the process. The colorant is added at any time of the process to deionized water being mixed with PVA and Collagen solids. In one aspect, half the water being used to form the dry heat composition is used to make the colorant. A wash is created with the water and drops of dye. The amount and color of colorant used varies depending on the anatomical model. The colored wash is then combined with the other half of water and mixed with the PVA and Collagen. For example, a coloring agent (agent that applies colors resembling human tissues or blood) may be added to the dry heat composition depending on the intended use. For example, coloring with the coloring agent, such as Light Coral colorant, identified by a color code, for example #D8B5A5, makes it possible to color prostate anatomical model as similar to the prostate of a human body (or for example, in a complex anatomical model, the colorant additive enables clear distinction between different anatomical elements where critical elements, such as vasculature, may be more distinctly colored compared to adjacent simulated tissues to enhance visual differentiation). A color code may be detected and used to identify one or more elements or a state of the composition. For example, when a prostate anatomical model, having color code #D8B5A5, undergoes state transition (e.g., such as carbonization due to treatment) its color may shift toward a darker, browner tone. This transformation is mapped using perceptual and/or computational color models. For example, in the RGB color space, carbonization of composition can be approximated by reducing the red, green, and blue components unevenly, often more strongly in the blue channel, since blue tones degrade more quickly under heat. Such as starting from RGB (216, 181, 165), a mild carbonization might reduce values by 7-15% unequally: R_new=216×0.95≈205, G_new=181×0.9˜163, B_new=165×0.85˜140, producing an approximate color of #CDA38C. In the HSL color space, composition state transition (e.g., carbonization) corresponds to change in lightness (L), saturation(S), and hue (H). For instance, an initial HSL of roughly (20°, 45%, 75%) could shift to (20°, 35%, 60%), resulting in a more taupe or brown appearance. Generalized equations to describe color might look like: New_RGB=α×(Original_RGB)\hat{ }γ+b, where γ<1 models gamma darkening, and a, b are tuning constants reflecting the severity of carbonization or treatment. Alternatively, empirical linear reduction can be used to describe color: New_R=R−ΔR, New_G=G−ΔG, New_B=B−ΔB, where Δ values reflect composition-specific state transition sensitivity. These shifts are rooted in how pigments and organic compositions undergo state transition, for example due charring or oxidizing under heat, leading to darker, less saturated colors. In this case, the color path moves perceptually from warm pinks toward muted browns like #C9AE99, #BA9C88, or #A9826C, depending on treatment degree. The approach may be implemented in simulation and include color modeling, color mapping, and characterization of composition state transitions corresponding to degrees of treatment.

The water content of the composition (the water content in the prostate anatomical model) is not particularly limited but is preferably, for example, 20 mass % or more, and more preferably 50 mass % or more with respect to the entire composition. Such water content enables a more realistic texture. The content of water in the dry heat discoloration composition is not limited, but is preferably 5 to 80% by weight, more preferably 45 to 50% by weight. When there is too little content of water, there exists a possibility that the color change at the time of discoloration may advance too much. Moreover, when there is too much content of water, there exists a possibility that there may be little color change at the time of discoloration and formation of treatment field profile may be impossible.

The dry heat composition mixture of the prostate anatomical model is constantly stirred throughout each step until the solution is homogeneous. First, a material (e.g., base compound such as PVA) included in the composition is compounded, stirred and dissolved while being heated so as to obtain a mixture. The mixture is heated until it becomes consistent and viscous. Heating conditions are not limited, but it is preferable to heat the mixture, for example, at 60° C. to 100° C. for 1 hour or more, and more preferably, for 3 hours or more. The composition mixture is used to fabricate the prostate anatomical model using additive manufacturing method. In addition, the additive and the like are appropriately mixed and stirred in the mixture so as to prepare a composition (the step of preparing composition). It should be noted that preparation of the mixture and preparation of the composition may be carried out simultaneously.

The amount of additive (for example, albumin protein) to be compounded is not particularly limited and may be appropriately set within the range not hindering the effects of the invention. For example, when the albumin protein is compounded in the composition, the amount may be set to 2 to 5 mass % with respect to the mass of the entire composition (mass of the whole composition). When various types of additives are used, the additives may be added at any time, but it is preferable to add before the step of freeze-thawing.

Although the manufacturing method, referenced in step 1006, is not particularly limited the mixture is preferably cast into prostate shaped molds (as illustrated in FIG. 22) and allowed to undergo a curing process. In one aspect, a plurality of molds that form a final prostate anatomical mold are shown in FIG. 22 and may include a top mold, a bottom mold 1103, and a spacer mold 1102. The curing process is not particularly limited but preferably contains a temperature controlled environment to undergo curing, for example by freeze-thaw cycling of the cast composition. Additive manufacturing methods may also be employed, for example, to directly print the prostate anatomical model or to fabricate molds into which the composition is cast and cured.

It is preferable to perform curing with a crosslinking agent (crosslinking) from a viewpoint that the crosslinking agent accelerates curing. When using a cross-linking agent, the crosslinking agent may be added at any time. When a crosslinking agent is not used, a possible aspect as the step of curing is such that the composition is frozen and thawed. In some aspects of the disclosure, the method can further comprise freeze-thaw cycle in which the composition is cooled to a predetermined temperature and then thawed to a predetermined temperature to facilitate crosslinks within the composition network. To achieve controlled freeze-thaw process, the composition can be placed in a temperature-controlled environment or system. The temperature control ensures that the freezing and/or thawing process occurs in a consistent and repeatable way. In some aspects of the present disclosure, the composition can be frozen by placing it in a freezer (or other temperature-controlled environment) that is maintained at a temperature between −20° C. to 0° C., such as −20° C. to −10° C., or −10° C. to −4° C. for less than 0.5 hours or more. In other aspects, the composition can be thawed by placing it in a water bath (or other temperature-controlled environment) that is maintained between −20° C. to 80° C., such as 20° C. to 40° C., or 37° C. to 40° C. for less than 0.5 hours or more.

In some aspects of the disclosure freezing the composition can be achieved using a temperature ramp protocol wherein the temperature surrounding the composition is lowered at a cooling rate of −0.5° C. per minute to −10° C. per minute, or −1° C. per minute to −5° C. per minute, or −1° C. per minute to −2° C. per minute until a temperature of −20° C. to −80° C. is reached. At this point, the composition is transferred to an environment held at a temperature ranging from −20° C. to −196° C. In other aspects of the disclosure, the temperature can be reduced rapidly to a temperature below −100° C.

In other aspects, the composition is transferred to an environment to achieve thawing using a temperature ramp protocol wherein the temperature surrounding the composition is increased at a heating rate of 0.5° C. per minute to 10° C. per minute, or 1° C. per minute to 5° C. per minute, or 1° C. per minute to 2° C. until a temperature of 1° C. to 80° C. is reached. In some aspects, the temperature can be increased rapidly to a temperature above the freezing point.

In other aspects of the disclosure the composition is frozen and then thawed between 1 to 20 times, and more preferably 1-4 times. In some such aspects, using a cyclical freeze-thaw process the method can further comprise an analysis process identified as step 1008 of FIG. 21. The analysis process can comprise testing the composition properties between one or more freeze-thaw cycles. Without limitations, composition properties include electro conductivity, cell viability, compressive and/or tensile properties, vaporization rate, and/or treatment rate.

In some aspects of the disclosure the composition is pre-loaded with magnetically responsive nanoparticles, such as iron oxide nanoparticles, to enable rapid and uniform heating by applying an alternating magnetic field. The nanoparticles can be loaded into the composition through mixing, using methods such as those described above. In other aspects, the composition may contain cells or cellular components.

As described above for aspects of the disclosure utilizing a freeze-thaw process, the composition can be stored at predetermined temperatures in specialized storage units or facilities; however, there are situations where a composition should be restored to its original functional state for various purposes. In some aspects of the disclosure, and as described above, the composition can be thawed so as to return to its normal temperature and ensure integrity of the composition during the method.

Next, a plurality of compositions may be appropriately laminated and fixed to each other with an adhesive and the like. Such an adhesive (adhesive composition) is not particularly limited and may be appropriately selected within the range not hindering the effect of the present invention. For example, when the first part (such as a layer) contains a first composition, for example including a hydrogel may be used as the adhesive. Alternatively, another part of a second composition may be directly (without an adhesive or the like) laminated and solidified to an unsolidified part (a layer containing the same or different composition) so that the parts are bonded to each other. Even when a part other than the composition-containing part is used as the first part and the like to form an organ or tissue model, any appropriate methods as described above, in which parts or elements are adhered to each other, enables production of the anatomical model.

Another example of the production method of the prostate anatomical model as illustrated in FIG. 22, a second part-composition mixture is added into the mold and cured to form the second part 1107, and then, the first part-composition mixture 1105 is added by pouring 1104 from above the second part 1107 and cured to form the first part 1106. Such a method enables appropriate lamination and fixation of parts without adhesive parts.

Similarly, in the case of laminating a thin part, the production method of the anatomical model may be such that a composition of another part is applied to a certain part and fixed.

As a method of fixing part, other methods such as physical fixing (for example, by sewing at least an aspect of each part, or providing an irregular surface in each part so as to fit the irregularities) may also be employable and may be appropriately changed depending on the intended use.

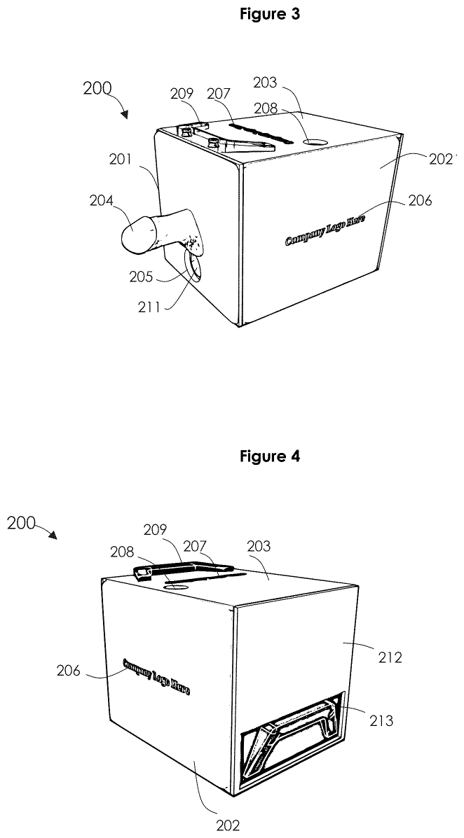

Next, the method may involve configuring an anatomical model referenced by step 1009. The prostate anatomical model may be attached to an adapter as shown in FIG. 12. The prostate adapter 226 supports the prostate element 230 in space and orients it within a surgical trainer, or simulator, to provide access to the prostate model from at least one side of the enclosure (e.g., simulator or trainer). An example of a surgical trainer 200 is illustrated in FIGS. 3-12. Therein, the prostate adapter 226 includes an opening that is connected to the first opening of the lumen 106. Surrounding the prostate adapter, water is provided inside basin 229 to facilitate use of acoustic devices. In one aspect, the practice of the surgical TUEB procedure may be performed through the opening of the prostate adapter into the prostate lumen element as described above.

The anatomical model is preferably constructed and arranged to conform in anatomical details to actual human tissue(s) forming a simulated tissue anatomical model. As noted above, the term “anatomical model” as used herein is defined as a representation, preferably of a specific object or element or clinical procedure. An anatomical model may refer to a physical model which is capable of being touched and may comprise a physical or virtual representation of all or part of a human or animal anatomy, for example a particular human organ. A simulated or “in silico” tissue model may refer to a computer model that is a visual representation of mathematical data, e.g., a three-dimensional computer rendering. The anatomical model may be made to represent different scenarios. For example, the anatomical model may represent adult or pediatric tissue(s) and may also represent either healthy or diseased anatomy or tissue(s). The method of fabricating the anatomical model includes mixing the composition and additive(s) and applying advanced manufacturing methods. In one aspect, advanced manufacturing may include 3D printing, molding, injection molding, CNC machining, and laser cutting. In some aspects, an anatomical model may include features or elements that are non-anatomical yet beneficial for simulation. Further, an anatomical model may be a computer model of a mold and might be referred to herein as a “mold.” An anatomical model may further comprise an anatomical model to which other elements, parts, or models may be added. An anatomical model may comprise a model to undergo further processes prior to its completion without adding other elements. For example, an anatomical model comprising a composition with a mold may be processed to remove mold. A model (physical and/or computer) may be derived from 3D imaging data, e.g., MRI data. A model (physical and/or computer) may be derived from two-dimensional (2D) data, e.g., MRI slice data. A physical model may be formed from a mold. An anatomical model may be mounted in a controlled environment. An example of a controlled environment is a simulator for surgical demonstrations.

The composition of the present invention can be cut, cauterized, and fused. Additionally, the composition according to the present invention shows realistic discoloration (e.g., formation of treatment field profile) when manipulated with treatment device(s) similar to soft tissue(s). Furthermore, a prostate anatomical model containing the composition can be vaporized and transected like real prostate tissue. Mechanical devices such as scissors, graspers, and sutures may be used on anatomical model manufactured according to the present invention. The composition (e.g., in its cured state) has the strength to accommodate sutures and can be further reinforced with mesh to allow additional strength to accommodate sutures in a manner used for actual surgeries without concern for the suture tearing through the model and coming undone. In addition, the compatibility of the composition with other materials becomes useful when making complex anatomical model, such as anatomical model comprising multiple anatomical models (e.g., plurality anatomical element(s), organ(s) and/or tissue(s)) because the anatomical models not only need to bond to each other, but also are able to bond to components of the enclosure. The anatomical model of the present invention should be stored in closed containers with minimal exposure to air circulation until ready for use. Due to being predominantly water, the composition can dry out over time if not stored properly and may alter the treatment characteristics. However, advantageously, the composition of the present invention has the ability to reabsorb water allowing it to rehydrate after losing moisture and to be used. Also, the cured composition may comprise non-toxic compounds and may accommodate cellular culture or used in tissue engineering applications.

Besides gel-based or polymer-based composition semiconductive silicones can be utilized to produce anatomical model(s). Semiconductive silicones are silicone rubbers that have been doped with small particles of metal, commonly, platinum, nickel-graphite or aluminum. These metal particles essentially contribute to altering composition characteristics. For example, metal particles make a non-conductive silicone semiconductive by providing a medium for electricity to flow through. Semiconductive silicones are expensive and difficult to bond to other materials. In addition, the silicone needs to contain large amounts of metal particles to provide a short enough arcing distance for the electric current. The above materials and processes can similarly be engaged to manufacture anatomical models that are energy compatible.

### 6.8 Methods, Devices, and Systems

FIG. 20 presents a block diagram illustrating one aspect of a simulation system in accordance with the present invention. The system may comprise a combination and multiple devices and can include but are not restricted to the following. In another aspect multiple devices can be combined to include but not restricted to anatomical model, hyperthermic devices, hypothermic devices, auxiliary device or system. In other words, this invention comprises systems and devices used to simulate activation, deactivation, modulation, and delivering of thermal treatment in organic or inorganic composition and may comprise systems and devices for treatment learning, planning, guidance, or assessment.

In some aspects an auxiliary device or system may be used in conjunction with the treatment device and can include but is limited to the following. Needle guides (sterile disposable, variable-angle, Ultra-Pro), introducers, sheaths (including steerable and Spotlight OPS), cannulas, coaxial adapters/connectors, interface hubs, handpiece connectors, footswitches, mock power connectors, electrosurgical switch boxes (e.g., Synergy), thermocouple, cooling sleeves, fluid management systems and pumps (e.g., vacuum adapters), patient specific implant, patient specific guide, mechanical tracking rigs, guiding templates, stereotactic frames, alignment platforms, laser alignment tools and crosshairs, targeting grids, positioning jigs, robotic catheter navigation systems (Sensei, Stereotaxis Niobe, Hansen Sensei, Amigo) with contact-force sensors (IntelliSense), VR/AR markers, ultrasound transducer, intracardiac echocardiography system, sensor globes, propagation arrows, guidance lasers, needle retractors, disposable gel warmers, MAG RF generator interface cables, vacuum, MAG vacuum adapters, DiamondTemp generator accessories, CryoFlex console components, simulation carts/platforms, and treatment device accessories kits (e.g., AngioDynamics EVLT kits).

Energy can include any suitable form of energy, including RF and MW and L, CryT, HIFU, Radioactive Therapy (Brachytherapy: BrT), IRE, Electrical Current Therapies, Electrocautery, MR, or Ultrasound. Also includes systems and devices for non-invasive techniques such as transdermal HIFU and electromagnetic focused energy, sclerotherapy, electromagnetic energy and mechanical energy. Other systems and devices provide methods to treat and control the treatment field profile while preserving, or minimally affecting, adjacent non-target area. In some aspects, energy delivery methods, devices, and systems; ultrasound devices and systems; visualization, imaging, learning, or simulation environments may be employed. Simulation environments may include surgical simulators, procedural training devices, anatomy-specific devices, part-task trainers, scenario-based surgical training systems, synthetic training environments, virtual reality simulators, augmented reality platforms, man-in-the-loop simulation systems, distributed team training frameworks, or constructive simulation platforms. In other aspects, these systems may provide procedural rehearsal, real time feedback, skill assessment, and decision-making support and can be used alone or together to improve treatment simulation or surgical procedure.

In one aspect, the current invention references systems and devices for treatment energy delivery unit 906 such as MR and RF and magnetic external heating treatment and include but are not restricted to the following. In one aspect ferromagnetic particles can be placed into the target area containing the composition of the present invention and the MRI machine sequences can then be engaged. If Electromagnetic and mechanical and RF and SAR (heat depositing sequences) are used then the ferromagnetic particles will heat up and can reach temperatures that can be modulated to reach greater than 46° C. Such heating may induce a reaction as described in this invention and produce treatment field profile. The size of the ferromagnetic particles can be microscopic and as small as particles that are angstroms or nanometers to particles that are macroscopic and in the order of size from micrometers to millimeters. These ferromagnetic particles can be in the solid, liquid, gel or gaseous states or can form a slurry or a mixture or combination of the solid, liquid, gel or gaseous states.

Referring again to FIG. 20, system comprises configuring anatomical model for simulation 904, and in one aspect, for use with a noninvasive HIFU system capable of transcutaneous treatment of specific target areas. An ultrasound transducer may be used for some applications with a treatment device. For some applications, treatment device comprises one or more ultrasound transducers, and is configured to treat the composition by applying ultrasound energy to the anatomical model (e.g., treatment device is compatible with and comprises an ultrasound treatment device that is configured to be driven by controller 910 to apply ultrasound energy). In one aspect, the system includes a 1.06 MHz high-intensity focused ultrasound transducer designed to treat a rectangular area approximately 45.2 mm by 18.3 mm. The transducer is spherically focused, with a focal distance of 63±3 mm and an active aperture measuring 64 mm in diameter. A rectangular cutout (18×45 mm²) within the assembly allows for coaxial integration of a linear ultrasound imaging array. This transducer can operate continuously at its specified frequency and can produce focused acoustic pressures between 3.6 and 8.0 MPa, depending on selected exposure durations (such as 2, 5, or 10 seconds). These conditions typically elevate local temperatures within the target area to between 65° C. and 85° C., sufficient for producing treatment field profile.

In another aspect, the anatomical model is configured and compatible for use with auxiliary device 922 such as conventional diagnostic ultrasound probes. Unlike HIFU systems, these transducers operate at significantly lower acoustic power levels, typically producing time-averaged intensities between 0.1 and 100 milliwatts per square centimeter and generating pressure amplitudes in the range of 0.001 to 0.003 megapascals, depending on the imaging modality in use (such as B-mode, pulsed Doppler, or continuous wave Doppler). For reference, HIFU systems concentrate energy at the focal region with far greater intensity, typically between 100 and 10,000 watts per square centimeter. These systems are capable of reaching peak compression pressures as high as 30 MPa and peak rarefaction pressures up to 10 MPa. To facilitate simulation, composition contained by the anatomical model can be visible under ultrasound and a treatment field profile is distinguished under ultrasound. In another aspect, a number of ultrasound probes are employed, including image treatment arrays, single-component, and therapy-only transducers. In one aspect, transducers are driven using a standard protocol with acoustic power between 0.5 W to 120 W, preferably 10 W to 55 W. Duty cycles are used between 1% and 100% preferably between 60% and 100%. Frequency between 2 MHz and 20 MHz is used preferably between 2.5 MHz and 7.9 MHz. In another aspect, the transducers are driven using a generator and radiofrequency amplifier, electronics system for imaging and therapy. Arrays are either applied directly to the anatomical model surface or inserted into the composition. Application of ultrasound leads to temperature increase in the composition due to absorption. Increased heat leads to water boiling as well as composition boiling. Composition boiling is known to cause substantial changes in acoustic heat deposition, including shifting of heat deposition toward the ultrasonic source and limiting depth of treatment or treatment field profile. In another aspect, the system and method may comprise controlled treatment field profile unit 912.

The controlled treatment field profile unit is configured to communicate with one or more treatment devices, enabling both sequential and parallel communication over any programmable period. This allows the controlled treatment field profile unit to coordinate and control multiple treatment devices, repeating communication cycles with a first treatment device as necessary while also managing communication with additional devices. The controlled treatment field profile unit interfaces with a monitoring and feedback unit 916 to receive real time data, which it uses to dynamically adjust treatment condition(s) and optimize energy delivery. Such communication flexibility facilitates complex treatment protocols where multiple treatment devices are deployed simultaneously or in a controlled sequence.

The controlled treatment field profile unit is further configured to receive electrical signals from various electrical components 915 integral to the treatment system. These signals, which may be analog or digital in nature, are subjected to a series of processing steps within the controller. In some aspect, signals may be amplified to ensure adequate strength for accurate processing. Further, filtering may be necessary to remove noise and irrelevant frequency components, improving signal clarity. The controller 913 includes mechanisms for selecting specific signals from multiple inputs based on defined criteria or operational needs. In other aspects, analog and digital storage capabilities may be included, enabling the controller 913 to retain signal data for ongoing analysis or future reference. Additionally, the controlled treatment field profile unit supports daisy chaining of signals, allowing signals to be passed through a chain of components or modules to facilitate data collection and distribution. After processing, signals may be output through one or more channels or circuits designed to elicit appropriate responses, such as modifying energy delivery, triggering alarms, or adjusting system operation.

In other aspects, the controlled treatment field profile unit employs a token-based control protocol to manage the complexity of multi-module signal collection and processing which governs the sequence and timing of operations. In other aspects, the protocol involves the generation of a control token, which is sent as a control signal from the controller 913 to the first processing module over a dedicated control channel. Upon receiving the control token, the first processing module executes its assigned data collection task for the current cycle. Once completed, it passes the token downstream to the next processing module via control channels. In some aspects, this sequential passing of the token ensures that each processing module performs its data acquisition in turn without conflict or data collision. Further, the protocol may promote synchronized, orderly operation across all modules, optimizing timing and ensuring comprehensive coverage of all necessary data within each collection cycle.

In other aspects, the controlled treatment field profile unit 912 may be equipped with an integrated power source (not shown) sufficient to support electronics and communication modules. Additionally, a wireless transceiver (not shown) may be coupled to the controller 913, enabling bidirectional wireless communication with a remote host system. In some aspects, wireless capability facilitates remote monitoring, control commands, firmware updates, and telemetry without the need for direct wired connections.

In one aspect, implementation of the controlled treatment field profile unit may utilize a combination of hardware components such as application-specific integrated circuits, microcontrollers, programmable logic devices, analog front-end circuits, digital signal processors, and data converters. In another aspect, communication protocols supported by the controlled treatment field profile unit can include wired standards such as USB, SPI, 12C, or CAN bus, and wireless protocols including Bluetooth, Wi-Fi, or proprietary radio frequency systems. The system's firmware manages communication stacks, controls signal processing algorithms, and interfaces with user applications or external monitoring systems such as monitoring and feedback unit 916. In yet other aspects, timing parameters governing communication cycles and signal processing sequences may be configurable, allowing the controlled treatment field profile unit to be adapted to various treatment modalities and workflows. In another aspect, safety features may be integrated into the controller monitor system health (not shown) and detect errors, preventing unsafe operation by triggering alarms or shutting down energy delivery as necessary.

Accordingly, treatment field profile may be analyzed and monitored for depth, volume, and formation rate. Spatial peak temperature, exposure time, acoustic power, angular location, power density, probe configuration, anatomical model placement angle, thermal dose, temperature, and treatment field profile shape may be detected and/or controlled.

In one aspect, a system of the current invention comprises treatment device and may alternatively or additionally be configured to treat the composition cryogenically, using laser, using resistive heating, using chemical treatment, or via another treatment mechanism.

In one aspect, IRE is particularly suited for treatment training scenarios due to its non-thermal mechanism of action. This technique relies on delivering short-duration, high-voltage electrical pulses, typically in the microsecond to millisecond range, which generate electric fields up to 3 kV/cm. These fields disrupt the structural integrity of the composition, resulting in irreversible damage and treatment field profile without significant heat generation. Because IRE is minimally influenced by thermal sinks, it offers consistent treatment field profile regardless of local heat dissipation. The system may utilize fine-gauge electrodes, such as insulated 19-gauge (1.1 mm) needles, although larger options are also compatible. Using the anatomical model of the current invention, users can employ either single-needle bipolar electrodes or deploy multiple electrodes in a configured array. Depending on the specific pulse protocol, the system may deliver fewer high-voltage pulses or hundreds of lower-voltage pulses to achieve the desired treatment effect. In another aspect, electrocautery simulation system comprises devices for surgical cauterization procedures. This involves applying an electrical current to heat a metallic tip, which is then brought into contact with the anatomical model. The heated probe may be used to produce treatment field profile in target area.

In another aspect, the treatment device 907 may be configured to include I/O circuits 908 for communication, a sensory device 909 to monitor parameters like temperature or impedance, and a local controller 910 to process commands and manage device functions. In yet another aspect, the treatment device 907 may further comprise one or more energy devices 911 configured to deliver controlled thermal energy (e.g., RF, microwave, laser) to an anatomical model. The controller 910 may be configured to coordinate energy delivery based on sensor feedback.

In one aspect, a treatment energy delivery unit 906 comprises sensory device 909 that includes but is not restricted to the following. Prior to the simulated procedure an treatment sensory device can be prepared then the needle tip or guide or probe is positioned and prior to treatment, the sensory device is configured to determine whether the non-target treatment area adjacent or near to the target area is affected by treatment. In one example, the sensory device is coupled to monitoring and feedback unit 916 comprising one or more processing units, image identification, measurement tools, predictive ML algorithms, reference data, and/or a combination thereof to simulate and/or predict treatment field profile parameter(s). In other aspects, the monitoring and feedback unit 916 includes a method to visualize, monitor, simulate, track, measure, or reconstruct treatment field profile which can include but is not restricted to a monitor, glasses, hologram, or other methods known in the art and a method is applied before, during, or after simulation. In yet another aspect, a sensory device can be connected to one or more auxiliary devices, sensors, cameras, input devices, output devices, or systems such that accessories and/or systems facilitate simulation. In another aspect, a temperature probe is one such sensory device and is applied by insertion of a probe or temperature measuring device in the anatomical model. Further, a sensory device can have the capacity to turn off the energy device and discontinue or limit or modulate treatment field profile. The sensory device can also be located in or on or adjacent to the target area.

Other types of sensory device, referenced by 909, such as a device that senses electromagnetic signals such as electric current can be contained by simulation system. A sensory device can include but is not restricted to modifications of Hall sensors with field concentrators, AMR current sensors, magneto-optical and superconducting current sensors, Hall effect IC sensor, Resistor, whose voltage is directly proportional to the current through it, Fiber optic current sensor, using an interferometer to measure the phase change in the light produced by a magnetic field, Rogowski coil, electrical device for measuring alternating current (AC) or high speed current pulses, a galvanometer is a type of ammeter: an instrument for detecting and measuring electric current and an electrometer is an electrical instrument for measuring electric charge or electrical potential difference. The sensory device can be placed in the vicinity of the target area and in the case of the prostate anatomical model can be placed adjacent or near the prostate element specifically near neural elements such as the hypogastric nerves element or major blood vessels element.

In another aspect, a treatment energy delivery unit 906 comprises a combined hyper and hypothermic device that can include but is not restricted to the following. In one aspect a Hyper and Hypothermic devices can be coupled to control the heating and cooling of an anatomical model. In addition, the forces and architecture responsible for treatment field profile differ and the forces and architecture resistant to treatment field profile formation differ. In one aspect alternating heating and cooling can create a synergy that can decrease both the temperature and duration required for hyper and hypothermia which can prove beneficial to the adjacent non-targeted area thus simulating a clinical process that aims to preserve the non-target tissue(s) or element(s) in the vicinity of the target area, which can include but is not restricted to the prostate gland element being the targeted tissue and the neural and vascular elements adjacent to the prostate gland element being spared.

In one aspect, a treatment energy delivery unit 906 comprises auxiliary devices such as markers and localization devices and wires and filaments that can include but are not restricted to the following. Currently surgeons that remove prostate gland adenomas rely on pre-surgical imaging to approximate the location of the prostate gland. In treatment simulation environment, markers can be placed onto the anatomical model. Methods for marking and localizing the anatomical model, e.g., simulated prostate gland, can prove useful. In one aspect, the simulated prostate gland element targeted for removal can be percutaneously injected with a marking material. This material can include, but is not restricted to, a solid, liquid, gel, or gas, such as methylene blue, gentian violet, tattoo inks, or fluorescent/UV-sensitive dyes. These dyes can incorporate nanoparticles, including but not limited to sol-gel derived silica, which serves as an excellent host for covalently-bound organic dyes used in fluorescent nanoparticle systems. In another aspect, fluorophores, either organic or inorganic, can be used. Fluorescent markers may include naturally fluorescent minerals such as fluorite (calcium fluoride, CaF₂), calcite, and amber, which fluoresce under short-wave UV; or rubies, emeralds, and the Hope Diamond, which exhibit red fluorescence under short-wave UV light. Diamonds can also emit visible light under X-ray radiation. Additional fluorescent substances include vitamin B₂ (yellow fluorescence), quinine (blue), ninhydrin, and fluorescein. In another aspect, the injected marker can be metal-based and radio-opaque for X-ray or fluoroscopic visualization. Suitable materials can include, but are not limited to, calcium, iodine, iron, titanium, tungsten, barium sulfate, and zirconium oxide. In another aspect, the marker or localizing device can include a low-dose radioactive substance suitable for diagnostic radiology. This can include, but is not limited to, technetium-99m, iodine-123, iodine-131, or sestamibi-99mTc, which may be injected directly into or adjacent to the prostate gland element. A radiation-sensitive probe, such as a pencil probe, can be used intraoperatively to facilitate localization. In one aspect, the marker or localization device may incorporate or interface with a GPS-based detection system to support spatial tracking within the anatomical model. In another aspect, an ultrasound-opaque material can be injected into composition to for visualization under ultrasound. In other aspects, the entirety or portion(s) of the anatomical model, including elements, structures, components, or enclosure(s), can be made compatible with localization/visualization methods (e.g., imaging modalities including MR and CT).

Additionally, a marker or localizing device can be placed using a guide, wire, stylet, or placement device, which can include but is not limited to a needle, hollow or solid tube, or similar delivery device. This placement device can be used to position the marker within or adjacent to the target area, such as prostate gland element to be treated. In one aspect, the marker or localizing device can include a transitional zone containing a state-sensitive material that transitions in response to an applied stimulus, such as, but not limited to, electromagnetic energy. Upon activation, this material changes state, enabling separation of the placement device from the marker or localizing element. In one aspect, the placement material, the transitional material, and the marker or localizing device can all be metallic. When energy, such as an electrical current or thermal force, is transmitted through the placement wire, the transitional zone can be activated to separate from the marker or localizing device. In another aspect, the placement device material can be composed of a phase-transitional gel that remains solid at cooler temperatures but melts or dissolves upon heating after a defined period, allowing the transitional zone to separate from the marker or localizing device. In another aspect, solvents or other stimuli-responsive agents can be used to alter the physical state of the transitional material. In yet another aspect, the placement device can include grooves or threads that, when rotated or moved in a specific manner, disengage and release the marker or localizing device in the anatomical model. In one aspect, the gel can exhibit crystalline characteristics and change rigidity when exposed to electromechanical, kinetic, or mechanical energy. For example, liquid crystal (LC) gels with radial or twisted-radial molecular orientation can be fabricated using a radial electric field generated by an indium-tin-oxide hole electrode in the bottom substrate. If the top substrate is unbuffed, a radial-type LC gel forms, which converts linearly polarized light into axially polarized light. Conversely, if the top substrate is homogeneously buffed, a twisted-radial LC gel is produced that converts linearly polarized light into radially polarized light. These polarization converters are useful in diffractive optics and optical imaging systems. The placement device can be a hollow tube that transports a filament, which may be organic, such as silk, cotton, or hemp, or inorganic, including synthetic polymers like nylon or rayon, carbon or carbon-carbon synthetic filaments, or metallic filaments. The filament should be sufficiently flexible to avoid damaging the anatomical model or anatomical model elements it passes through, including but not limited to the prostate, fat, and skin. The marker or localizing device can then be attached to the filament and positioned within the anatomical model, such as the prostate anatomical model.

In yet another aspect, treatment energy delivery unit 906 includes a percutaneous localization device as another example of an auxiliary device. Such a device can be used to facilitate treatment and techniques commonly used, for example, in simulated breast localization procedures where a guide wire is inserted into the target area. The localization wire material can include, but is not restricted to, stainless steel, nitinol, titanium, and other metals or metal alloys that may be either MRI compatible or not. Additionally, carbon-carbon fibers, organic, and inorganic materials can be used alone or in combination to optimize flexibility and strength. The localization wire can be composed of different segments, each containing one or a combination of materials. In one aspect, the localizing device can be composed of, but is not restricted to, a solid wire or a braided or woven wire. The device, including the wire and anchoring components, can be textured or beaded to enhance detection under ultrasound imaging. Additionally, the localizing device, wire, and anchor can be visible on MRI or CT scans. The device may be coated with materials that improve imaging visualization or provide electrical insulation. The localizing device's component can include, but is not limited to, threaded, beaded, barbed, looping, angled, curved, spiral, circular, or straight forms. In one aspect, the device can be screwed into or out of the anatomical model. In another aspect, the localizing device may be coated with an organic, dissolvable material that can be stripped away by a guiding mechanism, preferably percutaneously, allowing the device to self-fix within the anatomical model but also enabling removal by stripping the coating with the guide if necessary. Coatings can include, but are not restricted to, proteins, carbohydrates, fats, minerals, or other organic or inorganic substances. In yet another aspect, at least one surface of the device may be constructed using data of imaging modalities for guiding the placement of a surgical instrument into a target area within the anatomical model.

According to one particular aspect of the present invention, a system and method is provided for use with a variety of auxiliary devices or systems the like of a needle or percutaneous penetrating cylinder, or a solid or hollow tube device and can include but is not restricted to the following. A needle or probe or percutaneous cylinder or tube (which can be hollow or solid) device (all collectively referred to here as a “needle”) that can be composed of a metallic substance, including but not limited to stainless steel, aluminum, iron, titanium, or other ferrous or non-ferrous materials and alloys. In one aspect, a device that penetrates the surface of the anatomical model or passes through an anatomical element can include, but is not restricted to, a needle, probe, tine, or percutaneous tube device and hereafter will be referred to as a needle. The needle can consist, fully or partially, of optimal insulating materials, or it can be insulated with material on the outside portion, on the inside portion (if hollow), or both. The needle can be composed of a combination of metallic and non-metallic materials, including but not restricted to insulators and poor conductors of heat, and may include materials such as ceramic, high-alumina ceramics (Alumina Ceramic), beryllium, fiberglass, zirconium, high-zirconium ceramics, adhesives, and nansulators. The needle can also be constructed using advanced materials, including but not restricted to: ceramic materials, high aluminum ceramics (Alumina Ceramic), beryllium, fiberglass, Zirconium, High Zirconium, adhesives and nansulators, reinforced carbon-carbon fiber construction (aka carbon-carbon, abbreviated C/C), which is a composite material consisting of carbon fiber reinforcement in a matrix of graphite, Carbon fiber-reinforced silicon carbide (C/SiC), which is a development of pure carbon-carbon (C/SiC utilizes silicon carbide with carbon fiber, and this compound is thought to be more durable than pure carbon-carbon), Fibrous refractory composite insulation (FRCI), LI-900 silica tiles, made from essentially very pure quartz sand, High-temperature reusable surface insulation (HRSI), Reaction Cured Glass (RCG) of which tetrasilicide and borosilicate glass are some of several ingredients to waterproof the coating dimethylethoxysilane and are injected into the coating (densifying the tile with tetraethyl orthosilicate (TEOS) also helps to protect the silica and waterproof), RCC (a laminated composite material made from graphite rayon cloth and impregnated with a phenolic resin). In one example, RCC is a laminated composite material made from graphite rayon cloth impregnated with phenolic resin. After curing at high temperature in an autoclave, the laminate is pyrolyzed to convert the resin to carbon. The laminate is then impregnated with furfural alcohol in a vacuum chamber, cured, and pyrolyzed again to convert the alcohol to carbon. This process can be repeated multiple times until the desired carbon-carbon properties are achieved. The outer parts of the RCC can then be converted to silicon carbide to protect the carbon-carbon component from oxidation.

In one aspect, an auxiliary device 922 further comprises a stylet, guide, or introducer and can include a tip composed of diamond, zirconium, or similar materials. The stylet, guide, or introducer can also include one or more chambers capable of circulating substances to form a heat sink, including but not limited to solids, liquids, gels, gases, or a vacuum. These substances can include but are not restricted to water, saline, dye, argon, nitrogen, nitrous oxide, or a vacuum. These materials may serve to simulate thermal conduction, heat dispersion, or localized cooling effects during treatment in a surgical simulation environment. In another aspect, the stylet or guide or introducer may contain one or more chambers that include substances or vacuum, wherein such contents are non-circulating. The stylet or guide or introducer can be used in applications where insulation is not required. In another aspect, the stylet or guide or introducer can be coated with or composed of a Nansulate coating, which may include, but is not limited to, an insulation material incorporating a nanocomposite called Hydro-NM-Oxide, a product of nanotechnology. This material is reported to exhibit one of the lowest thermal conductivity values (0.017 W/mK). Nansulate, when fully cured, may contain approximately 70% Hydro-NM-Oxide and 30% acrylic resin and performance additives. It does not operate as a metallic UV radiator, and the nanoparticles act to inhibit heat flow, functioning similarly to traditional insulation materials. In other aspects, the stylet or guide or introducer or in some cases the anatomical model may include an outer or inner coating designed to reduce resistance or friction when penetrating an anatomical model or simulated organ and/or tissue. Such coatings can include, but are not limited to, Polytetrafluoroethylene (PTFE), fluoropolymers of tetrafluoroethylene, hydrophilic or hydrophobic materials, ultra-high-molecular-weight polyethylene (UHMWPE), mineral oil, or molybdenum disulfide, embedded into the device matrix as lubricants. In yet another aspect, the stylet or guide or introducer may exhibit variable or non-uniform flexibility and tensile strength along its length or width. It may also possess a variable wall or lumen thickness. In one example, the proximal portion of the wall may be thicker than the distal portion, providing the stylet, guide, introducer, or catheter with a tapered configuration, such as a rectangle, triangle, or arrowhead, for improved penetration. The stylet or guide or introducer may include one or more chambers filled with a solid, liquid, gel, or gas, optionally under pressure, that alters the rigidity of the tool. This configuration enables the device to become more firm for the purpose of piercing the surface of the anatomical model, simulated organ, or tissue. After reaching the target area, the chamber contents may be withdrawn, partially or completely, or modified in nature. For example, the chamber may contain nitinol or a shape-memory alloy that is firm at lower temperatures and soft or flexible when heated. In one aspect, the stylet or guide or introducer may be composed of a thermally or electromagnetically responsive material, including but not limited to nitinol or other alloys, that changes its mechanical properties in response to heat, cold, UV light, electric current, or magnetic fields. Such materials may also include ferrofluids or magnetorheological fluids (MRFs), which solidify or alter viscosity in the presence of a magnetic field. These materials may contain iron-based compounds such as magnetite or hematite suspended in a carrier fluid like water or an organic solvent. A typical ferrofluid composition may consist of approximately 5% magnetic solids, 10% surfactant, and 85% carrier fluid by volume. Ferromagnetic particles may be arranged in circular, spiral, or other geometric or non-geometric patterns to influence the shape, firmness, or flexibility of the stylet or guide or introducer. One application of such a device includes its use as a rigid penetrating structure to reach a target area through anatomical model, simulated tissue, organ, or vessel element, and subsequently transitioning to a flexible state to prevent further damage to anatomical model or adjacent element(s) such as simulated orangs and/or tissues. The transition in stiffness may occur in all or only in selected portions of the device. The stylet, guide, or introducer may also be formed in a range of geometries, including but not limited to curved, circular, elliptical, angled, straight, triangular, rectangular, pentagonal, or hexagonal cross-sections. The cross-section may remain fixed or vary along the length of the device.

In one aspect, a treatment energy delivery unit 906 comprises a catheter designed to include a solid or hollow cylinder or tube device for use with but not restricted to percutaneous or transcutaneous or filing or being transmitted or transported in or within or through a hollow or simulated model or an organic or inorganic part within or outside of the anatomical model. The catheter may be constructed from non-metallic materials such as rubber, plastic, latex, fabric, carbon fiber, or carbon-carbon composites, or from metallic materials including, but not limited to, stainless steel, aluminum, iron, titanium, ferrous alloys, or any combinations thereof. In another aspect, the catheter may be configured to transport various forms of matter, e.g., solids, liquids, gases, or gels, and may be used to access, pass through, or deliver materials into anatomical model or element(s) such as organs, tissues, or luminal elements such as esophagus, intestines (small or large), stomach, bladder, urethra, colon, rectum, trachea, mouth, nostrils, biliary ducts, and vascular networks (arterial, venous, or lymphatic). Additionally, the catheter may serve structural or procedural functions, such as reinforcing a pathway, guiding or introducing other instruments or devices, or filling cavities, either temporarily or permanently. The catheter may be wholly or partially composed of insulating materials or coated to achieve electrical or thermal insulation. These insulating features may be applied externally, internally, or in both locations if the catheter is hollow. Materials used for this purpose can include ceramics, high-alumina ceramics, beryllium, zirconium, fiberglass, high-zirconium composites, adhesives, and advanced insulators (“nansulators”). Specific high-performance materials include reinforced carbon-carbon (C/C) composites with a graphite matrix, carbon fiber-reinforced silicon carbide (C/SiC), fibrous refractory composite insulation (FRCI), LI-900 tiles derived from pure quartz sand, high-temperature reusable surface insulation (HRSI), and Reaction Cured Glass (RCG) materials enhanced with tetrasilicide, borosilicate glass, dimethylethoxysilane, TEOS (to improve water resistance and thermal protection), RCC (a laminated composite material made from graphite rayon cloth and impregnated with a phenolic resin). In one aspect the catheter can contain a diamond or zirconium tip. Catheter with chambers that can circulate substances to form a heat sink can include but are not restricted to solids, liquids and gels and gasses or a vacuum. These substances can include but are not restricted to water, saline, dye, argon, nitrogen, and nitrous oxide or a vacuum. In another aspect the catheter can have chambers that contain substances or a vacuum that are non-circulating. The catheter can be used for additional applications where insulation is not a requirement. In yet another aspect, the catheter may be coated with ultra-low-conductivity nanocomposite materials such as Nansulate, incorporating Hydro-NM-Oxide, acrylic resin, and performance additives. This material is documented as having one of the lowest measured thermal conductivity values (0.017 W/mK). Nansulate, when fully cured, contains approximately 70% Hydro-NM-Oxide and 30% acrylic resin and performance additive. It does not function as a metallic UV radiator (reflection). The nano-particles in Nansulate act to inhibit the heat flow much like traditional insulation. Low-friction or hydrophobic coatings may also be applied to reduce resistance as the catheter moves through the anatomical model or tissue simulants. These may include PTFE, polysaccharide, hydrophilic or hydrophobic polymers, UHMWPE, mineral oil, petroleum jelly, or molybdenum disulfide embedded within the catheter's guide, stylet matrix, or anatomical model.

In additional aspects, the catheter may exhibit non-uniform mechanical properties along its length, featuring variable flexibility, tensile strength, wall thickness, or lumen diameter. For example, the wall may taper from a thicker proximal segment to a thinner distal tip, resulting in an arrowhead or triangular cross-section that facilitates initial catheter entry. In another aspect the catheter can have but is not restricted to a chamber that can be filled with a substance that can include a solid or liquid or gel or gas that can be filled to include but not restricted to it being under pressure and causing the catheter or catheter wall to harden or become more firm such that it can pierce the anatomical model more easily. Once it has reached its target area the chamber material can be withdrawn fully or incompletely or the nature of the material can be altered. In one example the catheter or catheter chamber can be a nitenol or alloy metal that when cooled is firm but when heated is soft and pliable and flexible. In another aspect, the catheter can be composed of, but is not limited to, materials such as Nitinol or other alloy metals that exhibit thermal responsiveness, becoming firm when cooled and soft, pliable, or flexible when heated. Alternatively, the catheter may incorporate materials with variable hardness or flexibility in response to changes in thermal or electromagnetic conditions. These may include exposure to heat, cold, ultraviolet (UV) light, electrical currents, or magnetic forces. Examples of such materials include ferrofluids, colloidal liquids containing nanoscale ferromagnetic or ferrimagnetic particles suspended in a carrier fluid such as water or an organic solvent, and magnetorheological fluids, which are similar to ferrofluids but solidify or stiffen in the presence of a magnetic field. These materials may also be part of nanoelectromechanical systems designed to alter mechanical properties in situ. These materials can include, but are not limited to, compounds containing magnetite, hematite, or other iron-based substances. The particles are small enough for thermal agitation to keep them evenly dispersed within a carrier fluid, allowing them to actively contribute to the fluid's overall magnetic response. A typical ferrofluid composition, by volume, may consist of approximately 5% magnetic solids, 10% surfactant, and 85% carrier fluid. In other aspects, the ferromagnetic particles can be arranged in circular, spiral, or other geometric or non-geometric patterns, which can be used to alter or modulate the shape, firmness, or flexibility of the stylet, guide, or introducer. One potential use of this type of catheter includes, but is not limited to, functioning as a rigid penetrating device to access a target area, for example, by traversing parts of simulated skin, organs, or vessels. After reaching the target area, the catheter can transition into a more flexible or compliant state, thereby minimizing further disruption or damage to the target area. The variable stiffness may be applied to the entire length or localized to specific portions of the stylet, guide, or introducer. The catheter itself can support multiple structural configurations, with cross-sectional geometries that may be geometric (e.g., curved, circular, elliptical, triangular, rectangular, pentagonal, hexagonal) or non-geometric and variable along its length. Additionally, the catheter can serve as a conduit for delivering surgical tools or instruments to the intended target area.

In another aspect auxiliary device/system 922 comprises a delivery device used to deliver a compound that can be directly delivered within the anatomical model and the substance can include but is not restricted to a solid, liquid, gel or gas and can suppress or activate or modulate a state-sensitive composition that transitions from its native state to one or more altered states, including but not limited to discoloration, denaturation, coagulation, carbonization, vaporization, melting or other energy-induced changes in response to an applied stimulus, such as, but not limited to, electromagnetic, kinetic, mechanical, or thermal energy. For example, a saline bolus with a volume greater than 0.1 mL, and preferably greater than 0.5 mL, is delivered adjacent to the target area to create a heat sink. A state-sensitive composition, when heated, transitions to form a treatment field profile at the target area as described above. However, an incomplete treatment field profile may be detected due to the heat-sinking effect. Other aspects can include but are not restricted to a scaffold or holding element or slow dissolving or time release substance that can include but is not restricted to a lattices or crystals that can be injected percutaneously adjacent or within a target area and the crystals or lattices can contain substance(s) to visualize and/or monitor the target area through the slow release of the compound. In one aspect the substance(s) can be placed in the non-target area adjacent to the target area. In one example, a compound is injected and forms a heat sink and resulting asymmetric treatment field profile is caused by proximity to compound. For example, when the treatment applicator is positioned within a threshold distance (e.g., <5 mm) of a heat sink, the treatment field profile may be predictably reduced compared to a treatment field profile conducted in homogeneous composition.

Additionally, a simulation system comprises a monitoring and feedback unit 916 further comprising a display device 919 such as screen and/or protective goggles and can include, but are not restricted to, the following features. The viewing screen can be designed to move with, or track, the viewer's eyes, head, body, or instrument. In one aspect, this can include glasses, goggles, or a mask that functions as a display, screen, or visual representation device. The display device 919 can display images or data from anatomical model, imaging device(s) 920, treatment energy delivery unit 906, diagnostic device(s), stored data in memory or database 917, or a computing device. Imaging devices data can include, but are not limited to, ultrasound, MRI, CT scans, thermal imaging, camera images, sensor array data, or laser imaging. Stored data in memory or database 917 may include, but are not restricted to, treatment plan data, energy deposition, measures, dimensional data such as length, width, and depth, temporal data, anatomical simulators, reference clinical datasets (e.g., patient-specific or non-patient-specific), treatment field profile parameter(s), data from imaging devices, devices engaged, input data, and sensory feedback. In some cases, data types may be user-selectable or user-defined (e.g., user inputs) via the user interface, including but not limited to: treatment plan data, energy deposition parameters, dimensional targets, temporal settings, anatomical models, reference datasets, segmentation overlays, and treatment field profile parameters. Data is processed by processor 918. Data transmission can be via hard-wired methods, such as cables, fiber optics, or metal wires, or by wireless methods including Wi-Fi. Additionally, the display can take the form of glasses, goggles, or a mask that also protects portions of the body or face, such as the viewer's face, from energy or substances, including but not limited to organic or inorganic materials or forms of energy. In one aspect, the protective device and the viewing device can be combined or separate and may include specialized protections such as, but not limited to, electromagnetic or thermal shielding. In another aspect, the protective and/or viewing device can incorporate a seal that is airtight, watertight, or alternatively breathable and non-airtight/non-watertight. The display can be worn on various parts of the body, including the face, in the form of a helmet, glasses, or goggles. Additionally, it can be worn extending from other body regions such as the shoulders, torso, or a combination thereof. Portions or the entirety of the display, screen, goggles, or glasses may be opaque, transparent, or translucent.

A treatment energy delivery unit 906 used for treatment simulation. For some applications, the initiation of energy and the treatment simulation steps shown in FIG. 16 (e.g., within step 504) may be performed using a single treatment device 705 (FIG. 18). For example, a single electrode may be moved back and forth through composition of the present invention, alternating between applying different thermal energy (e.g., an ablating RF current). Reference is again made to FIG. 18. System 701, and the techniques described herein, may be performed with varying degrees of automation, in accordance with various applications of the invention. For example: system 701 may display the parameter, for example discoloration, detected by camera or sensor 702 (e.g., on a display 707, in numerical and/or graphical format and allows for the user to interact with the system 710).

As shown in FIG. 18, the system 701 may comprise additional devices used in the simulation. The parameter is then captured by the equipment and may be converted to a 3D data set(s) by software or other algorithmic means known in the art, such as by exporting the data into a known modeling software program that allows data to be represented 709, for example, in CAD format. Once this data is converted, a treatment device may be modeled to complement the data set(s) and oriented by one or more axes determined by the user either before or through observation of the data set(s) from the initial capture of the parameter. A trainee (or user) may determine target area to start the treat-change-detect cycle (e.g., duty cycle) using software interface.

System 701, at least in part based on the detected parameter (e.g., temperature), may display an instruction or suggestion to the user, as to whether to continue or stop the treat-change-detect cycle (e.g., duty cycle). Similarly, audio instructions/suggestions may be provided by system 701.

System 701 (e.g., control unit 708 thereof) may automatically control the electrode and treatment device, at least in part based on the detected treatment field profile. For example, control unit 708 may receive, from camera or sensor 702, information indicative of the detected temperature change, and responsively control (e.g., stop) the treat-change-detect cycle (e.g., duty cycle).

Reference is again made to FIG. 18. For some applications of the invention, one or more simulative actions may be performed as to simulate other clinical steps that happen before, during, and/or after treatment steps. For example, organ cooling by circulating chilled fluid through a sheath inserted into the anatomical model may be performed throughout the entire procedure, so as to simulate clinical steps done during actual treatment procedures. In this case, cooling controls the treatment field profile and protects the anatomical model from unfavorable heat damage. For some applications, it is desirable to treat the entirety target area of an anatomical model.

Reference is now made to FIG. 16, which is a schematic diagram of an illustrative aspect of the thermal treatment simulation process of the present invention. For some applications, it is desirable to achieve only partial treatment of the target area, e.g., to a precisely controlled depth or volume. In those cases, the treatment field profile occupies only a fraction of the full target area. The steps shown in FIG. 16 (i.e., steps 501 to 507) are described herein as being performed using treatment energy delivery unit 906, described with reference to FIG. 20, but it is to be noted that the steps may alternatively be performed using other device, such as other systems described herein, mutatis mutandis. A preliminary treatment field profile (e.g., before treatment) at the target area is detected 503, e.g., using imaging modalities 702. A detected treatment field profile parameter value, e.g., volume, is determined by a first energy application (e.g., using electrode 705) that induces formation of a treatment field profile in the composition of the present invention, and detecting a detected treatment field profile parameter value 503 after the start of the first energy application 504 (e.g., while the energy is being applied, or after it has stopped being applied). For example, treatment field profile parameter that is a volume may be detected after a duration in which treatment field profile is allowed to form in response to the increase in energy delivery.

The treatment field profile volume is compared (e.g., by control unit) with a target volume value (described hereinbelow with reference to step 505). If the detected treatment profile volume value does not cross a threshold defined at least in part based on the target volume value, the value of at least one condition (such as, but not limited to, frequency or amplitude) of the treatment energy is altered 501, and the detected treatment field profile volume value is determined again, until the detected treatment profile volume value does cross the threshold defined at least in part based on the target volume value. This iterative routine is indicated by boxes 906 and 916 combined. For some applications, this iterative routine is automatically performed by control unit 708. For example, the operating trainee (or user) may press a single button on control unit 708, and the control unit iteratively (1) applies the energy 504 and detects 503 the detected treatment profile parameter value (e.g., volume), (2) compares the detected treatment field profile volume value to the target volume value 506, and (3) alters the value of the at least one condition of the energy 502, until the detected treatment field profile volume value crosses the threshold defined at least in part based on the target volume value.

It is to be noted that throughout this patent application, including the specification and the claims, a “threshold defined at least in part based on” a given value may be: equal to the given value, or different from the given value by a fixed value, by a fixed multiple of the given value, and/or by a linear or non-linear function determined at least in part based on the given value.

For some applications, the target parameter value is provided 502 (e.g., generated) by monitoring and feedback unit 916 (FIG. 20) at least in part responsively to the preliminary treatment profile parameter value. For example, monitoring and feedback unit 916 may set the target parameter value to be a given amount or percentage greater than the preliminary treatment field profile parameter value. Alternatively, the parameter value may be provided 502 manually, such as by the operating trainee (or user) entering the target value into monitoring and feedback unit 916.

Once the detected treatment field profile parameter value crosses the threshold defined at least in part based on the target parameter value, treatment energy is applied 504 (e.g., using treatment device 708) to the target area of anatomical model. Subsequently, energy is again delivered to the target area by applying (e.g., using electrode 705) a selected energy (e.g., a characteristic thereof) 504 that is at least in part based on the energy at which the detected treatment field profile parameter value crossed threshold defined at least in part based on the target parameter value (in step 505). For example, the value of at least one characteristic (e.g., frequency and/or amplitude) of the selected energy may be equal to the value of the same condition of the energy at which the detected treatment field profile parameter value crossed the threshold (e.g., the treatment energy that induced the detected treatment profile parameter value to cross the threshold) is “selected” (e.g., by control unit 708) as the selected treatment energy. For some applications, the selected treatment energy may be identical to the treatment energy at which the detected treatment field profile parameter value crossed the threshold defined at least in part by the target treatment energy value.

A detected treatment parameter value is detected 503 (e.g., by sensor 702) after the start of the application of the selected treatment energy (e.g., while the selected treatment energy is being applied, or after it has stopped being applied). For example, the parameter may be detected after a duration in which the parameter is allowed to respond to composition state transition. The detected treatment parameter value is compared (e.g., by monitoring and feedback unit 916) with a target treatment parameter value (described hereinbelow with reference to step 505). If the detected treatment parameter value does not cross a threshold defined at least in part based on the target treatment parameter value, treatment energy is applied again 504, and the detected treatment parameter value is determined again 503 until the detected treatment parameter value does cross the threshold defined at least in part based on the target treatment parameter value. This iterative routine is indicated by boxes 906 and 916 combined. For some applications, this iterative routine is automatically performed by control unit 708. For example, the operating trainee (or user) may press a single button on control unit 708, and the control unit iteratively (1) applies the treatment energy 504, (2) applies the selected current and detects the detected treatment parameter value 503, and (3) compares the detected treatment parameter value to the target treatment parameter value, until the detected treatment parameter value crosses the threshold defined at least in part based on the target treatment parameter value. It is to be noted that the threshold defined at least in part based on the target treatment field profile parameter value may be: equal to the target treatment field profile parameter value (e.g., the detected treatment field profile parameter value crosses the threshold by becoming equal to or lower than the target treatment field profile parameter value), or different from the target treatment field profile parameter value by a fixed value, by a fixed multiple of the target treatment field profile parameter value, and/or by a linear or non-linear function determined at least in part based on the target treatment field profile parameter value (e.g., the detected treatment field profile parameter value crosses the threshold by becoming equal to or lower than a value that is different from the target treatment field profile parameter value by a fixed value, by a fixed multiple of the target treatment field profile parameter value, and/or by a linear or non-linear function determined at least in part based on the target treatment field profile parameter value).

In other aspects, the system illustrated in block diagram in FIG. 20 may be configured to facilitate simulation of one or more clinical procedures, wherein the one or more clinical procedures may vary in complexity, including procedures of progressively increasing or decreasing difficulty of treatment simulation objective(s) (referenced by 921). The model may comprise a plurality of elements, each corresponding to a clinical task of differing anatomical complexity or surgical challenge. Example clinical procedures include minimally invasive, laparoscopic, robotic, or emergency interventions. The system further comprises monitoring and feedback unit 916 to facilitate simulation and may incorporate tracking sensors, camera(s), or proximity detectors configured to receive the anatomical model and for example monitor tool insertion, motion paths, or interaction depth, and may switch between simulation modes (e.g., open vs. endoscopic) based on real time input data (e.g., from a user) or tool movement. Furthermore, monitoring and feedback unit 916 may be configured to store and utilize data, including reference datasets, procedural preferences, treatment condition(s), standards, and parameters generated by computational algorithms, including those driven by artificial intelligence or ML. In addition, monitoring and feedback unit 916 provided may receive data such as performance metrics during a treatment or clinical procedure, such as instrument trajectory, coordinate(s), distance, applied force, temperature, color data, rate, insertion depth, angulation, and timing data. These input data may be analyzed post-treatment or in real time as to evaluate treatment, identify deviations from optimal or standardized treatment paths, or generate personalized planning parameters (such as patient-specific surgical or treatment plan). In certain aspects, the system may further employ predictive modeling for example to forecast treatment outcomes, anticipate sources of technical difficulty, or make recommendations using data including user-specific performance trends. In other aspects, monitoring and feedback unit 916 provided may utilize data to configure treatment processes, anatomical model, or treatment device.

Further, the system of the current disclosure may comprise providing an anatomical model coupled with a simulator configured for prostate thermal treatment procedures as shown in FIGS. 3-12. In one aspect, a prostate anatomical model is manufactured according to the current invention and coupled with enclosure such as prostate simulator assembly shown in FIG. 3 (referred to as simulator hereafter) to facilitate treatment. In preferred aspects, the simulator may be used by professionals and ones skilled in the art to develop, train, disseminate, teach, and evaluate prostate thermal treatment techniques, using systems, devices, and methods mentioned in this invention. In one aspect, the simulator contains waterproof structures to facilitate liquid-based treatment methods, for example requiring the use of water.

Simulator 200 may be manufactured using different methods, including but not limited to those described herein. In one aspect, simulator 200 is manufactured using injection molding. Further, the simulator may comprise an enclosure with plurality of structures. In one aspect, an outside structure or side 202 may include identifier structures 206 and 207 which may be configured to receive branding or visual identifier. In another aspect, simulator 200 comprises anatomical elements such as penis 204, and may further be adapted to receive a device. Turning to FIG. 3, penis 204 may be attached to front side 201. Penis may be manufactured using any one of methods described in this invention. Additional elements, e.g., anatomical or non-anatomical elements, may be coupled to the simulator. In one aspect, coupling may be done through variety of means such as physical means. A good example is the use of socket-ball connectors 210; alternatively, chemical means include the use of a chemical reaction such as the one in glue and additional methods may be utilized.

In some aspects, the simulator comprises anatomical element(s) that are multifunctional. For example, an anatomical model element may represent a urethral lumen, serve as a port, control fluid flow, and be dimensioned to receive a treatment device.

Simulator 200 may further comprise operational features such as a handle 209 configured to facilitate removal of a top panel 203. Handle 209 is depicted as transparent in FIG. 3 to allow visualization of the socket-ball connector(s) 210. Top panel 203 may further comprise one or more port structures 208 adapted to facilitate the introduction of fluid, such as water, into the internal volume of simulator 200.

Front side 201 may further comprise a port 205. In one aspect, port 205 may be fluidly or mechanically connected to a model element such as rectum 234, which is coupled to a rectal opening 211. Rectum 234 may include or retain a composition of the current invention and may be compatible to receive an acoustic medical device, such as an ultrasound probe (as shown in FIG. 10).

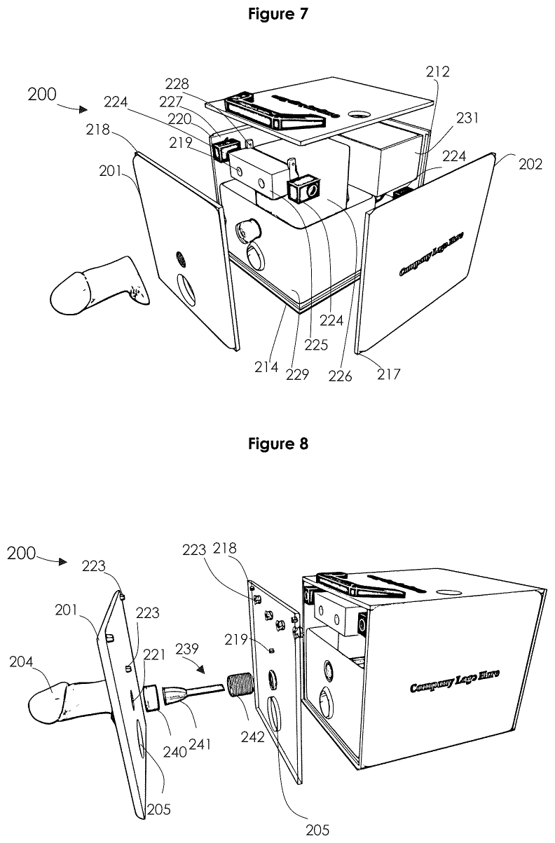

Turning now to FIG. 4, which presents an external back view of the prostate simulator of FIG. 3. In one aspect, simulator 200 comprises an enclosure having one or more sides, including a right side 220 (as shown in FIG. 7), a left side 202, a back panel 212, a top panel 203, and a bottom panel or base 214. In one aspect, back panel 212 further comprises a compartment 213, which may be configured to provide storage. Compartment 213 may be adapted to receive accessories, replacement components, tools, or fluid containers associated with use or maintenance of simulator 200.

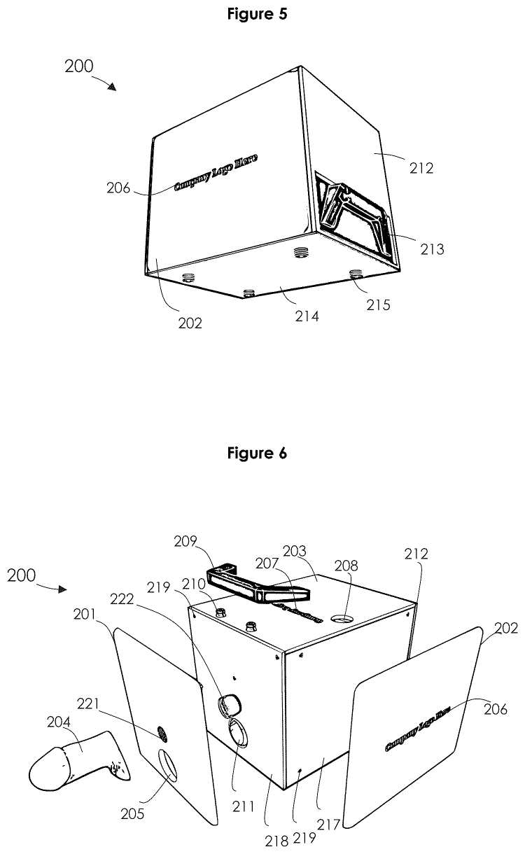

FIG. 5 presents an external bottom view of the prostate simulator of FIG. 3. In one aspect, bottom panel or base 214 comprises one or more feet 215. In one aspect, bottom panel or base 214 includes one or more mechanisms for securing to an underlying surface. For example, feet 215 may comprise a high-friction material, such as rubber, to enhance stability and reduce slippage. Feet 215 may be mechanically or chemically coupled to bottom panel or base 214. In one example, a chemical coupling method, such as adhesive bonding, may be employed to affix feet 215 to bottom panel or base 214. In other aspects, alternative coupling techniques known in the art may be used, including but not limited to mechanical fasteners, press-fit components, or integrally molded features.

In another aspect, one or more structural components of simulator 200 may comprise a shell that comprises a plurality of panels, including panels: back panel 212, bottom panel 214, left panel 217, front panel 218 and right panel 227. Each panel may be mechanically or chemically coupled to a corresponding side. In one aspect, simulator 200 comprises at least one side and may include up to six or more sides, depending on the desired configuration. The outer side(s) may undergo post-processing treatments, such as surface smoothing, coating, or polishing, to achieve a final finished or polished appearance suitable for presentation, handling, or instructional use.

Additionally, front side 201 of simulator 200 comprises a urethral opening 221, which is adapted or dimensioned to permit insertion of a treatment device. In one aspect, urethral opening 221 is in fluid or mechanical communication with a urethral passage 222. Urethral passage 222 may represent a urethra and may further be fabricated using any of the manufacturing methods described herein, including but not limited to 3D printing, molding, injection molding, or other suitable fabrication techniques. In other aspects, a urethral passage 222 may be manufactured using the materials and compositions disclosed in this specification, or using alternative methods and materials known in the art that provide comparable anatomical realism and functional performance.

FIG. 6 presents an exploded external front view of the prostate simulator of FIG. 3. In one aspect, simulator 200 is 3D-printed, e.g., by means of a 3D printer, and comprises structures for assembly. In this case, plurality of connectors 219 may be configured to assemble structures or components of simulator 200. The connector structure may comprise any geometric shape capable of providing mechanical engagement, alignment, or retention between adjoining parts. Examples of suitable connector geometries include, but are not limited to, pegs, sockets, dovetails, slots, snap-fits, or threaded structures. The connectors 219 may be integrally formed with the components or manufactured separately and subsequently affixed. In some aspects, the connectors may allow for reversible assembly and disassembly to facilitate cleaning, transport, or component replacement.

FIG. 7 presents an exploded view of panels of the prostate simulator of FIG. 3; wherein connector 224 is yet another type of connector. In this example, connector 224 may be manufactured independently. In one aspect, the shell may be modular and configured to facilitate assembly or disassembly of simulator. Further, the simulator may contain front panel 218 coupled to side 201. In this case, front panel 218 further comprises attachment mechanism 225 and may be used to facilitate placement or orientation of prostate adapter 226. In other aspects, attachment mechanism 225 may comprise placement mechanism 228. Nonetheless, any placement or orientation mechanism used should allow for easy replacement and insertion of the prostate adapter 226. In another aspect, the prostate adapter 226 is configured to facilitate positioning of the prostate element or prostate to be partially or fully submerged in water contained in basin 229. In this case, placement of prostate in water may facilitate use of simulator with ultrasound monitoring methods where in an ultrasound probe may be inserted through the port 205 in side 201 and in rectum 234 (FIG. 10). Rectum 234 and water basin 229 may be manufactured as one component. In other aspects, the water basin and rectum are manufactured independently. In FIG. 7 structures are shown as a single component. Additionally, rectum 234 and basin 229 may be manufactured using one composition or more.

FIG. 8 presents an external exploded front view of the water backflow preventer assembly of the prostate simulator of FIG. 3. In this illustration, the water backflow preventer assembly 239 is shown. The water backflow preventer assembly consists of connecting nut 240, check valve 241, fitting 242, connecting nut 243, and body 244 (FIG. 12). Fitting 242 is screwed in front panel 218 tightly and threaded seal tape is preferred to facilitate sealing of fitting 242. In another aspect, check valve 241 may be inserted into fitting 242 and connecting nut 240 is tightened on the fitting 242. Threaded seal tape or any other sealant may be used at the interface to ensure tight seal. The water backflow preventer assembly 239 comprising connecting nut 240, valve 241, and fitting 242 are inserted into body 244 sized to fit urethral opening 221. Connecting nut 243 is configured to tighten against the side of front panel 218, tightly pressing parts of the basin 229 against front panel 218, creating a water-tight seal. Again, threaded seal tape or any other type of sealant may be used to ensure a tight connection between connecting nut 243 and fitting 242. Together, the connecting nut 240, check valve 241, fitting 242, connecting nut 243, and body 244 may be configured to comprise water backflow preventer assembly 239. The water backflow preventer assembly 239 is important in preventing water backflow during use of simulator. The water backflow preventer assembly 239 prevents water from leaving the simulator.

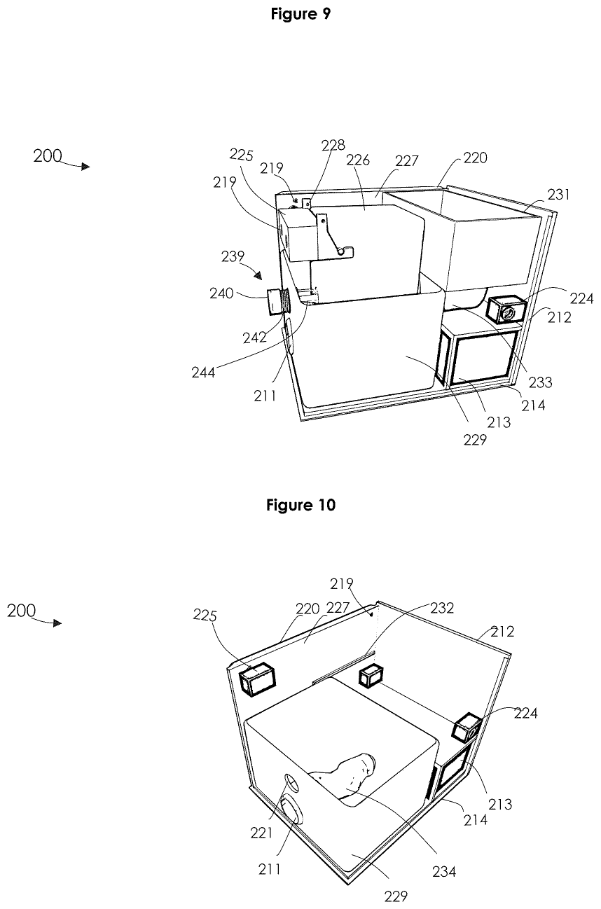

FIG. 9 presents a cut-away view of the prostate simulator assembly of FIG. 3. In this configuration, additional structures useful for simulation or training purposes may be operatively coupled to simulator 200. For example, as shown in FIG. 9, a compartment 231 may be integrated within the enclosure and configured to provide additional internal space for storage, component housing, or user interaction. In one aspect, simulator 200 is designed modular system facilitate the coupling of supplementary components, devices, anatomical models, or elements. Modularity enables customization and scalability, allowing the simulator to be adapted in a wide range of clinical training scenarios or simulations. This modularity also supports ease of assembly, disassembly, maintenance, reconfiguration, and replacement of individual parts.

FIG. 10 presents a cut-away view showing the ultrasound-compatible rectal element of the prostate simulator of FIG. 3. Rectum 234 may include or retain a composition of the current invention and may include an additive such as silica particles, propanol, BSA, or evaporated milk.

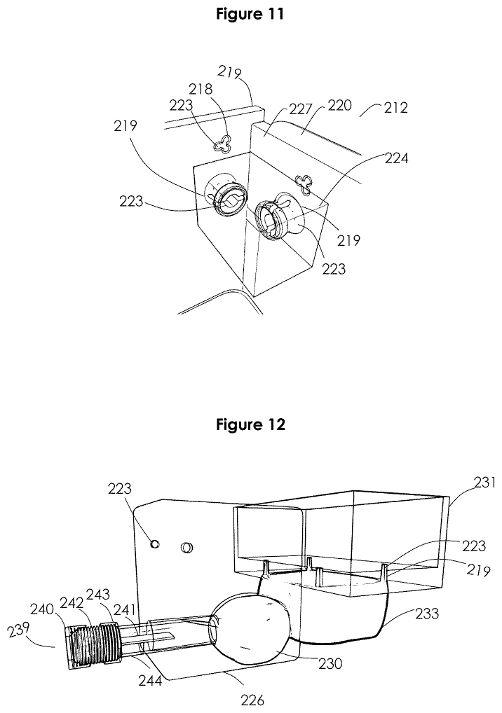

FIG. 11 presents a zoomed-in cut-away view of connector components of the prostate simulator of FIG. 3.

FIG. 12 presents a cut-away view of the internal structures of the prostate simulator of FIG. 3. These structures are configured to define and maintain a path suitable for guiding devices. The figure illustrates the internal assembly of simulator 200, including a prostate element 230 coupled with a prostate adapter 226. Prostate adapter 226 includes a set of two pins 223 on each lateral side, which are used to couple the prostate adapter 226 with a placement mechanism 228, thereby securing the prostate in position during use. FIG. 12 also shows a water backflow preventer assembly 239 inserted through prostate adapter 226 to manage fluid control within the simulator. Additionally, a bladder 233 is depicted as being coupled to compartment 231 via four sets of pins 223 inserted into corresponding connectors 219. This configuration enables stable placement and mechanical engagement of the bladder within the simulator, supporting its role in procedural simulations involving fluid dynamics or catheterization.

The foregoing description of the preferred aspect of the invention has been presented for the purpose of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### 7 INDUSTRIAL APPLICATION OF SYSTEMS AND METHODS OF THE PRESENT INVENTION

One having skill in the art will appreciate that aspects of anatomical model containing the composition of the current invention, as well as other aspects discussed herein, may be used in conjunction with systems, devices, and methods that employ automated or semi-automated treatment, such as, for example, robotics, image guidance or other autonomous systems.

For some application, the dry heat composition, as described herein, may be used in conjunction with simulation of ischemic treatment (e.g., to simulate parathyroid gland ablation), wherein a parathyroid gland anatomical model comprising a vessel element contains the composition of the present invention. In some aspects, the vessel may comprise a lumen that is either fluid-filled or devoid of fluid. Simulation of ischemic treatment includes application of energy to the vessel, resulting in a controlled reduction in vessel diameter and/or complete occlusion of the vessel. In certain aspects, thermal energy may be applied to a vessel containing a dry heat composition of the present invention. The applied thermal energy induces a composition state transition and a treatment field profile comprising coagulation layer is formed via a chemical reaction involving Maillard's Reaction. This reaction generates coagulation compounds that contribute to the structural coagulation and sealing of the vessel. In aspects where the vessel is liquid filled, this treatment would reduce and/or stop liquid movement. Simulation of ischemic treatment can be achieved by using high intensity focused ultrasound (HIFU), irreversible electroporation (IRE), as well as minimally invasive therapy (MIT) and tightly targeted minimally invasive therapy (TTMIT) methods described, but are not restricted to, microwave (MW), radiofrequency (RF), laser (L), computed tomography (CT), and chemical treatment methods, adjuvant therapy, chemo therapy or radiation or any combination of these methods or methods described within this patent. Strategies for optimally simulating ischemic treatment may include but are not restricted to modifications of the antenna and electrode and can include but are not restricted to changing antenna and electrode length and changing insulation lengths, limiting the maximal heating of the probe with longer durations of the pulse, alternating pulses of short and long, using a probe in which the insulation or the electrode can be made to vary to be shorter and longer, adjustments of the pulsing sequence with feedback from the target area or the heating or the cooling in the vicinity area, enlargement of the electrode face or tines, individually retractable tines or electrodes which can adjust to target the treated area shape and response to treatment of the target area and the local vicinity area, alternating or variable application of heat, electromagnetic, or kinetic energy, often including active cooling phases, to regulate composition state transition. A key characteristic is the intentional reduction in the energy delivered to composition surrounding the target area compared to that delivered directly to the target area. This modulation of energy input enhances selectivity, helping to confine the treatment field profile to the intended area while preserving adjacent elements.

In another example, the composition of the present invention as described herein may be used conjunction with simulation of Hypothermic or Cold Therapy or CryoT and includes but is not restricted to: in one aspect hypothermic or Cold or CryoT is the exposure of target area to lower than normal organic temperatures. Temperatures below 0° C. can create freezing to the composition in the target area, wherein such application simulates cryotherapy treatment of tissues. Clinically, temperatures of minus 20 to minus 40° C. represent the lethal isotherm although the temperatures often used by cryotherapy devices range as low as minus 140° C. inside the ice ball used for treatment or heat-sink of 9 KJ (kilojoules). Needles and probes for treatment can be small, as small as 13-gauge (2.4 mm) or smaller but larger probes with size equal to or greater than 15-gauge (1.7 mm) probes may prove effective in simulation. In addition, cryoprobes may be applied in the target area and/or proximate to the target area to create a heat sink and gasses and materials such as but not restricted to Argon, helium and nitrogen may be utilized. In another aspects the use of liquid materials such as Nitrogen that cool when allowed to return to a gaseous state can also be delivered to the target area through one surface of the anatomical model. Various cryoprobes exist that include but are not restricted to reservoirs that contain coolant materials such as but not restricted to nitrous oxide and needles that serve as heat-sinks that can use but are not restricted to argon gas.

In other aspects, systems and methods may also include simulation of chemical treatment can include but is not restricted to the following. In one aspect ethanol may be used to simulate treatment of soft tissue (e.g., using ethanol injection). In another aspect methods whereby substances are injected around and/or within the target area can include but are not restricted to water, saline, weak bases, dye. Other substances which have not been used but may prove more effective because of their greater capacity to improve simulation and can include but are not restricted to acetic acid and other moderate and weaker acids, weaker forms of alcohol or diluted forms of alcohol or other Sotradecol. Substances that can be injected can be in the solid, liquid, gel or gaseous states or can form a slurry or a mixture or combination of the solid, liquid, gel or gaseous states. Other substances may include but are not restricted to carbon monoxide, saline or dextrose solutions that are saturated in a manner that induces the formation of treatment field profile which can also be optimized or constructed or delivered to protect the non-target area. These substances once injected around and/or within the target area induce a composition state transition as described previously. The injected substances may replicate one or more characteristics of actual treatment agents (e.g., agents used clinically), for example, as to simulate their diffusive behavior, or may consist of a base solvent comprising a compound that facilitates imaging, thereby allowing visualization of the substance distribution within the anatomical model or target area.

Systems and methods of the current invention may be used in conjunction with simulation of Electromagnetic therapy can include but is not restricted to the following. Radioactive materials, brachytherapy, can be used to simulate delivery of electromagnetic energy into the target area. In one aspect the radioactive seeds can be implanted and left in place and the isotope which uses a low dose of radiation with a limited area of radiation can be used and can include but is not restricted to iodine-125 or palladium-103. In another aspect a high radiation dose isotope can be inserted into the composition for a limited period and then removed and this can include iridium-192 which would be inserted into the composition for less than 15 minutes. The dose is dependent upon the size of the target area to be treated and other elements in the vicinity. In the preferred aspect the radiation would be introduced through one surface of the anatomical model using a percutaneous guide and guiding system. Irradiation of the composition leads to composition state transition and formation of treatment field profile as described in this invention. Further, simulation allows for monitoring of the irradiated area. Light is a type of electromagnetic radiation and can be used to activate and deactivate substances. Photo/Electromagnetic and mechanical/vibration energy can also change the configuration of a molecule or molecular configuration and change its properties enabling an otherwise inaccessible molecule to become accessible (Woodward-Hoffman selection rules) or creating an accessible molecule and making it inaccessible. Some of the most widely used sections of the electromagnetic spectrum are UV 100-400 nm, visible light 400-700 nm and Near Infrared 700-2500 nm. Examples of photo activation can include but are not restricted to glycosylation (for example, a non-enzymatic glycosylation in the Maillard's Reaction), photosynthesis, Vitamin D conversion, bioluminescence, phenol and tetraphenylporphyrin, hydrocarbon solvents that use short wavelengths and solvents containing unsaturated bonds that may require higher wavelengths, cyclohexane, acetone and singlet oxygen reactions in general. Cis and Trans rotations of the molecule that can occur in alkenes. Other reactions can include mercaptans, toluene-chlorine, and metallic reactions like UV irradiation of THE solution of molybdenum hexacarbonyl. Transformation of a liquid into a crystal can be used to alter the internal structure of the composition such as in target area of the anatomical model. One reaction can include but is not restricted to photolysis of iron pentacarbonyl. Also carbon nanotubes can be placed into the composition and exposed to an intense pulsed light from a laser or an arc lamp. This will produce combustion and temperatures as high as 700 to 1500° C. Another reaction can include alpha-santonin when exposed to sunlight wavelengths. One or more of these aspects allows for simulation of electromagnetic treatment. The electromagnetic source can include a multichromatic light source such as mercury vapor lamps or monochromatic light sources such as LED or Rayonet lamps. Some activation examples can include but are not restricted to ultraviolet activated persulfate oxidation of phenol in the basic pH conditions. Carbon foam using a coal tar pitch as a precursor can serve as a support for titanium oxide for the catalytic degradation of phenol.

In other aspects, percutaneous imaging-guided RF treatment may be facilitated using methods, devices, and system of the invention disclosed, wherein the energy is delivered into the target area by means of needlelike electrodes. RF electrodes can include but are not restricted to a range in a diameter from 15 to 17 gauge. Each of these devices uses a different strategy to maximize the size of treatment field profile. In one example a treatment system contains an electrode that can be shaped like a standard 17-gauge needle and delivered as a single electrode or as a unit of three electrodes arranged in a triangular cluster. Such system increases treatment field profile size by using two enhancements: electrode cooling and pulsed energy delivery. The device should consists of a generator and an electrode with numerous retractable tines, which are used to increase the field of treatment profile. The tines are advanced into the target area in the anatomical model. In one aspect, a thermal treatment system uses a 14-gauge electrode with 12 retractable tines that are advanced into a prostate anatomical model to deliver thermal energy. Devices used in simulation of thermal treatment have slightly different approach to energy delivery and monitoring for treatment field profile.

Systems, devices, and methods described herein may be configured to determine theoretical maximum size of the treatment field profile. In vitro, the theoretical maximum size of the treatment field profile is at least two times the length of the energy-emitting segment of the electrode for the long axis of the treatment field profile. The transverse axis maximum can be up to two-thirds of the length of the long axis of the treatment field profile. In vivo, the treatment field profile varies and is usually smaller than the theoretical maximum. The maximum size of the treatment field profile can be increased using various methods (for example by treating devascularized tissue). Alternatively, a heat sink present near the target area (for example, flowing blood, fluid-containing spaces, or circulating air) can decrease the effective size of the treatment field profile. In some aspects, available RF devices use generators that deliver 50-500 W of energy. These heating characteristics may vary from device to device but the general principles of controlling treatment field profile apply to multiple forms of treatment. Simulating which treatment field profile parameter is optimal for the given simulation scenario, such as based on the size and location of the target area (e.g., prostatic tumor in prostate anatomical model), will require a case-by-case analysis. In this case, simulated prostatic tumor that is 30×12×18 mm and is not near vital arteries or neural elements should be treated with different wattage, and power and maximal heating and time duration and number of applications or pulses of the treatment than a simulated prostatic tumor that is 10×8×12 mm and lies in close proximity to vital arteries or neural elements. In one aspect treatment can either increase or decrease the temperature of the composition of which the two basic treatment methods are cryotherapy and hyperthermic, respectively. These treatment forms induce changes in the amount of heat and kinetic energy in the composition. Thermal treatment methods can include but are not restricted to RF and MW and L, utilizing an optimal temperature of 50° C., and heating of composition to 50 to 54° C. for 4-6 minutes is a common endpoint for simulation of realistic soft tissue treatment. In this case, formation of treatment field profile containing light discoloration of the composition can signal achieving such endpoint. But higher temperatures are generated by the RF or MW or L devices to include 100° C., such that the composition adjacent to the device can experience temperatures of 100° C. which coagulates the adjacent composition and higher temperatures such as 105° C. to vaporize and/or form carbonization treatment field profile.

Additionally, the systems, devices, and methods described herein may be used in conjunction with simulation of mechanical treatment procedure can include but is not restricted to the following. In one aspect a treatment can include placing a needle into the anatomical model, such as but not restricted to the prostate element. This can include but is not restricted to a mechanical cutting or treatment or cutting tool or cell maceration and tissue damaging device. The mechanism of mechanical damage can include but is not restricted to a blade, a needle, a burr, a compressive force, a steam, a stream or flow of focused material to include a solid or liquid or a gas or gel to include water, oxygen, a hydrogel or hot metal or liquid nitrogen. Methods of delivering the mechanical force can include but are not restricted to a needle with one or more end-holes, side-holes, or combination of these end and side holes and a cutting device that can include a blade, a needle, a burr, a compressive force, a rotating force, a stream or flow of focused material to include a solid or liquid or a gas or gel to include water, oxygen, a hydrogel or hot metal or liquid nitrogen. Negative suction that is continuous or pulsed can remove composition that enters the core of the needle.

In other aspects, systems, devices, and methods described herein may be used in conjunction with simulation of suction and expansion therapy can include but is not restricted to the following. In one aspect a treatment can include placing a hollow needle or catheter or guide that lies within or intimately adjacent to the target area in an anatomical model, such as but not restricted to simulated adenoma of a prostate. Negative pressure can be applied within the hollow needle or catheter or guide. This negative pressure can be combined with a cutting tool that can include a side-hole in the needle and a cutting or mechanical device that can include a burr or a blade that can remove composition that enters the core of the needle. The needle or guide or catheter can have one or more channels and each channel can be dedicated to the same or different tasks.

In other aspects, simulation of positive pressure and expansion procedures may be facilitated by systems and methods of the current invention and can include but is not restricted to the following. In one aspect a treatment can include placing a needle into the target area, such as but not restricted to simulated adenoma of a prostate. Positive pressure can be applied within the needle. This will create positive pressure within the prostate adenoma. To create the positive pressure a substance can include but is not restricted to a solid, liquid, gel or gas or a combination can form a slurry or a mixture or combination of the solid, liquid, gel or gaseous states can be instilled though the needle into the target area. The objective is to create enough positive pressure within the composition of the target area. This positive pressure can be combined with a cutting tool that can include a side-hole in the needle and a cutting device or mechanical device that can include a burr or a blade that can remove composition that enters the core of the needle. The needle or guide or catheter can have one or more channels and each channel can be dedicated to the same or different tasks.

Systems and methods of the current disclosure may further facilitate treatment using RF. In one aspect during simulation of RF treatment an electrical current oscillates through the ion channels that are inherently present in the composition. Since the composition is an imperfect generator of electrical current, frictional agitation and heat are produced. This is known as the Joule effect. Composition heating is greatest nearest the probe and more distant composition receives a thermal conduction and thus heat drops off away from the probe. Augmentation of the RF effect can be performed by increasing the probe surface area, pulsing the input power and injecting saline/ionic solutions. RF treatment can use a single or multiple tines. The needles can be insulated and cooled by water. Tines come in many shapes and configuration and multiple gauge sizes approximating 14 gauge (2.1 mm) to 17 gauge (1.5 mm). For example, during simulation of treatment of the prostate gland smaller gauge probes, one or two tines and smaller tines may provide a smaller and more controlled treatment field profile. In some aspects the multipolar or bipolar RF probe may be used for treatment simulation. With the multipolar and bipolar RF probe the current oscillates between the two electrodes. Saline can be instilled within the composition to augment the treatment field profile formation between these two electrodes each of which can be placed at the superior and inferior aspect of the target area in the anatomical model while monitoring needle placement using imaging guidance techniques to include but not restricted to real time ultrasound. Initially, levels of power begin in the 0.1 to 100 W range but may need to increase dependent on the impedance of the composition being treated and the adjuvant such as saline and ionic solutions administered. Also by pulsing the generator the size of the treatment field profile (e.g., containing a carbonization layer) can be controlled. For example, pulsing algorithms have been shown to increase treatment field profile (e.g., containing carbon) size and decrease the time for treatment, and in some aspects algorithms that decrease the treatment field profile (e.g., containing carbon layer) and that is less concerned with treatment time may be used in simulation. RF can be applied in a unipolar or a bipolar or multipolar fashion and the inter-electrode distances can vary depending on the composition and electrode characteristics (e.g. 5 mm, 10 mm) and the size of the target area. RF energies can vary (e.g. 500 kHz) that are delivered to the target area to include but not restricted to 100 J, 101-200 J, 201-300 J, 301-400 J, 401-500 J, 501-600 J, 601-1000 J, and >1000 J. Results of treatment profile (e.g., containing carbon) show that when RF energy is applied in a bipolar fashion, the formed treatment field profile is located between and around the electrode and when applied in a unipolar fashion treatment field was found in the catheter/anatomical model interface. In another aspect, bipolar mode increases the length of the treatment field profile (e.g., containing carbon layer) and can but is not restricted to allow for one energy pulse. In another aspect the tip of the electrode can be varied. The larger electrode tip appears to create a larger treatment field profile (e.g., one that contains carbon). Therefore depending on the size of the target area the size of the electrode tip will be determined by the size of the needle desired to simulate a safe percutaneous approach with a gauge size of 21 (0.72 mm) being optimal and a size as large as 15 gauge (1.5 mm) approaching a maximal size. The electrode tip may be limited by these conditions. In another aspect a bipolar or multipolar device can be used where the tines spread out as they exit the percutaneous introducer. In one aspect anchors or fixation hooks can be employed to stabilize the target area during treatment. In one example of treatment the RF energy sufficient to maintain a highest temperature of 100° C. can be delivered for 8-10 minutes for each treatment. The impedance values ranged from 30 to 60Ω. The diameters of the deployed hooks can vary between 1 and 3 cm, depending on the target area size and location. The temperature of each hook can be maintained above 90° C. For target area smaller than 2 cm in diameter, the needle tip can be placed in the center of the target area and the hooks can be deployed to reach the deepest margin of the target area. One treatment is usually sufficient to form a treatment field profile (for example one containing coagulation layer). For larger target area, multiple overlapping treatment field profiles can be produced according to the size and shape of the target area.

Systems and methods of the current disclosure may facilitate microwave treatment. In one aspect, the term microwave treatment describes electromagnetic energy typically at either 916 MHz to 2450 MHz, although microwave refers to electromagnetic energy between 300 MHz and 300 GHz. If microwave energy is continuously applied it can result in temperatures>150° C. in the simulated organ and/or tissue. Antennas are needlelike or looped. Microwave treatment refers to the use of all electromagnetic methods for inducing treatment profile by using devices with frequencies of at least 900 MHz). Microwave radiation refers to the region of the electromagnetic spectrum with frequencies from 900 to 2450 MHz. This type of radiation lies between infrared radiation and radio waves. Water molecules (H2O) are polar; that is, the electric charges on the molecules are not symmetric. The alignment and the charges on the atoms are such that the hydrogen side of the molecule has a positive charge, and the oxygen side has a negative charge. Electromagnetic radiation has electric charge as well; the “wave” representation is actually the electric charge on the wave as it flips between positive and negative. For a microwave oscillating at 9.2, 108 Hz, the charge changes signs nearly 2 billion times a second (9.2 108 Hz). When an oscillating electric charge from radiation interacts with water molecule, it causes the molecule to flip. Microwave treatment (e.g., ablation) is specially tuned to the natural frequency of water molecules of the tissue to maximize this interaction. As a result of the radiation hitting the molecules, the electrical charge on the water molecule flips back and forth 2-5 billion times a second depending on the frequency of the microwave energy. Temperature is a measure of how fast molecules move in a substance, and the vigorous movement of water molecules raises the temperature of water. Therefore, electromagnetic microwaves facilitate heating the composition of the present invention by agitating water molecules, producing friction and heat, thus inducing composition state transition and forming a treatment field profile. One aspect can include but is not restricted to a thin (14.5-gauge) microwave antenna that is placed directly into the target area in an anatomical model for example a prostate. When the antenna is attached to the microwave generator with a coaxial cable, an electromagnetic microwave is emitted from the exposed, non-insulated portion of the antenna. Heating causes the composition to undergo state transition and form and treatment field profile containing for example coagulated composition. Different configurations exist for MW antennas, which can be applied to control treatment field profile parameters.

Systems and methods of the current invention may facilitate laser treatment. In one aspect laser sources include but are not restricted to neodymium-doped yttrium aluminum garnet and semi-conductor diodes that emit approximately 600-1000 nm wavelength light energy. Laser light when it strikes target area containing the composition becomes scattered and absorbed rapidly this causes lasers to have limited energy penetration and thus produce smaller treatment field profile (10 to 20 mm) than other devices. Light also does not penetrate charred and coagulated treatment field profile well. The heat generated by laser treatment increases the kinetic energy in the composition. When the light is delivered to the target area the generated heat facilitates composition state transition and the formation of treatment field profile comprising for example a carbonization layer. Medical lasers can include but are not restricted to CO2 lasers, diode lasers, dye lasers, excimer lasers, fiber lasers, gas lasers, free electron lasers, and optical parametric oscillators. In one aspect laser irradiation can be performed with a 1.064-nm Nd: YAG laser and variable wattage can include 2, 3, 5, or 7 W and total delivered energy of 500, 1,000, 1,500 or 2,000 J, respectively. One or multiple illuminations can be performed. Between 600 and 1600 J for a target area of approximate size of 10 mm maximal length may prove optimal for a simulated tumor of that length but the treatment field profile parameter(s) will ultimately be dependent on the actual size of the simulated tumor and its location to vital non-target areas. Low-energy output (2-5 Wper fiber) close to the implanted fiber tip, the temperature exceeds 100° C. and results in vaporization of the composition core at the target area (e.g., simulated tumor). Laser treatment increases kinetic energy and induces browning reaction in the composition, for example by activating Maillard's Reaction wherein reducing sugars and amino acids contained within the composition react and facilitate composition dehydration and condensation. As the dry heat composition dehydrates and is exposed to energy, compounds may undergo Amadori rearrangement, subsequent dehydration, condensation, fragmentation of reactants, or Strecker degradation. This process may release low molecular and reactive intermediates, such as dicarbonyl compounds including glyoxal, which may facilitate at least one composition state transition, such as vaporization.

In another example, plasma treatment in water, particularly in saline, may be facilitated using the current invention. Plasma treatment is an emerging surgical technique designed to overcome the limitations of traditional electrosurgical tools like RF or microwave scalpels, which often cause extensive thermal damage to tissues. Unlike conventional methods that heat tissue directly through electrical current, leading to high temperatures, tissue carbonization, and collateral damage, plasma treatment in saline uses submerged electrodes to generate low-temperature plasma at the electrode-liquid interface. In this case, a prostate anatomical model of the current disclosure is coupled with treatment device and submerged in saline solution. When a high-frequency RF or pulsed DC voltage is applied to the composition surface, the localized heating causes vapor bubbles to form at the electrode/composition interface, coalesce around the electrode tip, and create a vapor sheath in which plasma is ignited. In this case, plasma consists of high-energy electrons and reactive species that treat the composition not by bulk heating, but through direct chemical and physical interactions at the plasma-composition interface. Composition treated using this method present discoloration and treatment field containing coagulation or carbonization layer as described in this invention. Experimental setups, may be applied such as dual-needle electrodes spaced 5 mm apart and energized with voltages between 220 V and 320 V at 100 kHz.

Throughout this disclosure the following terms are non-exclusively defined as follows:

A sheath can include but is not restricted to a tube or conduit or guide or guide that may be hollow or solid. A member can include but is not restricted to a tube, cylinder, probe wire, guide wire, guide, device and it can be solid or hollow. A controller can include but is not restricted to a device that takes an action in response to an input. A measuring device can include but is not restricted to a camera, sensor, or a device to measure a quality or quantity of a substance or energy or a phenomenon or an event.

Treatment field profile can refer to composition state transition that mimics the response of tissue to treatment. Further, treatment field profile can include but is not limited to denaturation, discoloration, coagulation, carbonization, cavitation, char formation, liquefaction, structural collapse, and vessel sealing. Additionally, treatment field profile may involve one or more visually distinguishable composition states such as color change, loss of translucency, volumetric change, or composition deformation. Treatment field profile can be controlled to replicate progression of soft tissue treatment, including formation of a carbonized layer, surrounding coagulation layer, and non-affected margins. Treatment field profile may be produced using direct energy delivery (e.g., MW, RF, L, cryotreatment, US, electromagnetic radiation, or ionizing radiation) or through indirect means (e.g., embedded heating elements, thermochromic reactions, or phase-changing materials). In other aspects, treatment field profile may comprise both desired and/or undesired consequences, including partial treatment, excessive treatment, unintended treatment to adjacent non-target area, and device malplacement.

Placement of a device can include but is not restricted to placement by at least one anatomical model or anatomical model element with or without robotic assistance.

The energy delivered and the insulation experienced at any given moment during treatment by the target and non-target area can both vary and can be variable to include but not restricted to duration, direction, exposure, periodicity or frequency.

The techniques and methods in this disclosure can be applied to hydrogel or non-hydrogel compositions. Throughout this disclosure, the composition of the current invention may be referred to as composition, dry heat composition, discoloration composition, coloration composition, state-sensitive composition, or dry heat treatment composition.

An inhibitor refers to an energy source or substance that is configured to alter, modulate, control, activate, deactivate, or neutralize another energy or substance.

In some aspects, inhibitors may be employed to limit, localize, or reverse treatment field profile, and may be applied directly to or around the target area, adjacent anatomical elements, or delivery pathways; thermal energy can be inhibited by applying a cooled fluid or gel, or by surrounding the target area with a thermally conductive or insulating composition; cryogenic cooling from a cryoprobe may be inhibited by localized heating, such as through application of a warmed fluid or an RF source; in some aspects radioactive emissions, such as those from brachytherapy seeds, may be inhibited by radiation-shielding compositions including but not limited to compositions containing lead or other high atomic number compounds; laser energy may be inhibited using compositions that are opaque, semi-opaque, or translucent to specific electromagnetic wavelengths; RF transmission and penetration may be reduced by compositions that absorb or reflect RF energy, such as dextrose-containing solutions, hydrogels, or low-osmolar or non-ionic compounds; or an electrical current that is inhibited by a composition that prevents electrical transmission that can include but is not restricted to a non-ionic or low or non-osmolar composition; an acid that can be inhibited by a base or a base that can be inhibited by an acid; a sclerosant such as ethanol or Sotradecol that can be inhibited by dilution by saline or water; a carboxylated molecule that can be inhibited by a decarboxylating enzyme or substance; a wavelength that can be inhibited by a wavelength with a wavelength that is has a frequency and amplitude and periodicity that inhibits the primary or the secondary wavelengths produced that can include but is not restricted to a second wavelength that is the mirror of the first wavelength; a phase altering composition that can metamorphose from a liquid to a gel; an adhesive that can be deactivated by UV light; the inhibitor can be at least one energy or a composition that inhibits the treatment energy.

System of the current invention can comprise components configured to detect, monitor, track, simulate, predict, characterize, localize, quantify, or visualize treatment field profile or the absence thereof. These components include, but are not limited to, embedded sensors, camera(s), imaging modalities, thermal mapping devices, or other instrumentation or device capable of providing prospective, real time, or retrospective feedback regarding the spatial, temporal, thermal, electrical, and mechanical characteristics of the treatment field profile or other parameter.

Medical application in which energy can be applied or simulated includes dermatology, gynecology, general, oral, plastic, and neurosurgery; spine; bone; otolaryngology; podiatry; urology; vascular lesion coagulation; retinal coagulation; ophthalmology; soft-tissue treatment; bulk tissue removal; thoracic surgery; gastroenterology, arthroscopic surgery; veterinary science, or veterinary care.

While various aspects of the present disclosure have been described in detail, it is apparent that modifications and alterations of those aspects will occur to those skilled in the art. However, it is to be expressly understood that such modifications and alterations are within the scope and spirit of the present disclosure, as set forth in the following claims. For further illustration, the information and materials supplied with the provisional and non-provisional patent applications from which this application claims priority are expressly made a part of this disclosure and incorporated by reference herein in their entirety.

Additionally, although the devices and systems described in the present disclosure are particularly well-suited for the simulation of soft tissue treatment, and much of the discussion herein is directed toward such simulation applications, the advantages provided by various aspects of the disclosure may also be applicable to other treatment procedures in which the treatment of a composition or tissue is desired. As will be appreciated by those skilled in the art, the present disclosure has utility in a broad range of fields, including but not limited to surgical training, medical device development, clinical research, oncology, and therapeutic treatment. In particular, the disclosure is well-suited for simulating treatment procedures involving simulated anatomies. However, it should be understood that the underlying principles and structures described herein may be adapted for use in additional applications beyond those explicitly discussed.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more aspects for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed aspect. Thus, the following claims are hereby incorporated into this Detailed Description, with each claim standing on its own as a separate preferred aspect of the disclosure.

The present inventions, in various aspects, include components, methods, processes, systems and/or devices substantially as depicted and described herein, including various aspects, subcombinations, and subsets thereof. Those of skill in the art will understand how to make and use the present inventions after understanding the present disclosure. The present inventions, in various aspects, include providing devices and processes in the absence of items not depicted and/or described herein or in various aspects hereof, including in the absence of such items as may have been used in previous devices or processes, e.g., for improving performance, achieving ease and/or reducing cost of implementation.

Moreover, though the present disclosure has included description of one or more aspects and certain variations and modifications, other variations and modifications are within the scope of the disclosure, e.g., as may be within the skill and knowledge of those in the art, after understanding the present disclosure. It is intended to obtain rights which include alternative aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

All publications mentioned herein are incorporated herein by reference in their entirely. However, nothing herein should be construed as an admission that the invention is not entitled to antedate such disclosure by virtue of prior invention.

While the invention has been described in detail and with reference to specific embodiments thereof, it is to be understood that the foregoing description is exemplary and explanatory in nature and is intended to illustrate the invention and its preferred embodiments. Through routine experimentation, one skilled in the art will readily recognize that various changes and modifications can be made therein without departing from the spirit and scope of the invention.

Other advantages and features will become apparent from the claims filed hereafter, with the scope of such claims to be determined by their reasonable equivalents, as would be understood by those skilled in the art. Thus, the invention is intended to be defined not by the above description, but by the following claims and their equivalents.

1. A three-dimensional anatomical model configured to represent a biological tissue, organ or anatomical region, said model comprised of a temperature-sensitive, tissue-mimicking, dry heat hydrogel composition, and optionally a cooling element, wherein said hydrogel composition, upon exposure to thermal or non-thermal treatment, undergoes a life-like transition from its native state into a distinguishable state analogous to that arising in a corresponding biological tissue, wherein said transition selected from the group consisting of: discoloration, denaturation, coagulation, carbonization, vaporization, melting or other energy-induced state transition.

2. The anatomical model of claim 1, wherein said model includes additional structural elements designed to replicate, represent, or simulate the geometry, form, mechanical properties, or functional characteristics of said biological tissue, organ or anatomical region.

3. The anatomical model of claim 2, wherein said additional structural elements are selected from the group consisting of: hooks, bases, guides, spacers, substrates, heat sinks, wires, cooling elements, tubes, markers, meshes, frames, rods, cages, and implants.

4. The anatomical model of claim 1, wherein said hydrogel composition is fabricated from polymeric matrix of a base polymer with a binder polymer, and optionally a sugar compound, wherein said polymeric matrix is cross-linked and cured to solid form.

5. The anatomical model of claim 4, wherein said base polymer is selected from the group consisting of: optionally modified polyvinyl alcohols (PVA), polyethylene glycols, polyacrylamides, chitosan, cellulose, starch, alginate, agar, collagen, polyaniline.

6. The anatomical model of claim 5, wherein the mean degree of polymerization of the base polymer is 500 to 3000, more preferably 1000 to 2000, more preferably 1500 to 2000.

7. The anatomical model of claim 4, wherein said binder polymer is capable of forming with said base polymer a cohesive-network in a gel matrix, further wherein said binder polymer is selected from the group consisting of: natural polysaccharides including carboxymethyl cellulose (CMC), sodium alginate, xanthan gum, guar gum, dextran, starch derivatives, chitosan, and hyaluronic acid; protein source like egg white or protein derivatives including gelatin, gelatin methacryloyl (GelMA); synthetic water-soluble polymers including PVA, polyacrylic acid (PAA), polyacrylamide, PEG, poly(ethylene oxide) (PEO), polyvinylpyrrolidone (PVP), polyethyleneimine (PEI), and poly(N-isopropylacrylamide) (PNIPA); hybrid binders combining polymers and crosslinkers such as tannic acid, citric acid-glycerol; and polymer blends including PAA-PVA and alginate-polyacrylamide.

8. The anatomical model of claim 7, wherein hydrogel composition comprises a viscoelastic polymeric matrix of PVA and a peptide polymer.

9. The anatomical model of claim 8, wherein said peptide polymer is collagen or albumin.

10. The anatomical model of claim 4, wherein said hydrogel composition further includes one or more solid fillers or fibers selected from the group consisting of: natural fibers including cotton, linen, wool, silk, hemp, jute, ramie, and kapok; regenerated fibers including rayon and viscose; animal-derived fibers including keratin and fibroin; plant-based nanofibers including cellulose nanofibers, nanocellulose, chitin nanofibers, and bamboo fibers; synthetic fibers including nylon, polyester, polypropylene, polyethylene, aramid fiber, acrylic fiber, glass fiber, carbon fiber, ceramic fiber, and basalt fiber; and particulate fillers including cellulose powder, microcrystalline cellulose, starch granules, silica, talc, titanium dioxide, calcium carbonate, kaolin, bentonite, montmorillonite, sepiolite, mica, alumina, hydroxyapatite, graphene, and carbon nanotubes.

11. The anatomical model of claim 4, wherein polymeric matrix includes a sugar compound selected from the group consisting of monosaccharides including glucose, fructose, galactose, mannose, ribose, xylose, arabinose, erythrose, sedoheptulose, ribulose, and tagatose; disaccharides including lactose, maltose, sucrose, and cellobiose; oligosaccharides including raffinose and trehalose; sugar alcohols including mannitol and sorbitol; deoxy sugars including fucose and rhamnose; amino sugars including glucosamine, galactosamine, and N-acetylglucosamine; sugar acids including gluconic acid, glucuronic acid, galacturonic acid, and iduronic acid; and sugar derivatives modified by phosphorylation, sulfation, acetylation, methylation, or other chemical modifications.

12. The anatomical model of claim 4, wherein said polymeric matrix is ionically or covalently cross-linked by means of a physical or chemical process.

13. The anatomical model of claim 12, wherein said chemical curing process encompasses the use of ionic curing agents, natural curing agents, covalent curing agents, photo-initiated curing agents, and enzymatic curing agents.

14. The anatomical model of claim 13, wherein said physical curing process includes UV, heat, freeze-thaw cycling, ionic gelation agents, and hydrogen bonding enhancers.

15. The anatomical model of claim 1, wherein said biological tissue, organ or anatomical region is selected from the group consisting of: healthy or unhealthy skin, muscle, vasculature, urethra, bladder, prostate, bone, cartilage, fat, nerve, tumor, cyst, polyp, ribs, stomach, abdominal wall, diaphragm, gallbladder, intestines, bone marrow, liver, eye, vascular bed, aorta, inferior vena cava, superior vena cava, pulmonary arteries, pulmonary veins, portal vein, hepatic veins, hepatic artery, renal arteries, renal veins, femoral arteries, femoral veins, iliac arteries, iliac veins, mesenteric arteries, mesenteric veins, splenic artery, splenic vein, carotid arteries, vertebral arteries, jugular veins, subclavian arteries, subclavian veins, brachiocephalic artery, brachiocephalic vein, coronary arteries, coronary sinus, left atrium, right atrium, left ventricle, right ventricle, mitral isthmus, atrial appendages, papillary muscles, pulmonary trunk, bronchial arteries, segmental and lobar pulmonary vessels, trachea, mainstem bronchi, cerebrospinal fluid spaces, intervertebral disc, nucleus pulposus, annulus fibrosislateral ventricles, third ventricle, fourth ventricle, cerebral aqueduct, central canal of the spinal cord, basilar artery, anterior cerebral artery, middle cerebral artery, posterior cerebral artery, internal carotid arteries, arteries and veins of the Circle of Willis, spinal venous plexus vertebral venous plexus, cancellous bone, liver parenchyma, kidney cortex, kidney medulla, adrenal glands, pancreas, spleen, uterus, vagina, ureter, seminal vesicles, ovaries, testicles, pelvic venous plexuses, and rectum.

16. A method of making the anatomical model of claim 1, said method comprising the steps of:
a. mixing a base polymer and a binder polymer with water to form a solution;
b. adding one or more curing agents and optionally one or more sugar compounds to the solution to initiate and enhance cross-linking between said base and binder polymers;
c. adding a solvent that promote polymer swelling or gelation to the solution after step b);
d. optionally adding composition containing biologically derived materials;
e. casting the solution into a shape representative of a target anatomical structure;
f. curing the solution to solid form to thereby yield said anatomical model;
g. optionally modifying and testing the properties of the anatomical model.

17. The method of claim 16, wherein said base polymer is PVA and said binder polymer is collagen or albumin.

18. The method of claim 16, wherein said curing agents are selected from the group consisting of citric acid, tannic acid, and calcium sulfate and said sugar compound is D-glucose.

19. The method of claim 16, wherein said solvent is DMSO.

20. The method of claim 16, wherein said composition is subjected to one or more sequential phases of freezing followed by thawing so as to intentionally to alter the physical, chemical, or mechanical properties of the composition.

21. The method of claim 20, wherein said physical, chemical, or mechanical properties being altered are selected from the group consisting of: crosslinking, phase separation, porosity modification, incorporation of precursors for browning reaction, and structural stabilization.

22. The method of claim 20, wherein said physical, chemical, or mechanical properties being altered modify the behavior of a state-sensitive composition to more accurately simulate tissue characteristics or to achieve desired performance attributes.

23. A method of simulating a surgical treatment plan comprising the steps:
a. contacting the anatomical model of claim 1 with a treatment energy delivery unit at a first location;
b. activating the energy delivery unit so as generate a thermal field profile at said first location that simulates a soft tissue response to said energy; and
c. optionally repeating step b) in the same or a different location within the model, whereby said series of activations allow for gradual or incremental formation of said treatment field profile and thus control of the degree of treatment field profile development.

24. The method of claim 23, wherein said energy is selected from the group consisting of: radiofrequency (RF), microwave (MW), laser (L), cryotherapy (CryT), high intensity focused ultrasound (HIFU), radiation, electrical current, electrocautery, electromagnetic energy, mechanical energy, magnetic resonance (MR), and ultrasound.

25. The method of claim 23, wherein said treatment energy delivery unit is designed for transdermal HIFU, electromagnetic focused energy, sclerotherapy, radioactive therapy Brachytherapy (BrT), irreversible electroporation (IRE), minimally invasive therapy (MIT), tightly targeted minimally invasive therapy (TTMIT) and electrical current therapy.

26. The method of claim 23, wherein said method further comprising the application of an auxiliary and/or monitoring systems, sensors, or device selected from the group consisting of ultrasound devices and systems; visualization, imaging, learning, or monitoring sensors; surgical simulators; procedural training devices; anatomy-specific part-task trainers; scenario-based surgical training systems; synthetic training environments; virtual reality simulators; augmented reality platforms; man-in-the-loop simulation systems; distributed team training frameworks; and constructive simulation platforms.

27. The method of claim 23, wherein said method is applied to a procedural rehearsal, real-time feedback, skill assessment, and decision-making support to improve treatment simulation or a surgical procedure.
